(19) United States
(12) Patent Application Publication
(10) Pub. No.: US 2012/0247155 A1
(43) Pub. Date: Oct. 4, 2012

(54) METHOD OF MANUFACTURING GLASS BLANK FOR MAGNETIC RECORDING MEDIUM GLASS SUBSTRATE, METHOD OF MANUFACTURING MAGNETIC RECORDING MEDIUM GLASS SUBSTRATE, METHOD OF MANUFACTURING MAGNETIC RECORDING MEDIUM, AND APPARATUS FOR MANUFACTURING GLASS BLANK FOR MAGNETIC RECORDING MEDIUM GLASS SUBSTRATE

(75) Inventors: Akira MURAKAMI, Tokyo (JP); Makoto OSAWA, Tokyo (JP); Nobuhiro SUGIYAMA, Tokyo (JP); Takashi SATOU, Tokyo (JP); Hidekazu TANINO, Tokyo (JP); Hideki ISONO, Tokyo (JP); Kinobu OSAKABE, Tokyo (JP); Takao MOTOHASHI, Tokyo (JP)

(73) Assignee: HOYA CORPORATION, Tokyo (JP)

(21) Appl. No.: 13/296,618

(22) Filed: Nov. 15, 2011

Related U.S. Application Data
(60) Provisional application No. 61/469,148, filed on Mar. 30, 2011.

(51) Int. Cl. C03C 17/00; C03C 19/00; C03B 11/05

(52) U.S. Cl. 65/60.1; 65/90; 65/61

(57) ABSTRACT

A method of manufacturing a glass blank for a magnetic recording medium glass substrate in which, after a pair of press molds placed so as to be opposed to each other in a horizontal direction with press-molding surfaces thereof and the temperatures of the press-molding surfaces being substantially the same are brought into contact with a molten glass gob substantially at the same time, press molding is carried out to produce plate glass and the plate glass continues to be pressed with the pair of molds, and then, when the plate glass is taken out, the duration time of pressing the plate glass is controlled so that the flatness of the glass blank is 10 μm or less, and a method of manufacturing a magnetic recording medium glass substrate, a method of manufacturing a magnetic recording medium, and an apparatus for manufacturing a glass blank for a magnetic recording medium glass substrate using the same.

### TECHNICAL FIELD

The present invention relates to a method of manufacturing a glass blank for a magnetic recording medium glass substrate, a method of manufacturing a magnetic recording medium glass substrate, a method of manufacturing a magnetic recording medium, and an apparatus for manufacturing a glass blank for a magnetic recording medium glass substrate.

### BACKGROUND ART

As a method of manufacturing a magnetic recording medium glass substrate (magnetic disk substrate), there are typically exemplified (1) a method of producing a substrate through a press-molding step of subjecting a molten glass gob to press molding with a pair of press molds (hereinafter, sometimes referred to as “press method.”See, for example, Patent Literatures 1 to 3), and (2) a method of producing a substrate through a processing step of cutting, into a disk shape, a sheet-shaped glass by a float method, a down-draw method, or the like (hereinafter, sometimes referred to as “sheet-shaped glass-cutting method.” See, for example, Patent Literature 4).

In conventional sheet-shaped glass-cutting method exemplified in Patent Literature 4, a magnetic recording medium glass substrate was obtained by carrying out a disk processing step of processing a sheet-shaped glass into a disk shape and then carrying out, as polish steps, a lapping step (rough-polishing treatment) and a polishing step (precision-polishing treatment). However, it is disclosed that, in the sheet-shaped glass-cutting method disclosed in Patent Literature 4, the lapping step (rough-polishing treatment) is eliminated and only the polishing step (precision-polishing treatment) is carried out as a polish step.

On the other hand, in conventional press methods exemplified in Patent Literatures 1 to 3, a magnetic recording medium glass substrate is usually obtained by carrying out a press-molding step with a method of press-molding a molten glass gob, in which the molten glass gob is placed in a lower mold and a pressing force is then applied to the molten glass gob from the vertical direction by using an upper mold and the lower mold (hereinafter, sometimes referred to as “vertical direct press”), and then carrying out a lapping step, a polishing step, and the like.

Here, it is also proposed that, in the press method disclosed in Patent Literature 2, the lapping step is eliminated by, for example, using a highly rigid material as a material for the upper mold, the lower mold, and a parallel spacer arranged between the upper mold and the lower mold.

In addition, in a press method disclosed in Patent Literature 3, a method is proposed in which, in order to obtain a plate glass with small warpage while preventing the productivity from being decreased, after press molding, an upper mold for cooling is placed on a press-molded product. In this method, by using the upper mold for cooling, cooled states of an upper surface and a lower surface of the press-molded product are balanced.

In addition, it is proposed that, in the press method disclosed in Patent Literature 3, in place of the vertical direct press, the press-molding step is carried out with a method in which a pressing force is applied to a molten glass gob from the horizontal direction by using a pair of press molds arranged so as to face each other in the horizontal direction (hereinafter, sometimes referred to as “horizontal direct press”).

### CITATION LIST

### Patent Literature

[Patent Literature 1] JP 2009-149477 A (Claim 1, paragraph 0012, and the like))
[Patent Literature 2] JP 2003-54965 A (Scope of Claims, paragraphs 0040 and 0043, FIG. 4 to FIG. 8, and the like)
[Patent Literature 3] JP 4380379 B (paragraph 0031, FIG. 1 to FIG. 9, and the like)
[Patent Literature 4] JP 2003-36528 A (FIG. 3 to FIG. 6, FIG. 8, and the like))

### SUMMARY OF THE INVENTION

### Technical Problems

On the other hand, from the viewpoint of enhancing the productivity of a magnetic recording medium glass substrate, it is very effective to eliminate a lapping step or to carry out a lapping step in a shorter time, the lapping step being carried out mainly for the purposes of securing the flatness and uniformity in thickness of the magnetic recording medium glass substrate, adjusting its thickness, and the like. This is because a lapping apparatus is required for carrying out the lapping step, and hence man-hours for producing a magnetic recording medium glass substrate become larger and the processing time thereof increases. Further, the lapping step may cause the occurrence of a crack in the surfaces of glass. Thus, the present situation is that examination is being made on how to eliminate the lapping step. Here, when the sheet-shaped glass-cutting method and the press method are compared from the viewpoint of eliminating the lapping step or carrying out the lapping step in a shorter time, more advantageous is the sheet-shaped glass-cutting method, in which processing is carried out by using a sheet-shaped glass having a higher flatness produced by a float method, a down-draw method, or the like. However, the press method has the advantage that glass is used more efficiently compared with the sheet-shaped glass-cutting method.

In order to eliminate a lapping step or to carryout a lapping step in a shorter time at the time of producing a magnetic recording medium by applying post-processing to a glass blank for a magnetic recording medium glass substrate (hereinafter, sometimes simply referred to as “glass blank”) produced by using vertical direct press, it is necessary to make the thickness deviation of the glass blank smaller and to improve the flatness thereof. Here, when a glass blank is manufactured by vertical direct press, the temperature of a lower mold is set to a temperature sufficiently lower than the temperature of a high-temperature molten glass gob in order to prevent the molten glass gob from melting and bonding. Thus, during the period from placing the molten glass gob in the lower mold until starting press molding, the molten glass gob loses heat through the surface in contact with the lower mold, and hence the viscosity of the lower surface of the molten glass gob placed in the lower mold locally increases. As a result, the press molding is carried out to the molten glass gob having a wide viscosity distribution (temperature distribution), producing portions that resist stretching by press. Besides, a cooling speed after the press molding is different for each site in a glass molded body produced by stretching glass by press molding so as to have a plate shape. Consequently, a glass blank that is produced by using vertical direct press is liable to have an increased thickness deviation or to have a deteriorated flatness. Further, in consideration of the above-mentioned mechanism, even in the case of adopting the vertical direct press using a upper mold for cooling as disclosed in Patent Literature 1, it is difficult to drastically suppress the increase of the thickness deviation of the glass blank and the deterioration of the flatness thereof.

On the other hand, in the horizontal direct press exemplified in Patent Literature 3, a molten glass gob is press-molded into a plate shape substantially at the moment when the molten glass gob is brought into contact with a press mold. More specifically, compared with a case of the vertical direct press, in the horizontal direct press, the viscosity distribution of the molten glass gob when the press molding is carried out is uniform, and hence, it is easy to stretch the molten glass gob uniformly and thinly. Therefore, in theory, compared with the vertical direct press, the horizontal direct press is thought to drastically suppress more easily the increase of the thickness deviation and the deterioration of the flatness of the glass blank.

Meanwhile, as the recording density of a magnetic recording medium is further enhanced in recent years, a magnetic recording medium glass substrate made of glass and a glass blank which are used in producing a magnetic recording medium are required to further improve the thickness deviation and the flatness thereof.

However, intensive study of the inventors of the present invention revealed that a glass blank produced using the horizontal direct press described in Patent Literature 3 could not cope with the above-mentioned needs especially with regard to the flatness (first situation).

Further, gravity acts on an integral type press mold used in the horizontal direct press exemplified in Patent Literature 3 in a direction in parallel with press-molding surfaces. Therefore, compared with the case of the vertical direct press in which the lower mold is substantially fixedly placed and the upper mold is moved in a direction in parallel with the direction of gravity, in the horizontal direct press, the press-molding surface tends to be inclined with respect to the direction of movement of the press mold. Therefore, in order to reduce the thickness deviation in the horizontal direct press, the press molding is required to be carried out with the press-molding surfaces opposed to each other being held in parallel with each other. In order to attain this, driving of the press mold in the horizontal direction in the press molding must be controlled with extreme precision. However, even if a drive of the press mold is improved, precise driving of the press mold has a ceiling, and hence, it is difficult to improve the thickness deviation, and the costs also increase, which is not practical. Therefore, even if the press mold exemplified in Patent Literature 3 is used, it is difficult to further improve the thickness deviation and the flatness (second situation).

An object common to a first aspect and a second aspect of the present invention is to improve the flatness. Here, the first aspect of the present invention has been made in view of the first situation described above, and an object of the first aspect of the present invention (first object) is to provide a method of manufacturing a glass blank for a magnetic recording medium glass substrate which may produce a glass blank excellent in flatness, and a method of manufacturing a magnetic recording medium glass substrate and a method of manufacturing a magnetic recording medium using the same.

The second aspect of the present invention has been made in view of the second situation described above, and an object of the second aspect of the present invention (second object) is to provide a method of manufacturing a glass blank for a magnetic recording medium glass substrate which may manufacture a glass blank with smaller thickness deviation and flatness even when the glass blank is manufactured using horizontal direct press, and a method of manufacturing a magnetic recording medium glass substrate, a method of manufacturing a magnetic recording medium, and a apparatus for manufacturing a glass blank for a magnetic recording medium glass substrate using the method of manufacturing a glass blank for a magnetic recording medium glass substrate.

### Solution to Problem

The first object including the common object is achieved by the first aspect of the present invention as follows. That is, according to the first aspect of the present invention, there is provided a method of manufacturing a glass blank for a magnetic recording medium glass substrate, including at least: a first pressing step of pressing a falling molten glass gob with a first press mold and a second press mold placed so as to be opposed to each other in a direction crossing a direction in which the molten glass gob falls to form the falling molten glass gob into a plate shape; a second pressing step of continuing to press, with the first press mold and the second press mold, plate glass formed between the first press mold and the second press mold; and a taking out step of, after the second pressing step, moving the first press mold and the second press mold away from each other and taking out the plate glass sandwiched between the first press mold and the second press mold, in which: at least during a period in which the first pressing step and the second pressing step are carried out, the temperature of a press-molding surface of the first press mold and the temperature of a press-molding surface of the second press mold are substantially the same; in the first pressing step, the molten glass gob is pressed after the press-molding surface of the first press mold and the press-molding surface of the second press mold are brought into contact with the molten glass gob substantially at the same time; and the duration time of the second pressing step is controlled so that the flatness of the glass blank for a magnetic recording medium glass substrate is 10 μm or less.

According to an embodiment mode, in the method of manufacturing a glass blank for a magnetic recording medium glass substrate of the first aspect of the present invention, it is preferred that the duration time of the second pressing step be selected so that the temperature of the plate glass when the second pressing step is completed is at least equal to or lower than a temperature which is 10° C. higher than the strain point of a glass material forming the plate glass.

According to another embodiment mode, it is preferred that the method of manufacturing a glass blank for a magnetic recording medium glass substrate of the first aspect of the present invention further include a molten glass gob forming step of causing molten glass to fall from a glass outlet and cutting a forward end portion of a molten glass flow continuously flowing out downward in the vertical direction.

According to a further embodiment mode, in the method of manufacturing a glass blank for a magnetic recording medium glass substrate of the first aspect of the present invention, it is preferred that the viscosity of the molten glass be in a range of 500 dPa·s to 1,050 dPa·s.

According to a further embodiment mode, in the method of manufacturing a glass blank for a magnetic recording medium glass substrate of the first aspect of the present invention, it is preferred that the first press mold and the second press mold be placed so as to be opposed to each other in a direction perpendicular to the direction in which the molten glass gob falls.

According to a further embodiment mode, in the method of manufacturing a glass blank for a magnetic recording medium glass substrate of the first aspect of the present invention, it is preferred that the absolute values of the temperature differences within the press-molding surfaces of the first press mold and the second press mold immediately before the first pressing step is carried out be in a range of 0° C. to 100° C.

According to a further embodiment mode, in the method of manufacturing a glass blank for a magnetic recording medium glass substrate of the first aspect of the present invention, it is preferred that the press pressure in the second pressing step be reduced with time.

According to a further embodiment mode, in the method of manufacturing a glass blank for a magnetic recording medium glass substrate of the first aspect of the present invention, it is preferred that the press pressure be reduced when the temperature of the plate glass sandwiched between the first press mold and the second press mold is lowered into a range of ±30° C. from the defromation point of a glass material forming the plate glass.

According to a further embodiment mode, in the method of manufacturing a glass blank for a magnetic recording medium glass substrate of the first aspect of the present invention, it is preferred that, during the second pressing step is carried out, one surface of the plate glass and the press-molding surface of the first press mold be always in intimate contact with each other without a gap and the other surface of the plate glass and the press-molding surface of the second press mold be always in intimate contact with each other without a gap.

According to a further embodiment mode, in the method of manufacturing a glass blank for a magnetic recording medium glass substrate of the first aspect of the present invention, it is preferred that the duration time of the second pressing step be controlled so that the flatness of the glass blank for a magnetic recording medium glass substrate is 4 μm or less.

According to a further embodiment mode, in the method of manufacturing a glass blank of the first aspect of the present invention, it is preferred that regions in contact with at least the plate glass of the press-molding surfaces of the first press mold and the second press mold be substantially flat surfaces.

According to the first aspect of the present invention, there is also provided a method of manufacturing a magnetic recording medium glass substrate, including at least: manufacturing a glass blank for a magnetic recording medium glass substrate, including at least: a first pressing step of pressing a falling molten glass gob with a first press mold and a second press mold placed so as to be opposed to each other in a direction crossing a direction in which the molten glass gob falls to form the falling molten glass gob into a plate shape; a second pressing step of continuing to press, with the first press mold and the second press mold, plate glass formed between the first press mold and the second press mold; and a taking out step of, after the second pressing step, moving the first press mold and the second press mold away from each other and taking out the plate glass sandwiched between the first press mold and the second press mold; and after that, a polishing step of polishing main surfaces of the glass blank for a magnetic recording medium glass substrate, in which: at least during a period in which the first pressing step and the second pressing step are carried out, the temperature of a press-molding surface of the first press mold and the temperature of a press-molding surface of the second press mold are substantially the same; in the first pressing step, the molten glass gob is pressed after the press-molding surface of the first press mold and the press-molding surface of the second press mold are brought into contact with the molten glass gob substantially at the same time; and the duration time of the second pressing step is controlled so that the flatness of the glass blank for a magnetic recording medium glass substrate is 10 μm or less.

According to an embodiment mode, in the method of manufacturing a magnetic recording medium glass substrate of the first aspect of the present invention, it is preferred that the duration time of the second pressing step be selected so that the temperature of the plate glass when the second pressing step is completed is at least equal to or lower than a temperature which is 10° C. higher than the strain point of a glass material forming the plate glass.

According to another embodiment mode, in the method of manufacturing a magnetic recording medium glass substrate of the first aspect of the present invention, it is preferred that the flatness of the glass blank for a magnetic recording medium glass substrate and the flatness of the magnetic recording medium glass substrate be substantially the same.

According to the first aspect of the present invention, there is further provided a method of manufacturing a magnetic recording medium, including at least: manufacturing a glass blank for a magnetic recording medium glass substrate, including at least: a first pressing step of pressing a falling molten glass gob with a first press mold and a second press mold placed so as to be opposed to each other in a direction crossing a direction in which the molten glass gob falls to form the falling molten glass gob into a plate shape; a second pressing step of continuing to press, with the first press mold and the second press mold, plate glass formed between the first press mold and the second press mold; and a taking out step of, after the second pressing step, moving the first press mold and the second press mold away from each other and taking out the plate glass sandwiched between the first press mold and the second press mold; after that, manufacturing a magnetic recording medium glass substrate, including at least a polishing step of polishing main surfaces of the glass blank for a magnetic recording medium glass substrate; and further, manufacturing a magnetic recording medium, including at least a magnetic recording layer-forming step of forming a magnetic recording layer on the magnetic recording medium glass substrate, in which: at least during a period in which the first pressing step and the second pressing step are carried out, the temperature of a press-molding surface of the first press mold and the temperature of a press-molding surface of the second press mold are substantially the same; in the first pressing step, the molten glass gob is pressed after the press-molding surface of the first press mold and the press-molding surface of the second press mold are brought into contact with the molten glass gob substantially at the same time; and the duration time of the second pressing step is controlled so that the flatness of the glass blank for a magnetic recording medium glass substrate is 10 μm or less.

According to an embodiment mode, in the method of manufacturing a magnetic recording medium of the first aspect of the present invention, it is preferred that the duration time of the second pressing step be selected so that the temperature of the plate glass when the second pressing step is completed is at least equal to or lower than a temperature which is 10° C. higher than the strain point of a glass material forming the plate glass.

According to another embodiment mode, in the method of manufacturing a magnetic recording medium of the first aspect of the present invention, it is preferred that the flatness of the glass blank for a magnetic recording medium glass substrate and the flatness of the magnetic recording medium glass substrate be substantially the same.

The second object including the common object is achieved by the second aspect of the present invention as follows. That is, according to the second aspect of the present invention, there is provided a method of manufacturing a glass blank for a magnetic recording medium glass substrate, including at least: a press-molding step of press-molding a falling molten glass gob with a first press mold and a second press mold placed so as to be opposed to each other in a direction crossing a direction in which the molten glass gob falls, in which: at least the first press mold at least includes: a press mold body having a press-molding surface; and a guide member having at least the function of maintaining a substantially fixed distance between the press-molding surfaces of the first press mold and the second press mold in the press molding, by, when pushed to the side of a press mold which is placed so as to be opposed to the press-molding surface, being brought into contact with a part of a press mold which is placed so as to be opposed to the press-molding surface; and the press-molding step includes: a first step of forming the molten glass gob into plate glass by bringing the first press mold and the second press mold closer together until the guide member of the first press mold and the second press mold are in contact with each other; and a second step of continuing to press, with the press mold body of the first press mold and the second press mold, the plate glass with the guide member of the first press mold and the second press mold being in contact with each other.

According to an embodiment mode, in the method of manufacturing a glass blank for a magnetic recording medium glass substrate of the second aspect of the present invention, it is preferred that each of the first press mold and the second press mold at least include: a press mold body having a press-molding surface; and a guide member having at least the function of maintaining a substantially fixed distance between the press-molding surfaces of the first press mold and the second press mold in the press molding, by, when pushed to the side of a press mold which is placed so as to be opposed to the press-molding surface, being brought into contact with a part of a press mold which is placed so as to be opposed to the press-molding surface, that the first step be carried out by bringing the first press mold and the second press mold closer together until the guide member of the first press mold and the guide member of the second press mold are brought into contact with each other, and that the second step be carried out by continuing to press, with the press mold body of the first press mold and the press mold body of the second press mold, the plate glass with the guide member of the first press mold and the guide member of the second press mold being in contact with each other.

According to another embodiment mode, in the method of manufacturing a glass blank for a magnetic recording medium glass substrate of the second aspect of the present invention, it is preferred that the method of manufacturing a glass blank for a magnetic recording medium glass substrate of the second aspect of the present invention further include a molten glass gob forming step of causing molten glass to fall from a glass outlet and cutting a forward end portion of a molten glass flow continuously flowing out downward in the vertical direction.

According to a further embodiment mode, in the method of manufacturing a glass blank for a magnetic recording medium glass substrate of the second aspect of the present invention, it is preferred that the viscosity of the molten glass be in a range of 500 dPa·s to 1,050 dPa·s.

According to a further embodiment mode, in the method of manufacturing a glass blank for a magnetic recording medium glass substrate of the second aspect of the present invention, it is preferred that the first press mold and the second press mold be placed so as to be opposed to each other in a direction perpendicular to the direction in which the molten glass gob falls.

According to a further embodiment mode, in the method of manufacturing a glass blank for a magnetic recording medium glass substrate of the second aspect of the present invention, it is preferred that the duration time of the second step be controlled so that the flatness of the glass blank for a magnetic recording medium glass substrate is 10 μm or less.

According to a further embodiment mode, in the method of manufacturing a glass blank for a magnetic recording medium glass substrate of the second aspect of the present invention, it is preferred that the duration time of the second step be selected so that the temperature of the plate glass when the second step is completed is at least equal to or lower than a temperature which is 10° C. higher than the strain point of a glass material forming the plate glass.

According to a further embodiment mode, in the method of manufacturing a glass blank for a magnetic recording medium glass substrate of the second aspect of the present invention, it is preferred that the absolute value of the difference between the temperature of the press-molding surface of the first press mold and the temperature of the press-molding surface of the second press mold immediately before the first step is carried out be in a range of 0° C. to 10° C.

According to a further embodiment mode, in the method of manufacturing a glass blank for a magnetic recording medium glass substrate of the second aspect of the present invention, it is preferred that the absolute values of the temperature differences within the press-molding surfaces of the first press mold and the second press mold immediately before the first step is carried out be in a range of 0° C. to 100° C.

According to a further embodiment mode, in the method of manufacturing a glass blank for a magnetic recording medium glass substrate of the second aspect of the present invention, it is preferred that at least during a period in which the press-molding step is carried out, the temperature of the press-molding surface of the first press mold and the temperature of the press-molding surface of the second press mold be substantially the same, and that the molten glass gob be press-molded after the press-molding surface of the first press mold and the press-molding surface of the second press mold are brought into contact with the molten glass gob substantially at the same time.

According to a further embodiment mode, in the method of manufacturing a glass blank for a magnetic recording medium glass substrate of the second aspect of the present invention, it is preferred that the second step continue until the temperature of the plate glass is at least equal to or lower than a temperature which is 10° C. higher than the strain point of a glass material forming the plate glass.

According to a further embodiment mode, in the method of manufacturing a glass blank for a magnetic recording medium glass substrate of the second aspect of the present invention, it is preferred that the press pressure in the second step be reduced with time.

According to a further embodiment mode, in the method of manufacturing a glass blank for a magnetic recording medium glass substrate of the second aspect of the present invention, it is preferred that the press pressure be reduced when the temperature of the plate glass sandwiched between the first press mold and the second press mold is lowered into a range of ±30° C. from the defromation point of a glass material forming the plate glass.

According to a further embodiment mode, in the method of manufacturing a glass blank for a magnetic recording medium glass substrate of the second aspect of the present invention, it is preferred that the flatness of the glass blank for a magnetic recording medium glass substrate be 10 μm or less.

According to a further embodiment mode, in the method of manufacturing a glass blank for a magnetic recording medium glass substrate of the second aspect of the present invention, it is preferred that the flatness of the glass blank for a magnetic recording medium glass substrate be 4 μm or less.

According to a further embodiment mode, in the method of manufacturing a glass blank for a magnetic recording medium glass substrate of the second aspect of the present invention, it is preferred that regions in contact with at least the plate glass of the press-molding surfaces of the first press mold and the second press mold be substantially flat surfaces.

According to a further embodiment mode, in the method of manufacturing a glass blank for a magnetic recording medium glass substrate of the second aspect of the present invention, it is preferred that each of the first press mold and the second press mold further include: a first pushing member for pushing at the same time the press mold body and the guide member in a direction perpendicular to the press-molding surface and to the side of a press mold placed so as to be opposed to the press-molding surface; and a second pushing member for, after the first pushing member brings the guide member and a part of a press mold placed so as to be opposed to the press-molding surface into contact with each other, pushing the press mold body in a direction perpendicular to the press-molding surface and to the side of a press mold placed so as to be opposed to the press-molding surface.

According to the second aspect of the present invention, there is also provided a method of manufacturing a magnetic recording medium glass substrate, including at least: manufacturing a glass blank for a magnetic recording medium glass substrate, including at least a press-molding step of press-molding a falling molten glass gob with a first press mold and a second press mold placed so as to be opposed to each other in a direction crossing a direction in which the molten glass gob falls, and after that, a polishing step of polishing main surfaces of the glass blank for a magnetic recording medium, in which: at least the first press mold at least includes: a press mold body having a press-molding surface; and a guide member having at least the function of maintaining a substantially fixed distance between the press-molding surfaces of the first press mold and the second press mold in the press molding, by, when pushed to the side of a press mold which is placed so as to be opposed to the press-molding surface, being brought into contact with a part of a press mold which is placed so as to be opposed to the press-molding surface; and the press-molding step includes: a first step of forming the molten glass gob into plate glass by bringing the first press mold and the second press mold closer together until the guide member of the first press mold and the second press mold are in contact with each other; and a second step of continuing to press, with the press mold body of the first press mold and the second press mold, plate glass with the guide member of the first press mold and the second press mold being in contact with each other.

According to an embodiment mode, in the method of manufacturing a magnetic recording medium glass substrate of the second aspect of the present invention, it is preferred that the flatness of the glass blank for a magnetic recording medium glass substrate and the flatness of the magnetic recording medium glass substrate be substantially the same.

According to the second aspect of the present invention, there is further provided a method of manufacturing a magnetic recording medium, including at least: manufacturing a glass blank for a magnetic recording medium glass substrate, including at least a press-molding step of press-molding a falling molten glass gob with a first press mold and a second press mold placed so as to be opposed to each other in a direction crossing a direction in which the molten glass gob falls; after that, manufacturing a magnetic recording medium glass substrate, including at least a polishing step of polishing main surfaces of the glass blank for a magnetic recording medium; and further, manufacturing a magnetic recording medium, including at least a magnetic recording layer-forming step of forming a magnetic recording layer on the magnetic recording medium glass substrate, in which: at least the first press mold at least includes: a press mold body having a press-molding surface; and a guide member having at least the function of maintaining a substantially fixed distance between the press-molding surfaces of the first press mold and the second press mold in the press molding, by, when pushed to the side of a press mold which is placed so as to be opposed to the press-molding surface, being brought into contact with a part of a press mold which is placed so as to be opposed to the press-molding surface; and the press-molding step includes: a first step of forming the molten glass gob into plate glass by bringing the first press mold and the second press mold closer together until the guide member of the first press mold and the second press mold are in contact with each other; and a second step of continuing to press, with the press mold body of the first press mold and the second press mold, plate glass with the guide member of the first press mold and the second press mold being in contact with each other.

According to an embodiment mode, in the method of manufacturing a magnetic recording medium of the second aspect of the present invention, it is preferred that the flatness of the glass blank for a magnetic recording medium glass substrate and the flatness of the magnetic recording medium glass substrate be substantially the same.

According to the second aspect of the present invention, there is further provided an apparatus for manufacturing a glass blank for a magnetic recording medium glass substrate, including at least: a molten glass effluent pipe including an outlet through which a molten glass flow falls downward in the vertical direction; a pair of shear blades placed so as to be opposed to each other in a direction substantially perpendicular to a direction in which the molten glass flow flowing out from the molten glass effluent pipe falls, on both sides of the direction in which the molten glass flow falls, for cutting a forward end portion of the molten glass flow by being inserted into the molten glass flow from both sides thereof to form a molten glass gob; and a first press mold and a second press mold placed so as to be opposed to each other in a direction substantially perpendicular to the direction in which the molten glass gob falling downward in the vertical direction falls, on both sides of the direction in which the molten glass gob falls, for press-molding the molten glass gob into plate glass by sandwiching the molten glass gob from both sides thereof, in which at least the first press mold at least includes: a press mold body having a press-molding surface; a guide member having at least the function of maintaining a substantially fixed distance between the press-molding surfaces of the first press mold and the second press mold in the press molding, by, when pushed to the side of a press mold which is placed so as to be opposed to the press-molding surface, being brought into contact with a part of a press mold which is placed so as to be opposed to the press-molding surface; a first pushing member for pushing at the same time the press mold body and the guide member in a direction perpendicular to the press-molding surface and to the side of a press mold placed so as to be opposed to the press-molding surface; and a second pushing member for, after the first pushing member brings the guide member and a part of a press mold placed so as to be opposed to the press-molding surface into contact with each other, pushing the press mold body in a direction perpendicular to the press-molding surface and to the side of a press mold placed so as to be opposed to the press-molding surface.

### Advantageous Effects of Invention

According to the first aspect of the present invention, a method of manufacturing a glass blank for a magnetic recording medium glass substrate which may produce a glass blank excellent in flatness, and a method of manufacturing a magnetic recording medium glass substrate and a method of manufacturing a magnetic recording medium using the same may be provided.

According to the second aspect of the present invention, a method of manufacturing a glass blank for a magnetic recording medium glass substrate which may manufacture a glass blank with smaller thickness deviation and flatness even when the glass blank is manufactured using the horizontal direct press, and a method of manufacturing a magnetic recording medium glass substrate, a method of manufacturing a magnetic recording medium, and a apparatus for manufacturing a glass blank for a magnetic recording medium glass substrate using the method of manufacturing a glass blank for a magnetic recording medium glass substrate may be provided.

### BRIEF DESCRIPTION OF DRAWINGS

FIG. 1 is a schematic sectional view for illustrating a part of the whole steps in one example of a method of manufacturing a glass blank according to a first embodiment of the present invention.

FIG. 2 is a schematic sectional view for illustrating another part of the whole steps in the one example of the method of manufacturing a glass blank according to the first embodiment of the present invention.

FIG. 3 is a schematic sectional view for illustrating one example of a falling molten glass gob.

FIG. 4 is a schematic sectional view for illustrating a further part of the whole steps in the one example of the method of manufacturing a glass blank according to the first embodiment of the present invention.

FIG. 5 is a schematic sectional view for illustrating a further part of the whole steps in the one example of the method of manufacturing a glass blank according to the first embodiment of the present invention.

FIG. 6 is a schematic sectional view for illustrating a further part of the whole steps in the one example of the method of manufacturing a glass blank according to the first embodiment of the present invention.

FIG. 7 is a schematic sectional view for illustrating a further part of the whole steps in the one example of the method of manufacturing a glass blank according to the first embodiment of the present invention.

FIG. 8 is a schematic sectional view for illustrating a further part of the whole steps in the one example of the method of manufacturing a glass blank according to the first embodiment of the present invention.

FIG. 9 is a schematic sectional view for illustrating a further part of the whole steps in the one example of the method of manufacturing a glass blank according to the first embodiment of the present invention.

FIG. 10 is a schematic sectional view for illustrating one example of a press mold used in the method of manufacturing a glass blank according to the first embodiment of the present invention.

FIG. 11 is a schematic sectional view for illustrating a part of the whole steps in one example of a method of manufacturing a glass blank according to a second embodiment of the present invention.

FIG. 12 is a schematic sectional view for illustrating another part of the whole steps in the one example of the method of manufacturing a glass blank according to the second embodiment of the present invention.

FIG. 13 is a schematic sectional view for illustrating one example of a falling molten glass gob.

FIG. 14 is a schematic sectional view for illustrating a further part of the whole steps in the one example of the method of manufacturing a glass blank according to the second embodiment of the present invention.

FIG. 15 is a schematic sectional view for illustrating a further part of the whole steps in the one example of the method of manufacturing a glass blank according to the second embodiment of the present invention.

FIG. 16 is a schematic sectional view for illustrating a further part of the whole steps in the one example of the method of manufacturing a glass blank according to the second embodiment of the present invention.

FIG. 17 is a schematic sectional view for illustrating a further part of the whole steps in the one example of the method of manufacturing a glass blank according to the second embodiment of the present invention.

FIG. 18 is a schematic sectional view for illustrating a further part of the whole steps in the one example of the method of manufacturing a glass blank according to the second embodiment of the present invention.

FIG. 19 is a schematic sectional view for illustrating a further part of the whole steps in the one example of the method of manufacturing a glass blank according to the second embodiment of the present invention.

FIG. 20 is a schematic sectional view for illustrating one example of a more specific structure of a press mold used in the method of manufacturing a glass blank according to the second embodiment of the present invention.

FIG. 21 is a schematic sectional view illustrating another example of the press mold used in the method of manufacturing a glass blank according to the second embodiment of the present invention.

FIG. 22 is a schematic sectional view of a press mold used in Comparative Example A1.

FIG. 23 is a schematic sectional view of a press mold used in Comparative Example A2.

### REFERENCE SIGNS LIST

10 molten glass effluent pipe
12 glass outlet
20 molten glass flow
22 forward end portion
24 molten glass gob
26 plate glass
30 lower side blade (shear blade)
32 body portion
34 blade portion
34U upper surface (of blade portion)
34B lower surface (of blade portion)
40 upper side blade (shear blade)
42 body portion
44 blade portion
44U upper surface (of blade portion)
44B lower surface (of blade portion)
50 first press mold
50S press mold
52 press mold body
52A press-molding surface
52B pushed surface
54 guide member
54A guide surface
54B pushed surface
56 first pushing member
56A pushing surface
56B surface opposite to pushing surface 56A
56H through hole
58 second pushing member
60 second press mold
62 press mold body
62A press-molding surface
64 guide member
64A guide surface
110 molten glass effluent pipe
112 glass outlet
120 molten glass flow
122 forward end portion
124 molten glass gob
126 plate glass
130 lower side blade (shear blade)
132 body portion
134 blade portion
134U upper surface (of blade portion)
134B lower surface (of blade portion)
140 upper side blade (shear blade)
142 body portion
144 blade portion
144U upper surface (of blade portion)
144B lower surface (of blade portion)
150 first press mold
150S press mold
152 press mold body
152A press-molding surface
152B pushed surface
154 guide member
154A guide surface
154B pushed surface
156 first pushing member
156A pushing surface
156B surface opposite to pushing surface 156A
156H through hole
158 second pushing member
160 second press mold
162 press mold body
162A press-molding surface
164 guide member
164A guide surface
170 support member
200 press mold

### MODES FOR CARRYING OUT THE INVENTION

### First Embodiment

### (Method of Manufacturing Glass Blank for Magnetic Recording Medium Glass Substrate)

According to a first embodiment of the present invention, there is provided a method of manufacturing a glass blank for a magnetic recording medium glass substrate (hereinafter, sometimes abbreviated to as “method of manufacturing a glass blank”), including at least: a first pressing step of pressing a falling molten glass gob with a first press mold and a second press mold placed so as to be opposed to each other in a direction crossing a direction in which the molten glass gob falls to form the falling molten glass gob into a plate shape; a second pressing step of continuing to press, with the first press mold and the second press mold, plate glass formed between the first press mold and the second press mold; and a taking out step of, after the second pressing step, moving the first press mold and the second press mold away from each other and taking out the plate glass sandwiched between the first press mold and the second press mold, in which: at least during a period in which the first pressing step and the second pressing step are carried out, the temperature of a press-molding surface of the first press mold and the temperature of a press-molding surface of the second press mold are substantially the same; in the first pressing step, the molten glass gob is pressed after the press-molding surface of the first press mold and the press-molding surface of the second press mold are brought into contact with the molten glass gob substantially at the same time; and the duration time of the second pressing step is controlled so that the flatness of the glass blank is 10 μm or less. The “magnetic recording medium glass substrate” as used herein means a glass substrate for a magnetic recording medium formed of amorphous glass.

In the method of manufacturing a glass blank according to the first embodiment, in the first pressing step, similarly to a case of a conventional press method, a molten glass gob which has the temperature that is sufficiently higher than a strain point of a glass material and which is held in an easily deformable state is pressed to be formed into a plate shape. Here, the molten glass gob is pressed after the press-molding surface of the first press mold and the press-molding surface of the second press mold are brought into contact with the molten glass gob substantially at the same time. In addition to this, during a period in which the first pressing step and the second pressing step are carried out, the temperature of the press-molding surface of the first press mold and the temperature of the press-molding surface of the second press mold are substantially the same. Therefore, both surfaces of the molten glass gob which is being formed into a plate shape in the first pressing step and both surfaces of the plate glass sandwiched between the pair of press molds in the second pressing step continue to be cooled always symmetrically. Therefore, compared with a case of vertical direct press in which a molten glass gob in a state of having a viscosity distribution due to contact with a lower mold for a long time is press-molded, in the method of manufacturing a glass blank according to the first embodiment, almost no temperature difference is caused between both the surfaces of the plate glass after being press-molded, and thus, deterioration of the flatness due to temperature difference between both the surfaces may be suppressed with reliability.

On the other hand, the plate glass immediately after the first pressing step is completed is at a high temperature and has high fluidity (low viscosity). Therefore, the plate glass is in a quite easily deformable state, and thus, in a state of being liable to deteriorate in flatness. However, in the second pressing step which is carried out subsequently to the first pressing step, the plate glass formed between the first press mold and the second press mold continues to be pressed with the first press mold and the second press mold. Here, the duration time of the second pressing step is controlled so that the flatness of the glass blank is 10 μm or less. Note that, the duration time of the second pressing step is preferably controlled so that the flatness of the glass blank is 4 μm or less. In consequence, the flatness of the produced glass blank may be improved. Note that, if the duration time of the second pressing step is short, strain due to disturbance is caused in the plate glass in the process of being cooled, and the strain deteriorates the flatness of the glass blank. Therefore, the duration time of the second pressing step is changed, the flatness of the obtained glass blank is measured, and based on the result, the duration time of the second pressing step is set so that the flatness is 10 μm or less and the glass blank is manufactured. However, if the duration time of the second pressing step is too long, the productivity is reduced. It follows that the duration time of the second pressing step should be set taking into consideration the flatness of the glass blank and the productivity. From these viewpoints, specifically, it is preferred that the duration time of the second pressing step be in a range of 2 to 40 seconds, and be in a range of 2 to 30 seconds.

Further, in order to control the flatness of the glass blank to be 10 μm or less, in the second pressing step, it is particularly preferred that the duration time of the second pressing step be selected so that the plate glass continues to be pressed until the temperature reaches a range in which the fluidity of the plate glass is lost and deformation thereof becomes impossible in effect. In this case, with a state in which the deformation of the plate glass immediately after the completion of the first pressing step is suppressed being maintained, the plate glass may be solidified. In consequence, a more excellent flatness of the produced glass blank may be obtained. Here, the duration time of the second pressing step is preferably selected so that the temperature of the plate glass when the second pressing step is completed is equal to or lower than a temperature which is 10° C. higher than the strain point of the glass material forming the plate glass, more preferably selected so that the temperature is equal to or lower than a temperature which is 5° C. higher than the strain point, still more preferably selected so that the temperature is equal to or lower than the strain point. On the other hand, the lower limit of the temperature of the plate glass when the second pressing step is completed is not specifically limited, but, from the viewpoint of suppressing reduction of the productivity due to prolonged time necessary for carrying out the second pressing step, practically, it is preferred that the lower limit be equal to or higher than the strain point. Therefore, it is preferred that the upper limit of the duration time of the second pressing step be also selected from this viewpoint.

In the method of manufacturing a glass blank according to the first embodiment, at least during the period in which the first pressing step and the second pressing step are carried out, the temperature of the press-molding surface of the first press mold and the temperature of the press-molding surface of the second press mold need to be substantially the same. “Substantially the same” as used herein means that the absolute value of the difference between the temperature of the press-molding surface of the first press mold and the temperature of the press-molding surface of the second press mold is 10° C. or less. The absolute value of the temperature difference is more preferably 5° C. or less, most preferably equal to 0° C. Here, when a temperature distribution exists within a press-molding surface, the “temperature of the press-molding surface” means the temperature of the vicinity of a central portion of the press-molding surface. Note that, for the sake of reference, in the vertical direct press method, the absolute value of the difference between the temperature of a press-molding surface of an upper mold and the temperature of a press-molding surface of a lower mold when a molten glass gob is being press-molded is, depending on the conditions of the press molding, generally on the order of 50° C. to 100° C.

In the first pressing step, the molten glass gob is pressed after the press-molding surface of the first press mold and the press-molding surface of the second press mold are brought into contact with the molten glass gob substantially at the same time. “Brought into contact substantially at the same time” as used herein means that the absolute value of the temporal difference between a point in time at which the molten glass gob and one of the press-molding surfaces are brought into contact with each other and a point in time at which the molten glass gob and the other of the press-molding surfaces are brought into contact with each other is 0.1 second or less. The absolute value of the temporal difference is more preferably 0.05 second or less, most preferably equal to 0 seconds. Note that, for the sake of reference, in the vertical direct press method, time taken for the molten glass gob to, after being brought into contact with the press-molding surface of the lower mold, be brought into contact with the press-molding surface of the upper mold is, depending on the conditions of the press molding, generally on the order of 1.5 seconds to 3 seconds.

Note that, even in the conventional vertical direct press, if, after a molten glass gob is formed into plate glass with an upper mold and a lower mold, the plate glass is cooled to a temperature around the strain point with the plate glass being pressed with the upper mold and the lower mold, significant improvement of the flatness of the glass blank may be expected. However, in this case, time required for press-molding one glass blank significantly increases, and thus, significant reduction of the productivity is inevitable, which is not practical (see paragraph [0009] of Patent Literature 1). Therefore, the applicant of the subject application has given up adoption and commercialization of a technology for cooling a plate glass to a temperature around the strain point with the plate glass being pressed with the upper mold and the lower mold in the vertical direct press, and, has attempted to accomplish both the productivity and the improvement of the flatness of a glass blank with various alternative technologies such as using an upper mold for cooling as exemplified in Patent Literature 1.

It is thought that, from these circumstances, even when a glass blank is mass-produced using the horizontal direct press which is a press method similar to the vertical direct press in that press molding is carried out with a pair of press molds, to move the first press mold and the second press mold away from each other as early as possible and to take out the plate glass are extremely important, because this facilitates an attempt to accomplish, after a molten glass gob is formed into plate glass, both the productivity and the improvement of the flatness of the glass blank. Therefore, it is thought that, when a glass blank is mass-produced using the horizontal direct press, carrying out the second pressing step in which, even after a molten glass gob is formed into plate glass, the plate glass continues to be pressed until the temperature of the plate glass is equal to or lower than a temperature which is 10° C. higher than the strain point just results in significant reduction of the productivity of the glass blank, which is not practical. However, intensive study of the inventors of the first aspect of the present invention revealed that, in the horizontal direct press, even if the second pressing step was carried out, reduction of the productivity which was significant enough to impair the practicability did not occur. The reason is as follows.

First, in the vertical direct press, after the molten glass gob is placed in the lower mold, press molding is carried out. Therefore, the molten glass gob having a wide temperature distribution (viscosity distribution) caused by the contact with the lower mold for a long time is required to be press-molded with the upper mold and the lower mold without fail. On the other hand, in the horizontal direct press, a falling molten glass gob is press-molded with a pair of press molds which sandwich the falling molten glass gob. Therefore, the molten glass gob does not continue to be in contact with one press mold before the start of the press molding. As a result, the temperature distribution (viscosity distribution) of the molten glass gob at the time of the start of the press molding is extremely uniform. Therefore, in order to stretch evenly and thinly molten glass gobs by press molding to produce glass blanks having similar thicknesses by the horizontal direct press and the vertical direct press, respectively, the average temperature of the molten glass gob in the vertical direct press is required to be set to be higher than that in the horizontal direct press taking into consideration the temperature distribution of the molten glass gob. Therefore, the difference between the average temperature of the molten glass gob and the strain point at the time of the start of the press molding in the vertical direct press is larger than that in the horizontal direct press. This fact (first fact) means that, in order to cool a molten glass gob which is formed into a plate shape to a temperature around the strain point, if the cooling speeds of the molten glass gob and the plate glass are the same in the press method of the horizontal direct press and in the press method of the vertical direct press, the cooling may be carried out in a shorter time in the horizontal direct press than in the vertical direct press.

Suppose that the heat capacity of the press mold is similar irrespective of the press method. Then, the cooling speeds of the molten glass gob and the plate glass are determined by the temperature of the pair of press molds which are brought into contact with the molten glass gob. More specifically, at the time of the start of the press molding, the cooling speed is increased when a press mold at a low temperature is used, while the cooling speed is reduced when a press mold at a high temperature is used. Here, in the vertical direct press, the lower mold and the molten glass gob are in contact with each other for a long time until the start of the press molding, and thus, the lower mold is heated by the molten glass gob until the start of the press molding. Therefore, in the vertical direct press, the press molding always starts with one of the pair of press molds (the lower mold) being at a higher temperature. This fact (second fact) means that it is extremely easy to increase the cooling speeds of the molten glass gob and the plate glass in the horizontal direct press compared with the case of the vertical direct press.

Taking the above-mentioned two facts into consideration, it is clear that the time necessary for cooling the temperature of the molten glass gob which is formed into a plate shape to a temperature around the strain point may be more significantly reduced in the horizontal direct press than in the vertical direct press. Therefore, in the horizontal direct press, even if the second pressing step is carried out, reduction of the productivity which is significant enough to impair the practicality as in the vertical direct press does not occur.

The method of manufacturing a glass blank according to the first embodiment described above is not specifically limited insofar as at least the first pressing step, the second pressing step, and the taking out step are included therein, but, usually, it is preferred that a molten glass gob forming step be included therein. The respective steps including the molten glass gob forming step are described in more detail in the following. Note that, in the following description, description of points already described above is omitted.

### —Molten Glass Gob Forming Step—

In the molten glass gob forming step, a molten glass gob with regard to which press molding is carried out is produced. The method of producing the molten glass gob is not specifically limited, but, usually, the molten glass gob is formed by causing molten glass to fall from a glass outlet and cutting a forward end portion of a molten glass flow continuously flowing out downward in the vertical direction. Note that, in the cutting which is carried out so as to separate from the molten glass flow the forward end portion thereof, a pair of shear blades may be used. The viscosity of the molten glass is not specifically limited insofar as the viscosity is appropriate for the cutting of the forward end portion and for the press molding, but, usually, it is preferred that the viscosity be controlled to have a predetermined value in a range of 500 dPa·s to 1,050 dPa·s.

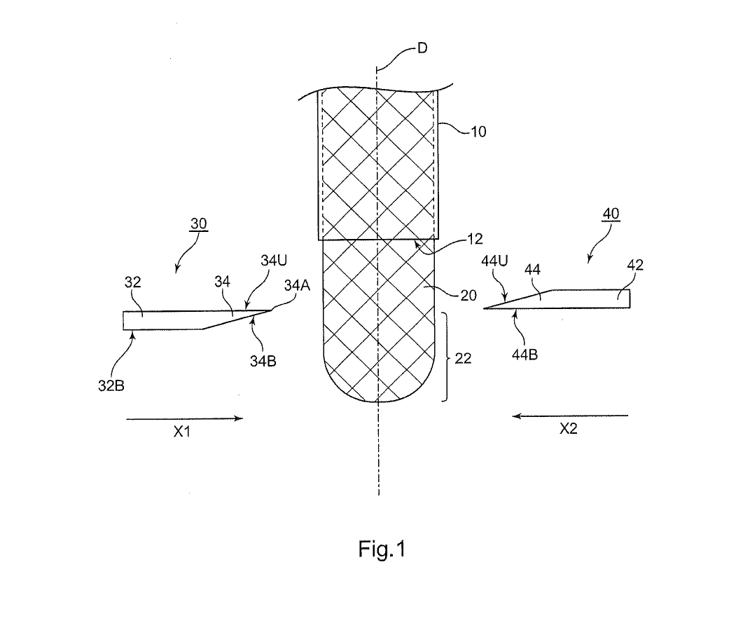

Next, a specific example of the molten glass gob forming step is described in more detail with reference to the drawings. In the molten glass gob forming step, as illustrated in FIG. 1, a molten glass flow 20 is caused to flow out continuously downward in the vertical direction from a glass outlet 12 provided at the lower end portion of a molten glass effluent pipe 10 whose upper end portion is connected to a molten glass supply source (not shown). On the other hand, at a portion lower than the glass outlet 12, a first shear blade (lower side blade) 30 and a second shear blade (upper side blade) 40 are arranged at both sides of the molten glass flow 20, respectively, in the direction substantially perpendicular to a central axis D, which is the falling direction of the molten glass flow 20. The lower side blade 30 and the upper side blade 40 move in a direction of an arrow X1 which is perpendicular to the central axis D and which is from a left side to a right side in the figure, and in a direction of an arrow X2 which is perpendicular to the central axis D and which is from the right side to the left side in the figure, respectively, thereby approaching a forward end portion 22 side of the molten glass flow 20 from both sides of the molten glass flow 20. Note that, the viscosity of the molten glass flow 20 is controlled by adjusting the temperatures of the molten glass effluent pipe 10 and the molten glass supply source which is upstream thereof.

Further, the lower side blade 30 and the upper side blade 40 have substantially plate-like body portions 32 and 42 and blade portions 34 and 44, respectively. The blade portions 34 and 44 are provided on end portion sides of the body portions 32 and 42, respectively, and cut the forward end portion 22 of the molten glass flow 20 continuously flowing out downward in the vertical direction from a direction substantially perpendicular to the direction in which the molten glass flow 20 falls down. Note that, an upper surface 34U of the blade portion 34 and a lower surface 44B of the blade portion 44 each have a surface substantially coincident with a horizontal plane, and a lower surface 34B of the blade portion 34 and an upper surface 44U of the blade portion 44 each have a surface that is slanted so as to cross the horizontal plane. Further, the lower side blade 30 and the upper side blade 40 are placed so that the upper surface 34U of the blade portion 34 and the lower surface 44B of the blade portion 44 are substantially flush with each other with respect to the vertical direction.

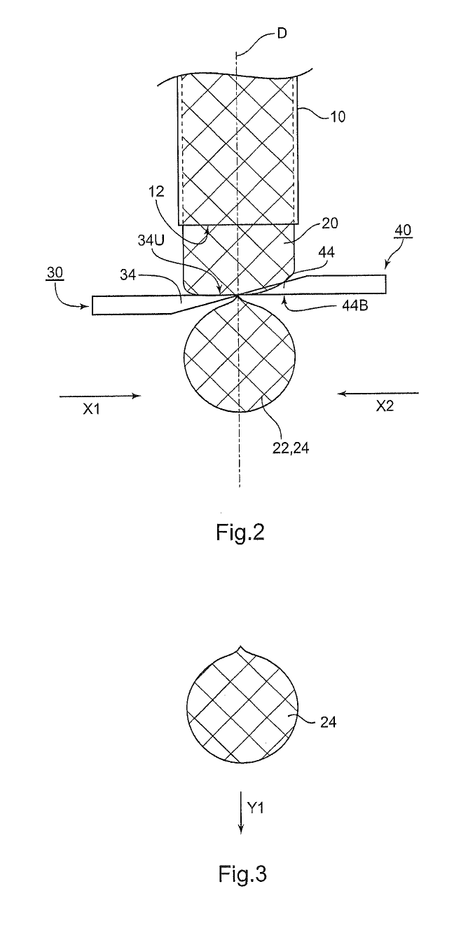

Next, as illustrated in FIG. 2, the lower side blade 30 and the upper side blade 40 are each moved in the horizontal direction so that the upper surface 34U of the blade portion 34 and the lower surface 44B of the blade portion 44 are partially overlapped substantially without any gap by further moving the lower side blade 30 and the upper side blade 40 toward the direction of the arrow X1 and the direction of the arrow X2, respectively. That is, the lower side blade 30 and the upper side blade 40 are caused to perpendicularly cross the central axis D. As a result, the lower side blade 30 and the upper side blade 40 penetrate into the molten glass flow 20 until reaching the vicinity of the central axis D thereof, and the forward end portion 22 is cut as a molten glass gob 24 having a substantially spherical shape. Note that, FIG. 2 illustrates the moment when the forward end portion 22 is separated from the body portion of the molten glass flow 20 as the molten glass gob 24. Further, as illustrated in FIG. 3, the molten glass gob 24 cut from the molten glass flow 20 further falls to a downward Y1 side in the vertical direction.

### —First Pressing Step—

In the first pressing step, the falling molten glass gob 24 illustrated in FIG. 3 is pressed with the first press mold and the second press mold which are placed so as to be opposed to each other in a direction crossing a direction in which the molten glass gob 24 falls to be formed into a plate shape. Here, it is preferred that the first press mold and the second press mold be placed so as to be opposed to each other in a direction substantially perpendicular to the direction in which the molten glass gob 24 falls so as to form an angle in a range of 90 degrees±1 degree, and it is particularly preferred that the first press mold and the second press mold be placed so as to be opposed to each other in a direction perpendicular to the direction in which the molten glass gob 24 falls. By placing the pair of press molds so as to be opposed to each other with respect to the direction in which the molten glass gob 24 falls in this way, it is further facilitated to press the molten glass gob 24 evenly from both sides to be formed into a plate shape.

Further, the temperatures of the press-molding surfaces of the first press mold and the second press mold immediately before the first pressing step is carried out is preferably equal to or lower than a temperature which is 10° C. higher than the strain point of the glass material forming the molten glass gob 24, more preferably equal to or lower than a temperature which is 5° C. higher than the strain point of the glass material forming the molten glass gob 24. By causing the temperatures of the press-molding surfaces to be in the above-mentioned range, fusion between the molten glass gob 24 and the press-molding surfaces in the press molding may be suppressed with reliability. The lower limit of the temperatures of the press-molding surfaces of the first press mold and the second press mold immediately before the first pressing step is carried out is not specifically limited, but, from practical viewpoints, that is, in order to prevent a crack in the glass blank due to rapid cooling of the molten glass gob 24, in order to prevent significant reduction of the stretchability of the molten glass gob 24 due to rapid increase of the viscosity in the press molding, and the like, it is preferred that the lower limit be equal to or higher than the strain point of the glass material forming the molten glass gob 24.

Further, the absolute value of the difference between the temperature of the press-molding surface of the first press mold and the temperature of the press-molding surface of the second press mold immediately before the first pressing step is carried out is preferably in a range of 0° C. to 10° C., more preferably in a range of 0° C. to 5° C., particularly preferably 0° C. In this case, temperature difference caused between both the surfaces of the plate glass which is formed into a plate shape by pressing the molten glass gob 24 may be suppressed with more reliability, and as a result, the flatness may be further improved.

Further, the absolute values of the temperature differences within the press-molding surfaces of the first press mold and the second press mold immediately before the first pressing step is carried out is preferably in a range of 0° C. to 100° C., preferably in a range of 0° C. to 50° C., particularly preferably 0° C. By causing the temperature distribution within the press-molding surfaces to be in the above-mentioned range, to stretch evenly and thinly the molten glass gob 24 in the press molding becomes further easier. As a result, even when a glass blank having a smaller thickness is manufactured, a glass blank which is excellent in flatness and has smaller thickness deviation may be more easily obtained. Note that, “temperature within a press-molding surface” means temperature measured in a largest region in which the press-molding surface and the molten glass gob 24 stretched into a plate shape are in contact with each other in the press molding.

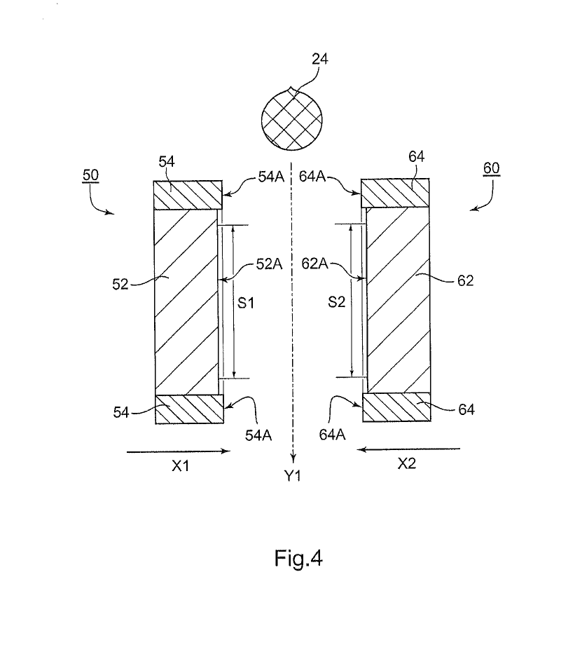

Next, the first pressing step is described more specifically with reference to the drawings. First, the molten glass gob 24 illustrated in FIG. 3 comes between a first press mold 50 and a second press mold 60 which are placed so as to be opposed to each other in a direction perpendicular to the direction Y1 in which the molten glass gob 24 falls as illustrated in FIG. 4. Here, the first press mold 50 and the second press mold 60 before the press molding is carried out are placed at an interval so as to be opposed to each other in a direction having line symmetry with respect to and perpendicular to the falling direction Y1. Then, in synchronization with the timing when the molten glass gob 24 reaches the vicinity of the central portions in the vertical direction of the first press mold 50 and the second press mold 60, the first press mold 50 moves in the direction of the arrow X1 which is perpendicular to the falling direction Y1 and which is from the left side to the right side in the figure and the second press mold 60 moves in the direction of the arrow X2 which is perpendicular to the falling direction Y1 and which is from the right side to the left side in the figure in order to press-mold the molten glass gob 24 by pressing from both sides. Note that, the moving rate of the first press mold 50 in the direction of the arrow X1 and the moving rate of the second press mold 60 in the direction of the arrow X2 are set to be the same or substantially the same.

Here, the press molds 50 and 60 include press mold bodies 52 and 62 each having a disk-like shape, respectively, and guide members 54 and 64 arranged so as to surround the outer peripheral ends of each of the press mold bodies 52 and 62, respectively. Note that, because FIG. 4 is a cross-sectional view, the guide members 54 and 64 are drawn as being positioned on both the upper and lower sides of the press mold bodies 52 and 62, respectively, in FIG. 4. Further, drive members for moving the press mold 50 in the direction of the arrow X1 and for moving the press member 60 in the direction of the arrow X2 are omitted in the figures.

One surface of each of the press mold bodies 52 and 62 serves as press-molding surfaces 52A and 62A, respectively. Further, in FIG. 4, the first press mold 50 and the second press mold 60 are arranged so that the two press-molding surfaces 52A and 62A face each other. Further, the guide member 54 is provided with a guide surface 54A, which is positioned so as to project slightly with respect to the press-molding surface 52A in the X1 direction, and the guide member 64 is provided with a guide surface 64A, which is positioned so as to project slightly with respect to the press-molding surface 62A in the X2 direction. Then, the guide surface 54A and the guide surface 64A come into contact with each other at the time of press molding, and hence a gap is formed between the press-molding surface 52A and the press-molding surface 62A. Thus, the thickness of the gap corresponds to the thickness of the molten glass gob 24 molded so as to have a plate shape by being press-molded between the first press mold 50 and the second press mold 60, that is, the thickness of a glass blank. Further, the press-molding surfaces 52A and 62A are formed so that, when the press-molding step is carried out so that the molten glass gob 24 is completely extended by pressure in the vertical direction and is molded into a plate glass between the press-molding surface 52A of the first press mold 50 and the press-molding surface 62A of the second press mold 60, at least regions (molten glass stretching regions) S1 and S2 in contact with the above-mentioned plate glass in each of the press-molding surfaces 52A and 62A form a substantially flat surface. Note that, in the example illustrated in FIG. 4, the whole part of the press-molding surface 52A including the molten glass stretching region S1 and the whole part of the press-molding surface 62A including the molten glass stretching region S2 each are a usual flat surface whose curvature is substantially zero. Further, the flat surface has only minute irregularities which are formed when usual flattening processing, usual mirror polishing processing, or the like is applied at the time of manufacturing press molds, but does not have convex portions and/or concave portions larger than the minute irregularities.

The glass blank is produced by press molding the molten glass gob 24 by pressure between the press-molding surfaces 52A and 62A. Thus, the surface roughness of the press-molding surfaces 52A and 62A and the surface roughness of the main surfaces of the glass blank become substantially the same. The surface roughness (central line average roughness Ra) of the main surfaces of the glass blank is desirably controlled to the range of 0.01 to 10 μm in view of performing scribe processing and grinding processing using a diamond sheet that are carried out as the post processes to be described below, and hence the surface roughness (central line average roughness Ra) of the press-molding surfaces is also preferably controlled to the range of 0.01 to 10 μm.

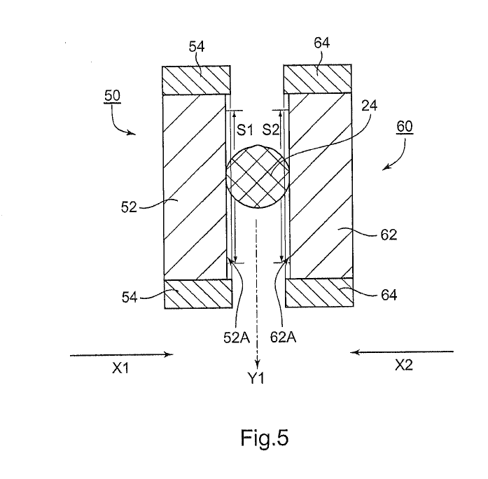

The molten glass gob 24 illustrated in FIG. 4 falls further downward and enters the space between the two press-molding surfaces 52A and 62A. Then, as illustrated in FIG. 5, at the time when the molten glass gob 24 reaches the vicinity of the almost central portion in the vertical direction of the press-molding surfaces 52A and 62A parallel to the falling direction Y1, both side surfaces of the molten glass gob 24 come into contact with the press-molding surfaces 52A and 62A at the same time or substantially at the same time.

Here, in additional consideration of the viewpoint of preventing the situation that press molding becomes difficult to carry out because of the increase of the viscosity of a falling molten glass gob 24 or the situation that the position of press fluctuates because of an excessively high falling speed, the falling distance is preferably selected from the range of 1,000 mm or less, more preferably selected from the range of 500 mm or less, still more preferably selected from the range of 300 mm or less, most preferably selected from the range of 200 mm or less. Note that, the lower limit of the falling distance is not particularly limited, but is preferably 100 mm or more for practical use. Note that, the term “falling distance” means a distance from the position at the moment when the forward end portion 22 is separated as the molten glass gob 24 as illustrated in FIG. 2, that is, the position at which the lower side blade 30 and the upper side blade 40 are overlapped in the vertical direction, until the position at the time of the start of the press molding (the moment of the start of the press molding) as illustrated in FIG. 5, that is, the vicinity of the almost central portion in the diameter direction of the press-molding surfaces 52A and 62A parallel to the falling direction Y1.

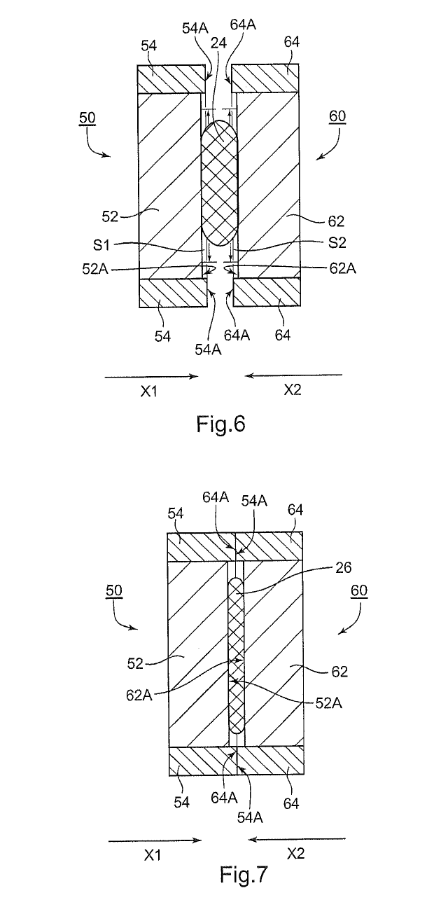

Next, as illustrated in FIG. 6, when the molten glass gob 24 is continuously pressed from its both sides with the first press mold 50 and the second press mold 60, the molten glass gob 24 is extended by pressure so as to have a uniform thickness around the position at which the molten glass gob 24 and each of the press-molding surfaces 52A and 62A first come into contact. Then, as illustrated in FIG. 7, the molten glass gob 24 is continuously pressed with the first press mold 50 and the second press mold 60 until the guide surface 54A and the guide surface 64A come into contact, thereby being formed into a disk-shaped or disk-like plate glass 26 between the press-molding surfaces 52A and 62A.

Here, the plate glass 26 illustrated in FIG. 7 has substantially the same shape and thickness as the glass blank to be finally obtained. Further, the size and shape of both surfaces of the plate glass 26 are the same as those of the molten glass stretching regions S1 and S2 (not shown in FIG. 7). Further, the time taken from the state at the time of the start of the press molding illustrated in FIG. 5 until a state in which the guide surface 54A and the guide surface 64A come into contact with each other as illustrated in FIG. 7 (hereinafter, referred to as “press molding time” in some cases) is preferably 0.1 second or less from the viewpoint of forming the molten glass gob 24 into a plate glass. Moreover, because a state in which the guide surface 54A and the guide surface 64A come into contact with each other is established at the time of the press molding, it becomes easy to maintain the parallel state between the press-molding surface 52A and the press-molding surface 62A. Note that, the lower limit of the press molding time is not particularly limited, however, it is preferably 0.05 second or more for practical use.

Note that, the press mold 50 illustrated in FIG. 4 to FIG. 7 includes a press mold body 52 and a guide member 54, and the press mold 60 has a similar structure. However, the pair of press molds used in the method of manufacturing a glass blank according to the first embodiment is not limited to those of the type illustrated in FIG. 4 to FIG. 7 insofar as the pair of press molds may press-mold the molten glass gob 24 into a plate shape. For example, as the pair of press molds, ones of a type formed of press mold bodies 52 and 62 which are formed by removing the guide members 54 and 64 from the press molds 50 and 60 illustrated in FIG. 4 to FIG. 7, respectively (of a guide-memberless type), may also be used. Further, the press molds 50 and 60 illustrated in FIG. 4 to FIG. 7 may be of the integral type in which the press mold bodies 52 and 62 and the guide members 54 and 64 are integrally formed, respectively, or may be of a separate type in which the press mold bodies 52 and 62 and the guide members 54 and 64 are formed as separate members, respectively. Note that, when the press molds 50 and 60 are of the separate type, in the first pressing step, the press mold body 52 and the guide member 54 move in the direction of the arrow X1 at the same time and integrally, and the press mold body 62 and the guide member 64 move in the direction of the arrow X2 at the same time and integrally.

Note that, the press molds 50 and 60 include the guide members 54 and 64, respectively, and thus, when the guide member 54 and the guide member 64 are in contact with each other as illustrated in FIG. 7, the press-molding surface 52A and the press-molding surface 62A are held in parallel with each other. Therefore, even if a state in which the press-molding surface 52A and the press-molding surface 62A are in parallel with each other can not be maintained in the process in which the press mold 50 moves in the direction of the arrow X1 and the press mold 60 moves in the direction of the arrow X2 as illustrated in FIG. 4 to FIG. 6, it is easy to cause the obtained glass blank to have very small thickness deviation. In consequence, a drive for driving the press molds 50 and 60 is not required to have controlling ability to control the press-molding surface 52A and the press-molding surface 62A to be always maintained in a precisely parallel state in a series of process illustrated in FIG. 4 to FIG. 7.

### —Second Pressing Step—

In the second pressing step, the plate glass 26 formed between the first press mold 50 and the second press mold 60 continues to be pressed with the first press mold 50 and the second press mold 60. More specifically, the plate glass 26 continues to be pressed with the first press mold 50 and the second press mold 60 with a state immediately after the first pressing step illustrated in FIG. 7 is completed being maintained. Here, the duration time of the second pressing step is controlled so that the flatness of the glass blank is 10 μm or less.

Note that, during a period from immediately after the start of the first pressing step at which the press-molding surfaces 52A and 62A and the molten glass gob 24 are brought into contact with each other to when the second pressing step is completed, the temperature of the glass (the molten glass gob 24 and the plate glass 26) located between the press-molding surface 52A and the press-molding surface 62A is, depending on the glass material used in the press molding, generally significantly lowered from on the order of 1,200±50° C. to on the order of 480° C.±20° C. In addition to this, in the second pressing step, the plate glass 26 continues to be pressed, and thus, the fluidity of the plate glass 26 is also lowered with time. In particular, when the plate glass 26 continues to be pressed until the temperature is equal to or lower than a temperature which is 10° C. higher than the strain point of the glass material forming the plate glass 26, the fluidity of the plate glass 26 is almost completely lost. In consequence, in the second pressing step, as the temperature is significantly lowered in this way, heat shrinkage of the plate glass 26 in the diameter direction progresses. On the other hand, in the second pressing step, the press-molding surfaces 52A and 62A which are in contact with both the surfaces of the plate glass 26 are thought to continue to absorb heat of the plate glass 26 to thermally expand in an in-plane direction or, by completing absorption of enough heat from the plate glass 26, stop thermal expansion in the in-plane direction or turn to mild heat shrinkage.

More specifically, in the second pressing step, a difference occurs between the extent of the thermal expansion/heat shrinkage of both the surfaces of the plate glass 26 and that of the press-molding surfaces 52A and 62A. Therefore, in the second pressing step, force to extend in the diameter direction of the plate glass 26, that is, force in the direction opposite to the heat shrinkage acts on both the surfaces of the plate glass 26 which is undergoing the heat shrinkage by the press-molding surfaces 52A and 62A. However, in the second pressing step, the fluidity of the plate glass 26 is significantly lowered as the second pressing step progresses, and thus, if excessive stress acts on the plate glass 26, brittle fracture in the plate glass 26 is liable to occur. Therefore, if the force in the direction opposite to the heat shrinkage always continues to act on both the surfaces of the plate glass 26, excessive stress acts on the plate glass 26 in the in-plane direction, which may result in a crack in the plate glass 26.

In order to prevent such a crack in the plate glass 26, (1) to use as a material forming the press molds 50 and 60 a material having the thermal expansion coefficient similar to that of the glass material forming the plate glass 26, and in addition, (2) in the second pressing step, to carry out cooling with the temperature of the plate glass 26 and the temperatures of the press-molding surfaces 52A and 62A being synchronized with each other are thought of. However, the second pressing step involves the significant temperature change, and thus, in order to carry out the above-mentioned cooling, it is necessary to cause the cooling speed to be very low. However, in this case, time necessary for carrying out the second pressing step significantly increases, and thus, there is a possibility that the mass productivity is lowered significantly, which is not practical.

Taking into consideration the points described above, in order to prevent a crack in the plate glass 26 in the second pressing step with more reliability, it is preferred that, in the second pressing step, a press pressure be reduced with time. In this case, reduction of the press pressure reduces friction coefficients between both the surfaces of the plate glass 26 and the press-molding surfaces 52A and 62A, respectively. As a result, slippage occurs between both the surfaces of the plate glass 26 and the press-molding surfaces 52A and 62A, respectively, which facilitates interruption of force which acts on both the surfaces of the plate glass 26 in the opposite direction to the heat shrinkage and which is a cause of a crack. The phrase “press pressure is reduced with time” as used herein includes, in the second pressing step, not only a case in which the press pressure is reduced with time but also a case in which, even if the press pressure is temporarily increased or maintains a fixed value with time, when change in press pressure with time is approximated by a linear equation, the slope thereof is negative. Further, the press pressure may be reduced stepwise with time, or may be reduced continuously with time.

Note that, when the press pressure is reduced stepwise with time, the press pressure is preferably reduced when the temperature of the plate glass 26 sandwiched between the first press mold 50 and the second press mold 60 is lowered to a range of ±30° C. from the defromation point of the glass material forming the plate glass 26. This enables more effective suppression of a crack in the plate glass 26 with relatively simple control of the press pressure. Note that, in this case, from the viewpoint of accomplishing in balance both the suppression of a crack in the plate glass 26 with reliability and the suppression of deterioration of the flatness, the press pressure is preferably in a range of on the order of 1% to 10% after the reduction with that before the reduction being 100%.

Further, in the second pressing step, instead of reducing the press pressure with time, the press pressure may be changed in a wavelike manner with time. In this case, for example, the press pressure may be changed periodically like rectangular waves or sine waves with time. In this case, when the press pressure reaches the vicinity of a minimum with time, the friction coefficients between both the surfaces of the plate glass 26 and the press-molding surfaces 52A and 62A, respectively, are reduced. As a result, slippage occurs between both the surfaces of the plate glass 26 and the press-molding surfaces 52A and 62A, respectively, which facilitates interruption of force which acts on both the surfaces of the plate glass 26 in the opposite direction to the heat shrinkage and which is a cause of a crack.

Note that, in the second pressing step, heat shrinkage of the plate glass 26 occurs not only in the diameter direction but also in a thickness direction although the amount thereof is small. Therefore, during the second pressing step, there are some cases in which a small gap is formed between the press-molding surfaces 52A and 62A and the plate glass 26, respectively. In this case, when a gap is formed, compared with a case in which the press-molding surface 52A and the press-molding surface 62A are in intimate contact with the plate glass 26 without a gap, the heat conduction efficiency between the two members is lowered. As a result, a temperature distribution between both the surfaces of the plate glass 26 or within the surfaces is liable to occur. Such a temperature distribution causes a viscosity distribution (nonuniform fluidity) in the plate glass 26, and thus, warpage of the plate glass 26 is liable to occur and the flatness of the obtained glass blank is liable to be deteriorated.

Taking into consideration the points described above, it is preferred that, during the second pressing step, one surface of the plate glass 26 and the press-molding surface 52A of the first press mold 50 be always in intimate contact with each other without a gap and the other surface of the plate glass 26 and the press-molding surface 62A of the second press mold 60 be always in intimate contact with each other without a gap. In this case, as the pair of press molds, press molds having the press-molding surfaces which are excellent in followability to the heat shrinkage of the plate glass 26 in the thickness direction may be used. As such press molds, specifically, press molds of the guide-memberless type formed of the press mold bodies 52 and 62 which are formed by removing the guide members 54 and 64 from the press molds 50 and 60, respectively, or the press molds 50 and 60 of the separate type in which the press mold bodies 52 and 62 and the guide members 54 and 64 are formed as separate members, respectively, may be used. Note that, when the press molds 50 and 60 of the separate type are used, in the second pressing step, by pressing only the press mold body 52 in the direction of the arrow X1 and pressing only the press mold body 62 in the direction of the arrow X2, the press pressure is applied to the plate glass 26.

### —Taking Out Step—

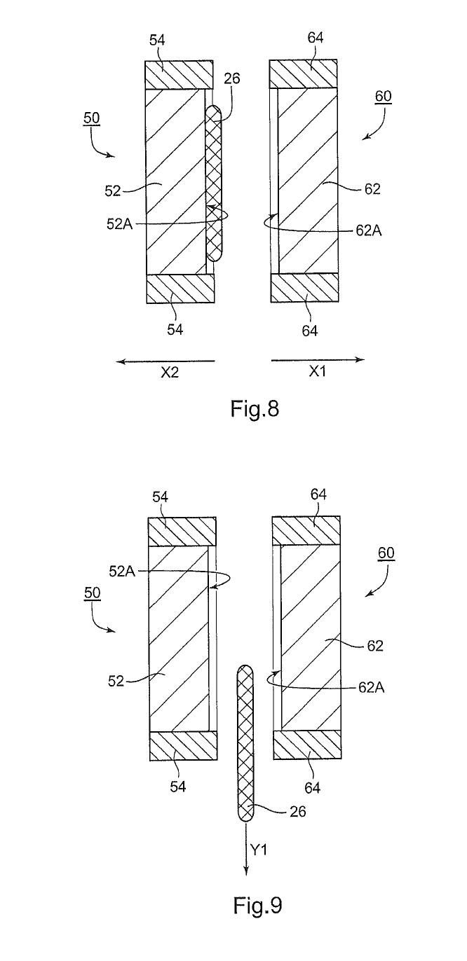

After the second pressing step is carried out, the taking out step is carried out in which the first press mold 50 and the second press mold 60 are moved away from each other and the plate glass 26 sandwiched between the first press mold 50 and the second press mold 60 is taken out. The taking out step may be carried out as, for example, described in the following. First, as illustrated in FIG. 8, the first press mold 50 is moved in the direction of the arrow X2 and the second press mold 60 is moved in the direction of the arrow X1 so that the first press mold 50 and the second press mold 60 are moved away from each other. This releases the press-molding surface 62A from the plate glass 26. Next, as illustrated in FIG. 9, the plate glass 26 is released from the press-molding surface 52A, and the plate glass 26 is caused to fall to the downward Y1 side in the vertical direction and is taken out. Note that, when the plate glass 26 is released from the press-molding surface 52A, by applying force from an outer peripheral direction of the plate glass 26, the plate glass 26 may be released as if the plate glass 26 is stripped off. In this case, the plate glass 26 may be taken out without applying great force thereto. Note that, in taking out the plate glass 26, the plate glass 26 may be released from the press-molding surface 62A after the plate glass 26 is released from the press-molding surface 52A. Finally, the plate glass 26 which is taken out is annealed as necessary to reduce or remove strain thereon, and a base material from which the magnetic recording medium glass substrate is formed, that is, the glass blank, is obtained.

### —Glass Blank—

With regard to the glass blank obtained by the method of manufacturing a glass blank according to the first embodiment described above, the flatness may be caused to be 10 μm or less, and it is extremely easy to even cause the flatness to be 4 μm or less. Note that, from the viewpoint of eliminating or shortening downstream steps such as a lapping step which are carried out mainly for the purpose of improving the flatness, the flatness is preferably 4 μm or less.

### —Press Mold—

It is preferred to use a metal or an alloy as a material for forming each of the press molds 50 and 60 in view of heat resistance, workability, and durability. In this case, in view of the temperature of molten glass, the heat resistant temperature of the metal or alloy for forming each of the press molds 50 and 60 is preferably 1,000° C. or more, more preferably 1,100° C. or more. Specific examples of the material for forming each of the press molds 50 and 60 preferably include ferrum casting ductile (FCD), alloy tool steel (such as SKD61), high-speed steel (SKH), cemented carbide, Colmonoy, and Stellite. Note that, it may be possible to control the press molding by cooling the press molds 50 and 60 by using a cooling medium such as water or air so that the temperatures of the press molds 50 and 60 do not rise. Further, for the purpose of causing the temperature distribution within the press-molding surfaces 52A and 62A to be uniform, the cooling medium may be used to cool the vicinity of the central portions of the press-molding surfaces 52A and 62A and/or a heating member such as a heater may be placed on outer peripheral sides of the press molds 50 and 60 to heat the outer edge sides of the press-molding surfaces 52A and 62A.

Further, regions (molten glass stretching regions S1 and S2) in contact with at least the plate glass 26 of the press-molding surfaces 52A and 62A of the first press mold 50 and the second press mold 60, respectively, may be surfaces having formed thereon as significant an irregular portion as, for example, a convex portion for forming in the surfaces of the glass blank a V-shaped groove or the like having the depth on the order of ⅓ to ¼ of the thickness thereof, but, usually, it is preferred that the regions be substantially flat surfaces. Note that, the whole of the press-molding surfaces 52A and 62A may be substantially flat surfaces. A reason for this is that, when a large V-shaped groove is formed in the glass blank, a crack defect which is assumed to be due to stress concentration on the V-shaped groove portion is liable to be caused. In addition to this, when a significantly irregular portion is formed in the molten glass stretching regions S1 and S2, heat shrinkage of the plate glass 26 in the diameter direction in the second pressing step is prevented. Therefore, excessive stress is produced in the plate glass 26 in the in-plane direction, which causes the plate glass 26 to be liable to be cracked.

Here, the term “substantially flat surface” not only means a usual flat surface whose curvature is substantially zero, but also means a surface having such a very small curvature that a slightly convex surface or a slightly concave surface is formed. Further, it is naturally allowed for the “substantially flat surface” to have minute irregularities which are formed when usual flattening processing, usual mirror polishing processing, or the like is applied at the time of manufacturing press molds, and it is also acceptable for the “substantially flat surface” to have convex portions and/or concave portions larger than the minute irregularities, if necessary.

Here, it is allowed for the convex portion larger than the minute irregularity to include a substantially point-shaped convex portion and/or a substantially linear-shaped convex portion each having such a height of 20 μm or less that those portions have a slight chance of bringing about the deterioration of flow resistance and promoting the partial cooling of a molten glass gob. Note that, the height is preferably 10 μm or less, more preferably 5 μm or less. Further, when the convex portion larger than the minute irregularity is a trapezoid-shaped convex portion having a minimum width in top surface on the order of several millimeters or more, or a dome-shaped convex portion having nearly the same height and size as the trapezoid-shaped convex portion instead of the substantially point-shaped convex portion and substantially linear-shaped convex portion, the above-mentioned chance of bringing about the deterioration of flow resistance and promoting the partial cooling of a molten glass gob becomes smaller, and hence the convex portion is allowed to have a height of 50 μm or less. Note that, the height is preferably 30 μm or less, more preferably 10 μm or less. Further, from the viewpoint of suppressing the occurrence of a crack due to stress concentration at the intersection part between the bottom surface and a side surface of the trapezoid-shaped convex portion, it is preferred that the side surface of the trapezoid-shaped convex portion be a flat surface having an angle of slope of 0.5° or less with respect to the top surface, or be a curved surface created by modifying the flat surface to a concave surface. Note that, the angle is more preferably 0.1° or less.

Further, it is allowed for the concave portion larger than the minute irregularity to include a substantially point-shaped concave portion and/or a substantially linear-shaped concave portion each having a depth of 20 μm or less, in order that, for example, the deterioration of the flowability of molten glass flowing into the concave portion at the time of press molding is not brought about. Note that, the depth is preferably 10 μm or less, more preferably 5 μm or less. Further, when the concave portion larger than the minute irregularity is an inverted trapezoid-shaped concave portion having a minimum width in top surface on the order of several millimeters or more, or an inverted dome-shaped concave portion having nearly the same height and size as the inverted trapezoid-shaped concave portion instead of the substantially point-shaped concave portion and substantially linear-shaped concave portion, the above-mentioned chance of bringing about the deterioration of the flowability becomes smaller, and hence the concave portion is allowed to have a depth of 50 μm or less. Note that, the depth is preferably 30 μm or less, more preferably 10 μm or less. Further, from the viewpoint of suppressing the occurrence of a crack due to stress concentration at the intersection part between the bottom surface and a side surface of the trapezoid-shaped convex portion, it is preferred that the side surface of the trapezoid-shaped convex portion be a flat surface having an angle of slope of 0.5° or less with respect to the bottom surface, or be a curved surface created by modifying the flat surface to a concave surface. Note that, the angle is more preferably 0.1° or less.

In the method of manufacturing a glass blank according to the first embodiment of the present invention, as the press molds, as already described, (1) press molds of the guide-memberless type, (2) the press molds 50 and 60 of the integral type in which the press mold bodies 52 and 62 and the guide members 54 and 64 are integrally formed, respectively, (3) the press molds 50 and 60 of the separate type in which the press mold bodies 52 and 62 and the guide members 54 and 64 are formed as separate members, respectively, or the like may be used. From the viewpoint of accomplishing both the excellent flatness and the smaller thickness deviation in the most balanced way, it is most preferred that, among these three kinds of press molds, the press molds 50 and 60 of the separate type be used.

Here, it is preferred that, as the press molds 50 and 60 of the separate type, specifically, ones having a structure described below be used. That is, it is preferred that the press mold 50 (or the press mold 60) of the separate type at least include the press mold body 52 having the press-molding surface 52A substantially perpendicular to the horizontal direction, the guide member 54 having at least the function of maintaining a substantially fixed distance between the press-molding surfaces 52A and 62A of the pair of press molds 50 and 60, respectively, in the press molding, by, when pushed to the side of the other press mold 60 which is placed so as to be opposed to the press-molding surface 52A, being brought into contact with a part of the other press mold 60, a first pushing member for pushing at the same time the press mold body 52 and the guide member 54 in a direction substantially perpendicular to the press-molding surface 52A and to the other press mold 60 side, and a second pushing member for, after the first pushing member brings the guide member 54 and a part of the other press mold 60 into contact with each other, pushing the press mold body 52 in a direction substantially perpendicular to the press-molding surface 52A and to the press mold 60 side.

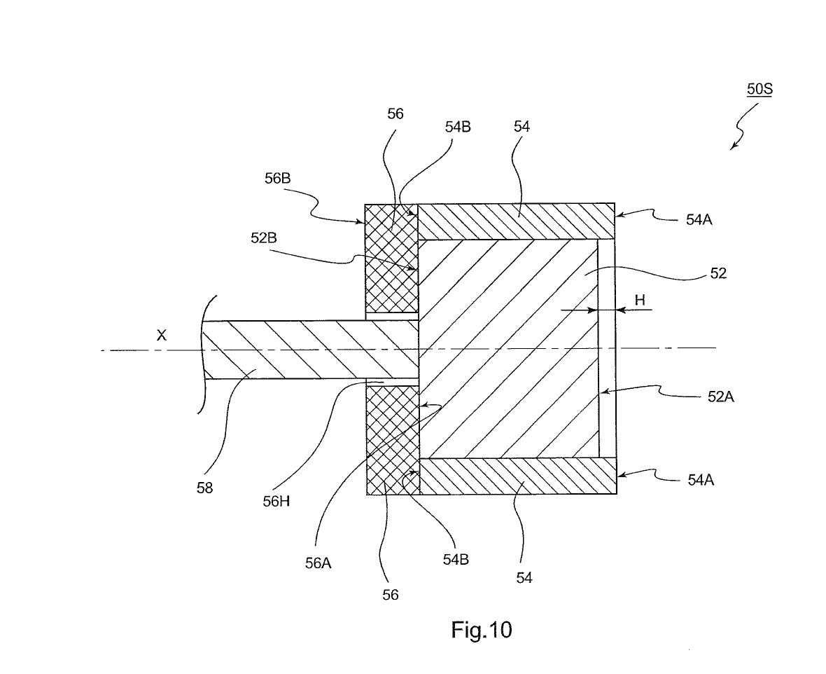

FIG. 10 is a schematic sectional view for illustrating one example of the press mold used in the method of manufacturing a glass blank for a magnetic recording medium glass substrate according to the first embodiment of the present invention, and more specifically, a view for illustrating one example of the press molds 50 and 60 of the separate type. In FIG. 10, like reference numerals are used to designate members similar to those illustrated in FIG. 4 to FIG. 9. Further, a press mold 50S illustrated in FIG. 10 is a figure corresponding to the press mold 50, but a similar structure may be adopted in the press mold 60. Here, a principal part of the press mold 50S includes the press mold body 52, the guide member 54, a first pushing member 56, and a second pushing member 58. Central axis of the members are coincident (dot-and-dash line X in the figure), and the central axis are substantially coincident with the horizontal direction.

Here, the press mold body 52 is formed of a circular cylinder having one end surface that forms the circular press-molding surface 52A. Note that, the shape of the press mold body 52 is a circular cylinder in the example illustrated in FIG. 10, but the shape is not specifically limited insofar as the shape is substantially columnar. In the example illustrated in FIG. 10, the press-molding surface 52A is a substantially flat surface.

The guide member 54 is a hollow circular cylinder, which has a length in an axial direction X that is longer than the length in the axial direction X of the press mold body 52 which is a circular cylinder, which houses the press mold body 52 in an inner peripheral side, and which has one end face (guide surface 54A) that is brought into contact with the guide member of the other press mold (not shown in the figure) when pushed by the first pushing member 56. Here, the difference between the length of the guide member 54 and the length of the press mold body 52 in the axial direction X, in other words, a height difference H between the guide surface 54A and the press-molding surface 52A in the axial direction X, corresponds to a length which is approximately a half of the thickness of the glass blank to be produced. Note that, the shape of the guide member 54 is a hollow circular cylinder, but the shape is not specifically limited insofar as the shape is hollow columnar.

The first pushing member 56 is formed of a disk-like member. Here, one surface (pushing surface 56A) of the disk-like first pushing member 56 is a flat surface which is in contact with the other end surface (pushed surface 52B) of the press mold body 52 and with the other end surface (pushed surface 54B) of the guide member 54. Further, a through hole 56H which passes through the first pushing member 56 in the thickness direction is provided in a part of a region which is opposed to the pushed surface 52B of the press mold body 52. Note that, a surface 56B which is opposite to the pushing surface 56A is connected to a first drive (not shown). Therefore, in the press molding, by the first drive, the press mold body 52 and the guide member 54 may be pushed at the same time via the first pushing member 56 in the axial direction X illustrated in the figure from the side on which the first pushing member 56 is placed to the side on which the press mold body 52 and the guide member 54 are placed.

Note that, in the example illustrated in FIG. 10, the shape of the first pushing member 56 is a disk, but the shape is not specifically limited insofar as the shape is substantially plate-like. Further, the through hole 56H is provided as a hole having a circular opening along the central axis X of the press mold body 52 and the first pushing member 56, but an arbitrary number of the through holes 56H may be provided at arbitrary positions in the first pushing member 56 insofar as the positions are in a part of the region which is opposed to the pushed surface 52B of the press mold body 52. Further, the shape of the opening of the through hole 56H may be appropriately selected as well. However, it is particularly preferred that the through hole (s) 56H be provided so as to have point symmetry with respect to the central axis X of the press mold body 52.

The second pushing member 58 is formed of a rod-like member which is placed within the through hole 56H and is connected to the pushed surface 52B side of the press mold body 52. Note that, the shape of the second pushing member 58 is a circular cylindrical rod in the example illustrated in FIG. 10, but the shape is not specifically limited insofar as the second pushing member 58 may move the press mold body 52 in the X axial direction. Note that, an end of the second pushing member 58 which is opposite to an end thereof connected to the pushed surface 52B side is connected to a second drive (not shown). Therefore, in the press molding, by the second drive, only the press mold body 52 may be pushed via the second pushing member 58 along the axis direction X from the side on which the second pushing member 58 is placed to the side on which the press mold body 52 is placed.

### —Glass Material—

The glass material used in the method of manufacturing a glass blank according to the first embodiment of the present invention is not specifically limited insofar as the glass material has physical properties suitable for a magnetic recording medium glass substrate, in particular, a high thermal expansion coefficient, further, high stiffness, or heat resistance and the like, and, at the same time, the glass material may be easily press-molded into a plate shape by the horizontal direct press. It is desired that the thermal expansion coefficient be similar to the thermal expansion coefficient of a holder for holding the magnetic recording medium. More specifically, the average linear expansion coefficient at 100 to 300° C. is preferably 70×10⁻⁷/° C. or more, more preferably 75×10⁻⁷/° C. or more, still more preferably 80×10⁻⁷/° C. or more, yet still more preferably 85×10⁻⁷/° C. or more. The upper limit of the average linear expansion coefficient is not specifically limited, but, practically, is preferably 120×10⁻⁷/° C. or less. For the purpose of reducing deflection which is caused when the magnetic recording medium rotates at high speed, a glass material having high stiffness is desired. More specifically, the Young's modulus is preferably 70 GPa or more, more preferably 75 GPa or more, still more preferably 80 GPa or more, still more preferably 85 GPa or more. The upper limit of the Young's modulus is not specifically limited, but, practically, is preferably 120 GPa or less. Further, by using a glass material which is excellent in heat resistance, the substrate may be processed at a high temperature in the process of manufacturing a magnetic recording medium, and hence, the glass transition temperature of the glass material is preferably 600° C. or more, more preferably 610° C. or more, still more preferably 620° C. or more, yet still more preferably 630° C. or more. Note that, the upper limit of the glass transition temperature is not specifically limited, but, from a practical viewpoint of suppressing temperature rise in the press molding and the like, is preferably 780° C. or less. Using a glass material which has a high thermal expansion coefficient, high stiffness, and heat resistance is effective in obtaining a glass substrate suitable for a magnetic recording medium having a high recording density.

As the composition of the glass material, a composition which may easily materialize physical properties suitable for a magnetic recording medium glass substrate may be appropriately selected, and for example, a glass composition of a conventional glass material for the vertical direct press may be appropriately selected, but it is preferred that aluminosilicate glass be selected. Note that, a composition of aluminosilicate glass described below is particularly preferred, because all of heat resistance, high stiffness, and a high thermal expansion coefficient may be easily accomplished in a well-balanced way. That is, it is preferred that the glass composition of the glass (hereinafter, referred to as “Glass Composition 1”), expressed in mol %, includes

### 50 to 75% of SiO₂,

### 0 to 5% of Al₂O₃,

### 0 to 3% of Li₂O,

### 0 to 5% of ZnO,

3 to 15% in total of at least one kind of component selected from Na₂O and K₂O,
14 to 35% in total of at least one kind of component selected from MgO, CaO, SrO, and BaO, and
2 to 9% in total of at least one kind of component selected from ZrO₂, TiO₂, La₂O₃, Y₂O₃, Yb₂O₃, Ta₂O₅, Nb₂O₅, and HfO₂, and
the molar ratio {(MgO+CaO)/(MgO+CaO+SrO+BaO)} be in the range of 0.8 to 1 and the molar ratio {Al₂O₃/(MgO+CaO)} be in the range of 0 to 0.30.

A preferred range of the average linear expansion coefficient of Glass Composition 1 at 100 to 300° C. is 70×10⁻⁷/° C. or larger, a preferred range of the glass transition temperature is 630° C. or higher, and a preferred range of the Young's modulus is 80 GPa or larger. Glass Composition 1 is suitable as a material of a magnetic recording medium glass substrate of an energy-assisted method using a high Ku magnetic material.

As a glass material which has a high thermal expansion coefficient, which is excellent in acid resistance and alkali resistance, which reduces the amount of alkaline elution from a surface of the substrate, and which is suitable for chemical strengthening, one having the following glass composition (hereinafter, referred to as “Glass Composition 2”) may be presented. That is, Glass Composition 2, expressed in mol %, includes

70 to 85% in total of SiO₂ and Al₂O₃, provided that the content of SiO₂ is 50% or more and the content of Al₂O₃ is 3% or more,
10% or more in total of Li₂O, Na₂O, and K₂O,
1 to 6% in total of MgO and CaO, provided that the content of CaO is higher than the content of MgO, and
more than 0% and 4% or less in total of ZrO₂, TiO₂, La₂O₃, Y₂O₃, Yb₂O₃, Ta₂O₅, Nb₂O₅, and HfO₂.

### (Method of Manufacturing Magnetic Recording Medium Glass Substrate)

The method of manufacturing a magnetic recording medium glass substrate according to the first embodiment of the present invention is characterized in that a magnetic recording medium glass substrate is manufactured by at least going through a polishing step of polishing the main surfaces of a glass blank produced by the method of manufacturing a glass blank according to the first embodiment of the present invention. Hereinafter, specific examples of steps involved in the processing of a glass blank into a magnetic recording medium glass substrate are described in more detail.

First, scribing is performed on a glass blank obtained by carrying out the press molding. The scribing refers to providing cutting lines (line-like flaws) like two concentric circles (inner concentric circle and outer concentric circle) with a scriber made of cemented carbide or formed of diamond particles on a surface of a molded glass blank, in order to process the molded glass blank into a ring shape having a predetermined size. The glass blank having scribed thereon the two concentric circles is partially heated, and the outside portion of the outer concentric circle and the inside portion of the inner concentric circle are removed by virtue of the difference in thermal expansion of glass, thereby yielding a disk-shaped glass having a perfect circle shape. Note that, in a state of a glass blank, when the size of the outer diameter is substantially the same as the outer diameter of a final magnetic recording medium glass substrate (glass substrate for magnetic disk) (when the size may be corrected by end surface polishing described below alone), a central portion serving as a circular hole may be subjected to coring instead of the scribing step.

When scribe processing is carried out, if the roughness of the main surfaces of the glass blank is 1 μm or less, cutting lines can be suitably provided by using a scriber. Note that, in the case where the roughness of the main surfaces of the glass blank exceeds 1 μm, a scriber does not follow the irregularities of the surface and it may become difficult to provide cutting lines uniformly. In this case, after the main surfaces of the glass blank are made smooth, scribing is performed.

Next, the scribed glass undergoes shape processing. The shape processing includes chamfering (chamfering of outer peripheral end portion and inner peripheral end portion). In the chamfering, the outer peripheral end portion and inner peripheral end portion of the ring-shaped glass are chamfered with a diamond grinding stone.

Next, the disk-shaped glass undergoes end surface polishing. In the end surface polishing, the inner peripheral side end surface and outer peripheral side end surface of the glass undergo mirror finish by brush polishing. In this case, there is used a slurry including fine particles of cerium oxide or the like as free abrasive grains. The end surface polishing removes contamination caused by attachment of dust or the like and impair such as damage or flaws on or in the end surfaces of the glass. As a result, precipitation of ions of sodium, potassium, and the like causing corrosion can be prevented from occurring.

Next, first polishing is carried out on the main surfaces of the disk-shaped glass. The purpose of the first polishing is to remove flaws and strain remaining in the main surfaces. A machining allowance removed by the first polishing is, for example, several μm to about 10 μm. As a grinding step involving a large amount of a machining allowance is not required to be performed, flaws, strain, and the like, which are caused by the grinding step, are not generated in the glass. Thus, the first polishing step involves a small amount of a machining allowance.

In the first polishing step and the second polishing step described below, a double-side polishing apparatus is used. The double-side polishing apparatus is an apparatus for carrying out polishing with polishing pads by relatively moving a disk-shaped glass and the polishing pads. The double-side polishing apparatus includes a polishing carrier fitting portion having an internal gear and a sun gear which are each rotationally driven at a predetermined rotation rate and also includes an upper surface plate and a lower surface plate which are rotationally driven in opposite directions to each other with the polishing carrier fitting portion being sandwiched by both the plates. On each surface facing a disk-shaped glass of the upper surface plate and lower surface plate, the polishing pads described below are attached. Each polishing carrier fitted so as to be engaged with each of the internal gear and the sun gear performs a planetary gear motion, that is, revolves around the sun gear while spinning.

The each polishing carrier holds a plurality of disk-shaped glasses. The upper surface plate is movable in the vertical direction and presses each polishing pad onto the front and back main surfaces of each disk-shaped glass. Then, while a slurry (polishing liquid) containing polishing abrasive grains (polishing material) is being supplied, the disk-shaped glass and the polishing pad move relatively owning to the planetary gear motion of the polishing carrier and the phenomenon that the upper surface plate and the lower surface plate rotate in opposite directions to each other. As a result, the front and back main surfaces of each disk-shaped glass is polished. Note that, in the first polishing step, a hard resin polisher, for example, is used as the polishing pad and cerium oxide abrasive grains, for example, are used as the polishing material.

Next, the disk-shaped glass after the first polishing is subjected to chemical strengthening. It is possible to use a molten salt of potassium nitrate or the like as a chemical strengthening solution. In the chemical strengthening, the chemical strengthening solution is heated to, for example, 300° C. to 400° C., and a cleaned glass is pre-heated to, for example, 200° C. to 300° C. and then immersed in the chemical strengthening solution for, for example, 3 hours to 4 hours. The immersion is preferably performed under a state in which a plurality of glasses are contained in a holder so as to be held by their end surfaces so that both main surfaces of each of the glasses entirely undergo chemical strengthening.

Each glass is immersed in the chemical strengthening solution, as described above, and as a result, sodium ions in the surface layers of the glass are substituted by potassium ions each having a relatively large ion radius in the chemical strengthening solution, respectively, forming a compressive stress layer with a thickness of about 50 to 200 μm. Thus, the glass is strengthened and is provided with good impact resistance. Note that, the glass having undergone chemical strengthening treatment is cleaned. For example, the glass is cleaned with sulfuric acid and then cleaned with pure water, isopropyl alcohol (IPA), or the like.

Next, the glass which has undergone chemical strengthening and has been cleaned sufficiently is subjected to second polishing. A machining allowance removed by the second polishing is, for example, about 1 μm.

The purpose of the second polishing is to finish the main surfaces like mirror surfaces. In the second polishing step, the disk-shaped glass is polished by using a double-side polishing apparatus as in the first polishing step, but the composition of polishing abrasive grains contained in a polishing liquid (slurry) to be used and the composition of a polishing pad are different from those in the first one. In the second polishing step, there are used polishing abrasive grains each having a smaller diameter and a softer polishing pad compared with those in the first polishing step. For example, in the second polishing step, a soft foamed resin polisher, for example, is used as the polishing pad, and finer cerium oxide abrasive grains or colloidal silica than the cerium oxide abrasive grains used in the first polishing step are, for example, used as the polishing material.

The disk-shaped glass polished in the second polishing step is again cleaned. In the cleaning, a neutral detergent, pure water, or IPA is used. The second polishing yields a glass substrate for a magnetic disk having a main surface flatness of 4 μm or less and a main surface roughness (Ra) of 0.2 nm or less, for example. After that, various layers such as a magnetic layer are formed on the glass substrate for a magnetic disk, and a magnetic disk is produced.

Note that, the chemical strengthening step is carried out between the first polishing step and the second polishing step, and the order of these steps is not limited to this order. As long as the second polishing step is carried out after the first polishing step, the chemical strengthening step can be arbitrarily arranged. For example, the order of the first polishing step, the second polishing step, and the chemical strengthening step (hereinafter, referred to as “Routing 1” may also be adopted. Note that, if Routing 1 is adopted, surface irregularities that may be produced by the chemical strengthening step are not removed, and hence more preferred is the routing of the first polishing step, the chemical strengthening step, and the second polishing step.

Note that, in manufacturing a magnetic recording medium glass substrate, the flatness of the glass blank used in the processing and the flatness of the produced magnetic recording medium glass substrate may be caused to be substantially the same. As a flatness required of a magnetic recording medium glass substrate, for example, in recent years, a flatness which is 10 μm or less has been required with regard to a 2.5-inch glass substrate. Such flatness may be easily accomplished by a glass blank produced by the method of manufacturing a glass blank according to the first embodiment of the present invention. The “flatness of the glass blank used in the processing and the flatness of the produced magnetic recording medium glass substrate are substantially the same” as used herein means that the flatness of the glass blank is 105% or less with the required flatness of the magnetic recording medium glass substrate (magnetic disk glass substrate) being 100%.

Note that, when the flatness of the glass blank used in the processing and the flatness of the produced magnetic recording medium glass substrate are caused to be substantially the same, a step such as a lapping step which is carried out with one of the main purposes thereof being to improve the flatness may be eliminated.

### (Method of Manufacturing Magnetic Recording Medium)

A method of manufacturing a magnetic recording medium according to the first embodiment of the present invention is characterized in that a magnetic recording medium is manufactured by at least going through a magnetic recording layer-forming step of forming a magnetic recording layer on a magnetic recording medium glass substrate produced by the method of manufacturing a magnetic recording medium glass substrate according to the first embodiment of the present invention.

A magnetic recording medium is also called, for example, a magnetic disk or a hard disk, and is suitable for internal storages (such as fixed disks) for desk top computers, server computers, notebook computers, mobile computers, and the like, internal storages for portable recording and reproducing devices used for recording and reproducing images and/or sounds, recording and reproducing devices for in-car audio systems, and the like.

The magnetic recording medium may have, for example, a configuration in which at least an adherent layer, an undercoat layer, a magnetic layer (magnetic recording layer), a protective layer, and a lubricant layer are laminated on the main surface of a magnetic recording medium glass substrate sequentially, starting from the layer close the main surface of the magnetic recording medium glass substrate. For example, a magnetic recording medium glass substrate is introduced into a film-forming apparatus in which pressure is reduced, and each layer from the adherent layer to the magnetic layer is sequentially formed on the main surface of the magnetic recording medium glass substrate in an Ar atmosphere by using a DC magnetron sputtering method. There can be used, for example, CrTi as the adherent layer, and, for example, CrRu as the undercoat layer. After the above-mentioned film formation, the protective layer is formed with C₂H₄ gas by using, for example, a CVD method, and then, nitriding treatment including introducing nitrogen into the surface is carried out in the same chamber, thereby being able to form the magnetic recording medium. After that, for example, polyfluoropolyether (PFPE) is applied on the protective layer by a dip coating method, thereby being able to form the lubricant layer.

The size of the magnetic recording medium is not specifically limited. However, the magnetic recording medium glass substrate is formed of a glass material which is excellent in impact resistance, and hence, it is suitable that the size is 2.5 inch or less which is conveniently portable and highly likely to be exposed to impact from the outside.

### Second Embodiment

### (Method of Manufacturing Glass Blank for Magnetic Recording Medium Glass Substrate and Manufacturing Apparatus Using the Same)

In a method of manufacturing a glass blank for a magnetic recording medium glass substrate (hereinafter, sometimes abbreviated as “method of manufacturing a glass blank”) according to a second embodiment, there is manufactured a glass blank for a magnetic recording medium glass substrate (hereinafter, sometimes abbreviated as “glass blank”) at least through a press-molding step of press-molding a falling molten glass gob with a first press mold and a second press mold placed so as to be opposed to each other in a direction crossing a direction in which the molten glass gob falls.

Here, at least the first press mold at least includes a press mold body having a press-molding surface, and a guide member having at least the function of maintaining a substantially fixed distance between the press-molding surfaces of the first press mold and the second press mold in the press molding, by, when pushed to the side of a press mold which is placed so as to be opposed to the press-molding surface, being brought into contact with a part of the press mold which is placed so as to be opposed to the press-molding surface.

Further, the press-molding step includes a first step of forming a molten glass gob into plate glass by bringing the first press mold and the second press mold closer together until the guide member of the first press mold and the second press mold are in contact with each other, and a second step of continuing to press, with the press mold body of the first press mold and the second press mold, plate glass with the guide member of the first press mold and the second press mold being in contact with each other.

Here, in the first step of the press-molding step, the first press mold and the second press mold are brought closer together. Therefore, the molten glass gob is press-molded with the first press mold and the second press mold into plate glass. Further, by bringing the first press mold and the second press mold closer together, the guide member of the first press mold and the second press mold are brought into contact with each other. Therefore, at this point in time, the substantially fixed distance is maintained between the press-molding surfaces of the first press mold and the second press mold. Therefore, the thickness deviation of the plate glass sandwiched between the press-molding surfaces may be significantly reduced. Thus, as a result, the thickness deviation of the obtained glass blank may also be significantly reduced.

However, in the state immediately after the first step is completed, the plate glass is at a high temperature and has high fluidity. Therefore, the plate glass is in an easily deformable state. Therefore, if the first press mold and the second press mold are moved away from each other and the plate glass is taken out immediately after the first step is completed, both the surfaces of the plate glass are supported by no member, and thus, the plate glass is easily deformed, which deteriorates the flatness of the produced glass blank. In consequence, it is thought to be preferred that the state in which the guide member of the first press mold and the second press mold are in contact with each other be maintained for a certain while even after the first step is completed to support both the surfaces of the plate glass by the press-molding surfaces, because it is thought that, while deformation of the plate glass may be prevented by supporting both the surfaces of the plate glass by the press-molding surfaces, deterioration of the flatness of the glass blank may be suppressed by taking out the plate glass after the plate glass is cooled to cause the fluidity thereof to be lowered or lost.

However, the plate glass in contact with the press-molding surfaces shrinks in the process of losing heat to the press molds to be cooled. Therefore, if the distance between the press-molding surfaces immediately after the first step is completed continues to be maintained after that, a gap is formed between the press-molding surfaces and the plate glass. Therefore, taking the shrinkage of the plate glass also into consideration, it is difficult that the press-molding surfaces always continue to support both the surfaces of the plate glass. In consequence, even if the state in which the guide member of the first press mold and the second press mold are in contact with each other is maintained for a further while after the first step is completed, it is difficult to suppress the deformation of the plate glass.

However, in the second step, the plate glass continues to be pressed by the press mold body of the first press mold and by the second press mold with the guide member of the first press mold and the second press mold being in contact with each other. More specifically, the plate glass continues to be pressed with only the press mold body of the first press mold being brought closer to the press-molding surface of the second press mold. Therefore, even if the plate glass shrinks in the thickness direction thereof, the press-molding surfaces continue to be in intimate contact with both the surfaces of the plate glass, respectively, without a gap, and support both the surfaces of the plate glass. Therefore, as described above, by cooling the plate glass with both the surfaces of the plate glass being always supported by the press-molding surfaces and taking out the plate glass after the fluidity thereof is lowered or lost, deterioration of the flatness of the glass blank may be suppressed with more reliability.

Further, in the second step, the press-molding surfaces of the press molds formed of solid members having the heat conductivity higher than that of gas such as air which exists in the gap, and the plate glass continue to be in intimate contact with each other without a gap, and thus, heat of the plate glass is efficiently lost to the press molds. Therefore, lowering of the fluidity of the plate glass in the press molding is more promoted compared with a case in which a gap is formed between the press-molding surfaces and the plate glass. Therefore, at a point in time at which the plate glass and the press-molding surfaces are moved away from each other (at a point in time at which the second step is completed), the fluidity of the plate glass is further lowered and the plate glass is in a state in which deformation thereof is less liable to occur or impossible to occur. Therefore, also from this viewpoint, deformation of the plate glass after the press molding is less liable to occur, and the flatness of the glass blank may be reduced.

Note that, in the method of manufacturing a glass blank according to the second embodiment, only the first press mold may at least include the press mold body and the guide member. In this case, as the second press mold, for example, a press mold that is a cylinder having one end surface forming a press-molding surface may be used. In this case, in the first step, the guide member of the first press mold is brought into contact with the press-molding surface of the second press mold. Then, in the second step, the plate glass continues to be pressed by the press mold body of the first press mold and by the second press mold with the guide member of the first press mold and the press-molding surface of the second press mold being in contact with each other (such a press-molding process is hereinafter sometimes referred to as “first pressing process”).

Further, in the method of manufacturing a glass blank according to the second embodiment, each of the first press mold and the second press mold may at least include a press mold body having a press-molding surface, and a guide member having at least the function of maintaining a substantially fixed distance between the press-molding surfaces of the first press mold and the second press mold in the press molding, by, when pushed to the side of a press mold which is placed so as to be opposed to the press-molding surface, being brought into contact with a part of the press mold which is placed so as to be opposed to the press-molding surface. In this case, the first step is carried out by bringing the first press mold and the second press mold closer together until the guide member of the first press mold and the guide member of the second press mold are brought into contact with each other. Then, the second step is carried out by continuing to press, with the press mold body of the first press mold and the press mold body of the second press mold, the plate glass with the guide member of the first press mold and the guide member of the second press mold being in contact with each other (such a press-molding process is hereinafter sometimes referred to as “second pressing process”).

Note that, in carrying out the second step, with regard to the press molds each of which at least includes the press mold body and the guide member that are used both in the first pressing process and in the second pressing process, the press mold body and the guide member particularly preferably have the function of separately moving toward the other press mold which is placed so as to be opposed to the press mold.

The method of manufacturing a glass blank according to the second embodiment may be carried out through any one of the first pressing process and the second pressing process. However, for the purpose of obtaining a glass blank having a similar extent of thickness deviation and flatness, from the viewpoint of shortening time necessary for the press molding, for example, to on the order of ⅓ of the first pressing process, it is particularly preferred that the method of manufacturing a glass blank according to the second embodiment be carried out through the second pressing process. The reason for this is that the structures of the pair of press molds used become more similar to each other or the same in the second pressing process compared with the case of the first pressing process, and thus, cooling of the plate glass located between the pair of molds may be carried out more symmetrically from both the surfaces.

The method of manufacturing a glass blank according to the second embodiment described above is not specifically limited insofar as at least the press-molding step is included therein, but, usually, it is preferred that a molten glass gob forming step be included therein. Further, after the press-molding step, a taking out step of moving the first press mold and the second press mold away from each other and taking out the plate glass is carried out. The respective steps including the molten glass gob forming step and the taking out step are described in more detail in the following. Note that, in the following description, description of points already described above is omitted.

### —Molten Glass Gob Forming Step—

In the molten glass gob forming step, a molten glass gob with regard to which press molding is carried out is produced. The method of producing the molten glass gob is not specifically limited, but, usually, the molten glass gob is formed by causing molten glass to fall from a glass outlet and cutting a forward end portion of a molten glass flow continuously flowing out downward in the vertical direction. Note that, in the cutting of the forward end portion of the molten glass flow, a pair of shear blades may be used. Further, the viscosity of the molten glass is not specifically limited insofar as the viscosity is appropriate for the cutting of the forward end portion and for the press molding, but, usually, it is preferred that the viscosity be controlled to have a predetermined value in a range of 500 dPa·s to 1,050 dPa·s. Note that, the viscosity of the molten glass gob immediately before the press molding is also preferably in the above-mentioned range.

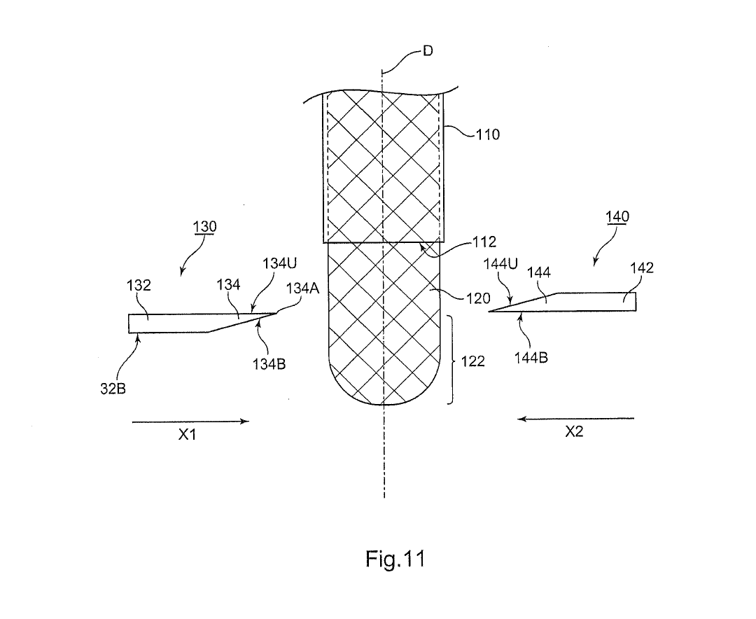

Next, a specific example of the molten glass gob forming step is described in more detail with reference to the drawings. In the molten glass gob forming step, as illustrated in FIG. 11, a molten glass flow 120 is first caused to flow out continuously downward in the vertical direction from a glass outlet 112 provided at the lower end portion of a glass effluent pipe 110 whose upper end portion is connected to a molten glass supply source (not shown). On the other hand, at a portion lower than the glass outlet 112, a first shear blade (lower side blade) 130 and a second shear blade (upper side blade) 140 are arranged at both sides of the molten glass flow 120, respectively, in the direction substantially perpendicular to a central axis D, which is the falling direction of the molten glass flow 120. The lower side blade 130 and the upper side blade 140 move in a direction of the arrow X1 which is perpendicular to the central axis D and which is from the left side to the right side in the figure, and in a direction of the arrow X2 which is perpendicular to the central axis D and which is from the right side to the left side in the figure, respectively, thereby approaching a forward end portion 122 side of the molten glass flow 120 from both sides of the molten glass flow 120. Note that, the viscosity of the molten glass flow 120 is controlled by adjusting the temperatures of the molten glass effluent pipe 110 and the molten glass supply source which is upstream thereof.

Further, the lower side blade 130 and the upper side blade 140 have substantially plate-like body portions 132 and 142 and blade portions 134 and 144, respectively. The blade portions 134 and 144 are provided on end portion sides of the body portions 132 and 142, respectively, and cut the forward end portion 122 of the molten glass flow 120 continuously flowing out downward in the vertical direction from a direction substantially perpendicular to the direction in which the molten glass flow 120 falls down. Note that, an upper surface 134U of the blade portion 134 and a lower surface 144B of the blade portion 144 each have a surface substantially coincident with a horizontal plane, and a lower surface 134B of the blade portion 134 and an upper surface 144U of the blade portion 144 each have a surface that is slanted so as to cross the horizontal plane. Further, the lower side blade 130 and the upper side blade 140 are placed so that the upper surface 134U of the blade portion 134 and the lower surface 144B of the blade portion 144 are substantially flush with each other with respect to the vertical direction.

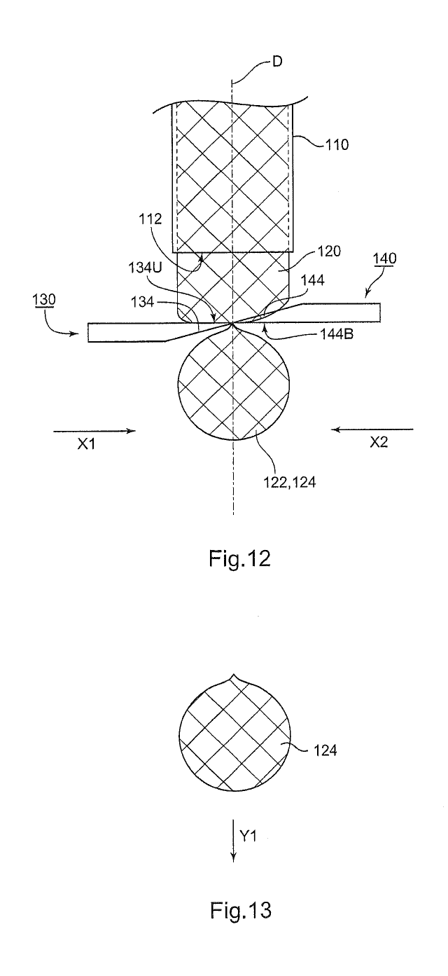

Next, as illustrated in FIG. 12, the lower side blade 130 and the upper side blade 140 are each moved in the horizontal direction so that the upper surface 134U of the blade portion 134 and the lower surface 144B of the blade portion 144 are partially overlapped substantially without any gap by further moving the lower side blade 130 and the upper side blade 140 toward the direction of the arrow X1 and the direction of the arrow X2, respectively. That is, the lower side blade 130 and the upper side blade 140 are caused to perpendicularly cross the central axis D. As a result, the lower side blade 130 and the upper side blade 140 penetrate into the molten glass flow 120 to the vicinity of the central axis D thereof, and the forward end portion 122 is cut as a molten glass gob 124 having a substantially spherical shape. Note that, FIG. 12 illustrates the moment when the forward end portion 122 is separated from the body portion of the molten glass flow 120 as the molten glass gob 124. Further, as illustrated in FIG. 13, the molten glass gob 124 cut from the molten glass flow 120 further falls to a downward Y1 side in the vertical direction.

### —Press Forming Step (First Step)—

In the first step, the falling molten glass gob 124 illustrated in FIG. 13 is pressed with the first press mold and the second press mold which are placed so as to be opposed to each other in a direction crossing the falling direction of the molten glass gob 124, and is formed into a plate shape. Here, it is preferred that the first press mold and the second press mold be placed so as to be opposed to each other in a direction substantially perpendicular to the falling direction of the molten glass gob 124 so as to form an angle in a range of 90 degrees±1 degree, and it is particularly preferred that the first press mold and the second press mold be placed so as to be opposed to each other in a direction perpendicular to the falling direction of the molten glass gob 124. By placing the pair of press molds so as to be opposed to each other with respect to the falling direction of the molten glass gob 124 in this way, it is further facilitated to press the molten glass gob 124 evenly from both sides into a plate shape.

Further, the temperatures of the press-molding surfaces of the first press mold and the second press mold immediately before the first step is carried out is preferably equal to or lower than a temperature which is 10° C. higher than the strain point of the glass material forming the molten glass gob 124, more preferably equal to or lower than a temperature which is 5° C. higher than the strain point of the glass material forming the molten glass gob 124. By setting the temperatures of the press-molding surfaces in the above-mentioned range, fusion between the molten glass gob 124 and the press-molding surfaces in the press molding may be suppressed with reliability. The lower limit of the temperatures of the press-molding surfaces of the first press mold and the second press mold immediately before the first step is carried out is not specifically limited, but, from a practical viewpoint, that is, in order to prevent a crack in the glass blank due to rapid cooling of the molten glass gob 124, in order to prevent significant reduction of the stretchability of the molten glass gob 124 due to rapid increase of the viscosity in the press molding, and the like, it is preferred that the lower limit be equal to or higher than the strain point of the glass material forming the molten glass gob 124.

Further, the absolute value of the difference between the temperature of the press-molding surface of the first press mold and the temperature of the press-molding surface of the second press mold immediately before the first step is carried out is preferably in a range of 0° C. to 10° C., more preferably in a range of 0° C. to 5° C., and particularly preferably 0° C. In this case, the temperature difference caused between both the surfaces of the plate glass which is formed into a plate shape by pressing the molten glass gob 124 may be suppressed with more reliability, and as a result, the flatness may be further improved.

Further, the absolute values of the temperature differences within the press-molding surfaces of the first press mold and the second press mold immediately before the first step is carried out is preferably in a range of 0° C. to 100° C., preferably in a range of 0° C. to 50° C., particularly preferably 0° C. By setting the temperature distribution within the press-molding surfaces in the above-mentioned range, it becomes further easier to stretch evenly and thinly the molten glass gob 124 in the press molding. As a result, even when a glass blank having a smaller thickness is manufactured, a glass blank which is excellent in flatness and has smaller thickness deviation may be more easily obtained. Note that, “temperature within a press-molding surface” means temperature measured in a largest region in which the press-molding surface and the molten glass gob 124 stretched into a plate shape are in contact with each other in the press molding.

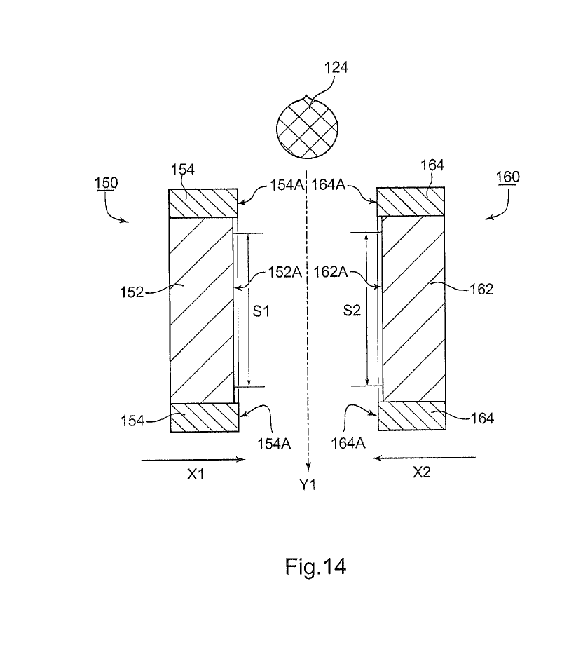

Next, the first step is described more specifically with reference to the drawings. First, the molten glass gob 124 illustrated in FIG. 13 comes between a first press mold 150 and a second press mold 160 which are placed so as to be opposed to each other in a direction perpendicular to the falling direction Y1 of the molten glass gob 124 as illustrated in FIG. 14. Here, the first press mold 150 and the second press mold 160 before the press molding is carried out are placed at an interval so as to be opposed to each other in a direction having line symmetry with respect to and perpendicular to the falling direction Y1. Then, in synchronization with the timing when the molten glass gob 124 reaches the vicinity of the central portions in the vertical direction of the first press mold 150 and the second press mold 160, the first press mold 150 moves in the direction of the arrow X1 which is perpendicular to the falling direction Y1 and which is from the left side to the right side in the figure and the second press mold 160 moves in the direction of the arrow X2 which is perpendicular to the falling direction Y1 and which is from the right side to the left side in the figure in order to press-mold the molten glass gob 124 by pressing from both sides. Note that, the moving rate of the first press mold 150 in the direction of the arrow X1 and the moving rate of the second press mold 160 in the direction of the arrow X2 are set to be the same or substantially the same.

Here, the press molds 150 and 160 include press mold bodies 152 and 162 each having a disk-like shape, respectively, and guide members 154 and 164 arranged so as to surround the outer peripheral ends of each of the press mold bodies 152 and 162, respectively. Note that, because FIG. 14 is a cross-sectional view, the guide members 154 and 164 are drawn as being positioned on both upper and lower sides of the press mold bodies 152 and 162, respectively, in FIG. 14. Further, drive members for moving the press mold 150 in the direction of the arrow X1 and for moving the press mold 160 in the direction of the arrow X2 are omitted in the figures.

One surface of each of the press mold bodies 152 and 162 serves as a press-molding surface 152A or 162A. Further, in FIG. 14, the first press mold 150 and the second press mold 160 are arranged so that the two press-molding surfaces 152A and 162A face each other. Further, the guide member 154 is provided with a guide surface 154A, which is positioned so as to project slightly with respect to the press-molding surface 152A in the X1 direction, and the guide member 164 is provided with a guide surface 164A, which is positioned so as to project slightly with respect to the press-molding surface 162A in the X2 direction. Then, the guide surface 154A and the guide surface 164A come into contact with each other at the time of press molding, and hence a gap is formed between the press-molding surface 152A and the press-molding surface 162A. Thus, the thickness of the gap corresponds to the thickness of the molten glass gob 124 molded so as to have a plate shape by being press-molded between the first press mold 150 and the second press mold 160, that is, the thickness of a glass blank. Further, the press-molding surfaces 152A and 162A are formed so that, when the first step is carried out so that the molten glass gob 124 is completely extended by pressure in the vertical direction and is molded into a plate glass between the press-molding surface 152A of the first press mold 150 and the press-molding surface 162A of the second press mold 160, at least regions (molten glass stretching regions) S1 and S2 in contact with the above-mentioned plate glass in the press-molding surfaces 152A and 162A form a substantially flat surface. Note that, in the example illustrated in FIG. 14, the whole part of the press-molding surface 152A including the molten glass stretching region S1 and the whole part of the press-molding surface 162A including the molten glass stretching region S2 each are a usual flat surface whose curvature is substantially zero. Further, the flat surface has only minute irregularities which are formed when usual flattening processing, usual mirror polishing processing, or the like is applied at the time of manufacturing press molds, but does not have convex portions and/or concave portions larger than the minute irregularities.

The glass blank is manufactured by press molding the molten glass gob 124 by pressure between the press-molding surfaces 152A and 162A. Thus, the surface roughness of the press-molding surfaces 152A and 162A and the surface roughness of the main surface of the glass blank become substantially the same. The surface roughness (central line average roughness Ra) of the main surface of the glass blank is desirably controlled to the range of 0.01 to 10 μm in view of performing scribe processing and grinding processing using a diamond sheet that are carried out as the post processes to be described below, and hence the surface roughness (central line average roughness Ra) of the press-molding surfaces is also preferably controlled to the range of 0.01 to 10 μm.

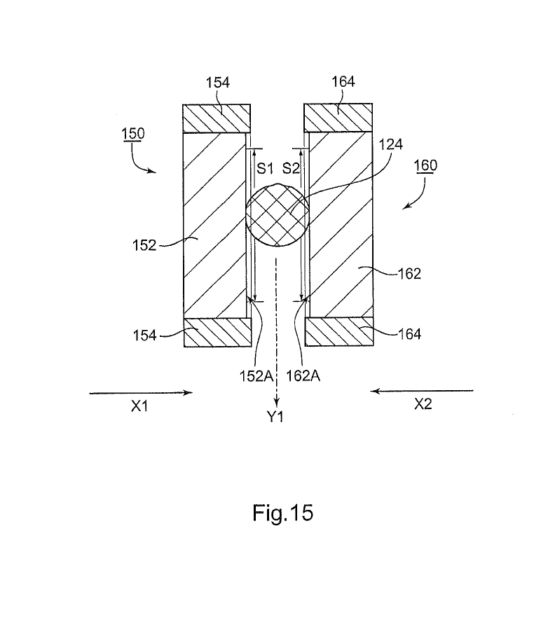

The molten glass gob 124 illustrated in FIG. 14 falls further downward and enters the space between the two press-molding surfaces 152A and 162A. Then, as illustrated in FIG. 15, at the time when the molten glass gob 124 reaches the vicinity of the almost central portion in the vertical direction of the press-molding surfaces 152A and 162A parallel to the falling direction Y1, both side surfaces of the molten glass gob 124 are brought into contact with the press-molding surfaces 152A and 162A. Here, it is preferred that, as illustrated in FIG. 15, the press-molding surface 152A and the press-molding surface 162A be brought into contact with the molten glass gob 124 substantially at the same time. “Be brought into contact substantially at the same time” as used herein means that the absolute value of the temporal difference between a point in time at which the molten glass gob and one of the press-molding surfaces are brought into contact with each other and a point in time at which the molten glass gob and the other of the press-molding surfaces are brought into contact with each other is 0.1 second or less. The absolute value of the temporal difference is more preferably 0.05 second or less, most preferably 0 seconds (at the same time). Note that, for the sake of reference, in the vertical direct press, time taken for the molten glass gob to, after being brought into contact with the press-molding surface of the lower mold, be brought into contact with the press-molding surface of the upper mold is generally on the order of 1.5 seconds to 3 seconds, depending on the conditions of the press molding.

Further, it is preferred that, as illustrated in FIG. 15, the press-molding surface 152A and the press-molding surface 162A be brought into contact with the molten glass gob 124 substantially at the same time, and, at least during the period in which the press-molding step is carried out, the temperature of the press-molding surface 152A of the first press mold 150 and the temperature of the press-molding surface 162A of the second press mold 160 be substantially the same. With this, both the surfaces of the molten glass gob 124 which is being formed into a plate shape in the first step and both the surfaces of the plate glass sandwiched between the pair of press molds 150 and 160 in the second step are continued to be cooled always symmetrically. In this case, compared with a case of the vertical direct press in which a molten glass gob in a state of having a viscosity distribution due to long-term contact with a lower mold is press-molded, almost no temperature difference is caused between both the surfaces of the plate glass after being press-molded, and thus, deterioration of the flatness due to temperature difference between both the surfaces may be suppressed with more reliability.

“Substantially the same” as used herein means that the absolute value of the difference between the temperature of the press-molding surface 152A of the first press mold 150 and the temperature of the press-molding surface 162A of the second press mold 160 is 10° C. or less. The absolute value of the temperature difference is more preferably 5° C. or less, most preferably 0° C. Note that, when a temperature distribution exists within the press-molding surface 152A or 162A, the “temperature of the press-molding surface” means the temperature of the vicinity of a central portion of the press-molding surface. Note that, for the sake of reference, in the vertical direct press, the absolute value of the difference between the temperature of a press-molding surface of an upper mold and the temperature of a press-molding surface of a lower mold when a molten glass gob is being press-molded is generally on the order of 50° C. to 100° C., depending on the conditions of the press molding.

Here, in additional consideration of the viewpoint of preventing the situation that press molding becomes difficult to carry out because of the increase of the viscosity of a falling molten glass gob 124 or the situation that the position of press fluctuates because of an excessively high falling speed, the falling distance is preferably selected from the range of 1,000 mm or less, more preferably selected from the range of 500 mm or less, still more preferably selected from the range of 300 mm or less, most preferably selected from the range of 200 mm or less. Note that, the lower limit of the falling distance is not particularly limited, but is preferably 100 mm or more for practical use. Note that, the term “falling distance” means a distance from the position at the moment when the forward end portion 122 is separated as the molten glass gob 124 as illustrated in FIG. 12, that is, the position at which the lower side blade 130 and the upper side blade 140 are overlapped in the vertical direction, to the position at the time of the start of the press molding (the moment of the start of the press molding) as illustrated in FIG. 15, that is, the vicinity of the almost central portion in the diameter direction of the press-molding surfaces 152A and 162A parallel to the falling direction Y1.

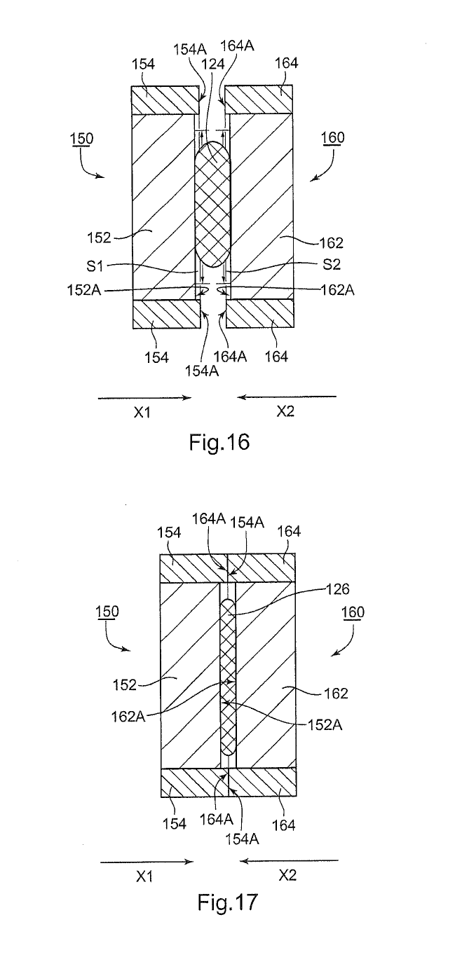

After that, as illustrated in FIG. 16, when the molten glass gob 124 is continuously pressed from its both sides with the first press mold 150 and the second press mold 160, the molten glass gob 124 is extended by pressure so as to have a uniform thickness around the position at which the molten glass gob 124 and each of the press-molding surfaces 152A and 162A first come into contact. Then, as illustrated in FIG. 17, the molten glass gob 124 is continuously pressed with the first press mold 150 and the second press mold 160 until the guide surface 154A and the guide surface 164A come into contact, thereby being formed into a disk-shaped or disk-like plate glass 126 between the press-molding surfaces 152A and 162A.

Here, the plate glass 126 illustrated in FIG. 17 has substantially the same shape and thickness as the glass blank to be finally obtained. Further, the size and shape of both surfaces of the plate glass 126 are the same size and shape of the molten glass stretching regions S1 and S2 (not shown in FIG. 17). Further, the time taken from the state at the time of the start of the press molding illustrated in FIG. 15 until a state in which the guide surface 154A and the guide surface 164A come into contact with each other as illustrated in FIG. 17 (hereinafter, sometimes referred to as “press molding time”) is preferably 0.1 second or less from the viewpoint of forming the molten glass gob 124 into a plate glass. Moreover, because a state in which the guide surface 154A and the guide surface 164A come into contact with each other is established at the time of the press molding, it becomes easy to maintain the parallel state between the press-molding surface 152A and the press-molding surface 162A. Note that, the lower limit of the press molding time is not particularly limited, however, it is preferably 0.05 second or more for practical use.

Note that, as illustrated in FIG. 14 to FIG. 17, the press mold 150 has the press mold body 152 and the guide member 154, and the press mold 160 has a similar structure. Here, in the first step, the press mold body 152 and the guide member 154 move in the direction of the arrow X1 at the same time and integrally, and the press mold body 162 and the guide member 164 move in the direction of the arrow X2 at the same time and integrally.

Further, the press molds 150 and 160 have the guide members 154 and 164, respectively, and thus, when the guide member 154 and the guide member 164 are in contact with each other as illustrated in FIG. 17, the press-molding surface 152A and the press-molding surface 162A are held in parallel with each other. Therefore, even if a state in which the press-molding surface 152A and the press-molding surface 162A are in parallel with each other cannot be held in the process in which the press mold 150 moves in the direction of the arrow X1 and the press mold 160 moves in the direction of the arrow X2 as illustrated in FIG. 14 to FIG. 16, it is easy to significantly reduce a thickness deviation in the obtained glass blank. In consequence, a drive for driving the press molds 150 and 160 is not required to have sophisticated controlling ability to control the press-molding surface 152A and the press-molding surface 162A to be always held in a precisely parallel state in a series of process illustrated in FIG. 14 to FIG. 17.

### —Press-Molding Step (Second Step)—

In the second step, as illustrated in FIG. 17, the press mold body 152 of the first press mold 150 is driven so as to move in the direction of the arrow X1 and the press mold body 162 of the second press mold 160 is driven so as to move in the direction of the arrow X2 under the state in which the guide member 154 of the first press mold 150 and the guide member 164 of the second press mold 160 are brought into contact with each other. This causes the plate glass 126 to continue to be pressed by the press mold bodies 152 and 162.

Note that, the plate glass 126 immediately after the first step is completed is at a high temperature and has high fluidity (low viscosity). More specifically, the plate glass is in a quite easily deformable state and in a state in which the flatness thereof is liable to be deteriorated. Therefore, if the second step is completed when the cooling of the plate glass 126 does not progress much with the high fluidity state being held, the plate glass 126 may be deformed after the second step is completed to deteriorate the flatness of the glass blank. In consequence, it is preferred that the second step be continued until the temperature of the plate glass 126 is at least equal to or lower than a temperature which is 10° C. higher than the strain point of the glass material forming the plate glass 126. More specifically, it is preferred that the plate glass 126 continue to be pressed by the press mold body 152 and the press mold body 162 until the temperature of the plate glass 126 is equal to or lower than the temperature which is 10° C. higher than the strain point of the glass material forming the plate glass 126 while holding the state immediately after the first step is completed illustrated in FIG. 17. In this case, the plate glass 126 continues to be pressed until the cooling of the plate glass 126 sufficiently progresses and the temperature reaches a range in which the fluidity thereof is lost and deformation thereof becomes impossible in effect. More specifically, the plate glass 126 may be solidified while holding a state in which the deformation of the plate glass 126 immediately after the first step is completed is suppressed. In consequence, the flatness of the produced glass blank may be improved.

Here, the duration time of the second step is preferably controlled so that the flatness of the glass blank is 10 μm or less, more preferably controlled so that the flatness of the glass blank is 4 μm or less. Note that, if the duration time of the second step is short, strain due to disturbance is caused in the plate glass 126 in the process of being cooled, and the strain facilitates deterioration of the flatness of the glass blank. Therefore, it is preferred that the glass blank be manufactured in a manner that the duration time of the second step is changed and the flatness of the obtained glass blank is measured, and based on the result, the duration time of the second step is set so that the flatness is 10 μm or less. However, if the duration time of the second step is too long, the productivity is reduced. It follows that the duration time of the second step should be set taking into consideration the flatness of the glass blank and the productivity. From these viewpoints, specifically, it is preferred that the duration time of the second step be in a range of 2 to 40 seconds, and be in a range of 2 to 30 seconds.

Further, in order to control the flatness of the glass blank to be 10 μm or less, in the second step, it is particularly preferred that the duration time of the second step be selected so that the plate glass continues to be pressed until the temperature reaches a range in which the fluidity of the plate glass is lost and deformation thereof becomes impossible in effect. In this case, the plate glass 126 may be solidified while holding a state in which the deformation of the plate glass 126 immediately after the first step is completed is suppressed. In consequence, the flatness of the produced glass blank may be improved. Here, the duration time of the second step is preferably selected so that the temperature of the plate glass when the second step is completed is equal to or lower than a temperature which is 10° C. higher than the strain point of the glass material forming the plate glass, more preferably selected so that the temperature is equal to or lower than a temperature which is 5° C. higher than the strain point, still more preferably selected so that the temperature is equal to or lower than the strain point. On the other hand, the lower limit of the temperature of the plate glass when the second step is completed is not specifically limited, but, from the viewpoint of suppressing reduction of the productivity due to prolonged time necessary for carrying out the second step, practically, it is preferred that the lower limit be equal to or higher than the strain point. Therefore, it is preferred that the upper limit of the duration time of the second step be selected from this viewpoint.

Note that, during a period from immediately after the start of the first step at which the press-molding surfaces 152A and 162A and the molten glass gob 124 are brought into contact with each other to a point in time when the second step is completed, the temperature of the glass located between the press-molding surface 152A and the press-molding surface 162A (the molten glass gob 124 and the plate glass 126) is generally significantly lowered from on the order of 1,200±50° C. to on the order of 480° C.±20° C., depending on the glass material used in the press molding. In consequence, in the second step, as the temperature is significantly lowered in this way, heat shrinkage of the plate glass 126 in the diameter direction progresses. The heat shrinkage becomes more conspicuous when the second step continues until the temperature of the plate glass 126 reaches a lower temperature range, in particular, a temperature range which is equal to or lower than a temperature that is 10° C. higher than the strain point of the glass material forming the plate glass 126. On the other hand, in the second step, the press-molding surfaces 152A and 162A which are in contact with both the surfaces of the plate glass 126 are thought to continue to absorb heat of the plate glass 126 to thermally expand in an in-plane direction or, by completing absorption of enough heat from the plate glass 126, stop thermal expansion in the in-plane direction or turn to mild heat shrinkage.

More specifically, in the second step, a difference occurs between the extent of the thermal expansion/heat shrinkage of both the surfaces of the plate glass 126 and that of the press-molding surfaces 152A and 162A. Therefore, in the second step, force to extend in the diameter direction of the plate glass 126, that is, force in the direction opposite to the heat shrinkage acts on both the surfaces of the plate glass 126 which is undergoing the heat shrinkage by the press-molding surfaces 152A and 162A. However, in the second step, the fluidity of the plate glass 126 is significantly lowered as the second step progresses, and thus, if excessive stress acts on the plate glass 126, brittle fracture in the plate glass 126 is liable to occur. Therefore, if the force in the direction opposite to the heat shrinkage always continues to act on both the surfaces of the plate glass 126, excessive stress acts on the plate glass 126 in the in-plane direction, which may result in a crack in the plate glass 126.

In order to prevent such a crack in the plate glass 126, (1) to use as a material forming the press molds 150 and 160 a material having the thermal expansion coefficient similar to that of the glass material forming the plate glass 126, and in addition, (2) in the second step, to carry out cooling with the temperature of the plate glass 126 and the temperatures of the press-molding surfaces 152A and 162A being synchronized with each other are thought of. However, the second step involves the significant temperature change, and thus, in order to carry out the above-mentioned cooling, it is necessary to cause the cooling speed to be very low. However, in this case, time necessary for carrying out the second step significantly increases, and thus, there is a possibility that the mass productivity is lowered significantly, which is not practical.

Taking into consideration the points described above, in order to prevent a crack in the plate glass 26 in the second step with more reliability, it is preferred that, in the second step, a press pressure be reduced with time. In this case, reduction of the press pressure reduces friction coefficients between both the surfaces of the plate glass 126 and the press-molding surfaces 152A and 162A, respectively. As a result, slippage occurs between both the surfaces of the plate glass 126 and the press-molding surfaces 152A and 162A, respectively, which facilitates interruption of force which acts on both the surfaces of the plate glass 126 in the opposite direction to the heat shrinkage and which is a cause of a crack. The phrase “press pressure is reduced with time” as used herein includes, in the second step, not only a case in which the press pressure is reduced with time but also a case in which, even if the press pressure is temporarily increased or maintains a fixed value with time, when change in press pressure with time is approximated by a linear equation, the slope thereof is negative. Further, the press pressure may be reduced stepwise with time, or may be reduced continuously with time.

Note that, when the press pressure is reduced stepwise with time, the press pressure is preferably reduced when the temperature of the plate glass 126 sandwiched between the first press mold 150 and the second press mold 160 is lowered to a range of ±30° C. from the defromation point of the glass material forming the plate glass 126. This enables more effective suppression of a crack in the plate glass 126 with relatively simple control of the press pressure. Note that, in this case, from the viewpoint of accomplishing in balance both the suppression of a crack in the plate glass 126 with reliability and the suppression of deterioration of the flatness, the press pressure is preferably in a range of on the order of 1% to 10% after the reduction with that before the reduction being 100%.

### —Taking Out Step—

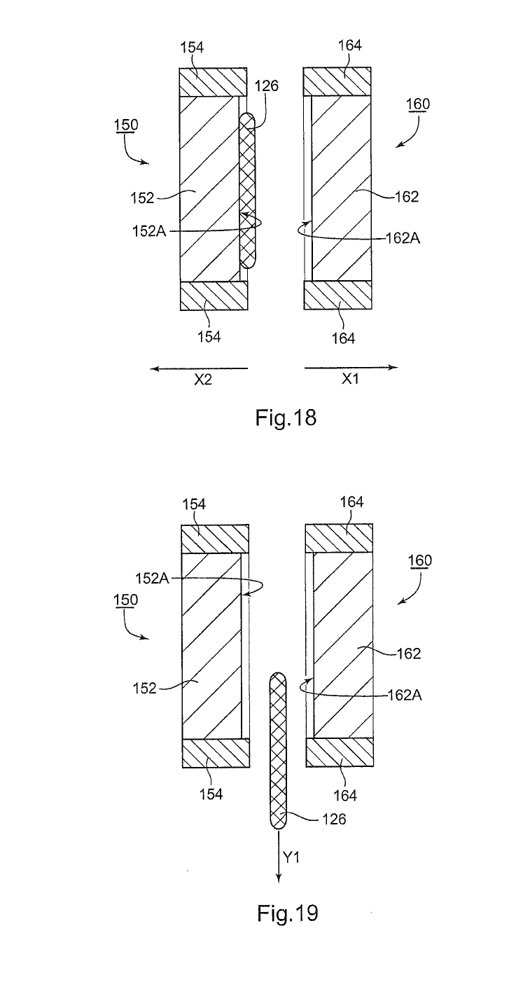

After the second step is carried out, the taking out step is carried out in which the first press mold 150 and the second press mold 160 are moved away from each other and the plate glass 126 sandwiched between the first press mold 150 and the second press mold 160 is taken out. The taking out step may be carried out as, for example, described in the following. First, as illustrated in FIG. 18, the first press mold 150 is moved in the direction of the arrow X2 and the second press mold 160 is moved in the direction of the arrow X1 so that the first press mold 150 and the second press mold 160 are moved away from each other. This releases the press-molding surface 162A from the plate glass 126. Next, as illustrated in FIG. 19, the plate glass 126 is released from the press-molding surface 152A, and the plate glass 126 is caused to fall to the downward Y1 side in the vertical direction and is taken out. Note that, when the plate glass 126 is released from the press-molding surface 152A, by applying force from an outer peripheral direction of the plate glass 126, the plate glass 126 may be released as if the plate glass 126 is stripped off. In this case, the plate glass 126 may be taken out without applying great force thereto. Note that, in taking out the plate glass 126, the plate glass 126 may be released from the press-molding surface 162A after the plate glass 126 is released from the press-molding surface 152A. Finally, the plate glass 126 which is taken out is annealed as necessary to reduce or remove strain thereon, and a base material from which the magnetic recording medium glass substrate is formed, that is, the glass blank, is obtained.

### —Glass Blank—

With regard to the glass blank obtained by the method of manufacturing a glass blank according to the second embodiment described above, the flatness may be caused to be, for example, 10 μm or less, and it is extremely easy to even cause the flatness to be 4 μm or less. Note that, from the viewpoint of eliminating or shortening downstream steps such as a lapping step which are carried out mainly for the purpose of improving the flatness, the flatness is preferably 4 μm or less.

### —Press Mold—

The press mold 150 used in the method of manufacturing a glass blank according to the second embodiment includes at least the press mold body 152 and the guide member 154. The press mold 160 includes at least the press mold body 162 and the guide member 164, and has the same structure as that of the press mold 150. In the following, the press mold 150 is described as an example. First, in the press mold 150, the press mold body 152 and the guide member 154 are formed as separate members. Therefore, in the first step, the press mold body 152 and the guide member 154 may be integrally driven so as to be pushed to the side of the press mold 160 which is placed to be opposed thereto, and, in the second step, only the press mold body 152 may be driven so as to be relatively pushed with respect to the guide member 154 to the side of the press mold 160 which is placed to be opposed thereto. The press mold 150 has the structure and function as described above, and hence, the thickness deviation and the flatness of the glass blank may be reduced more.

Note that, if attention is given only to reducing the thickness deviation, a press mold in which the press mold body 152 and the guide member 154 are integrally formed may be used. However, in a press mold of this type, it is not possible to drive only the press mold body 152 so as to be relatively pushed with respect to the guide member 154 to the side of the press mold 160 which is placed to be opposed thereto. Therefore, even if, after the first step is completed, the state in which the guide member 154 and the guide member 164 are in contact with each other is continued, both the surfaces of the plate glass 126 cannot be supported by bringing the press-molding surfaces 152A and 162A always into intimate contact therewith out a gap. In consequence, the glass blank is liable to deteriorate in flatness.

Further, if attention is given only to reducing the flatness, a press mold which does not include the guide member 154 (guide-memberless mold) may be used. With a press mold of this type, even after the molten glass gob 124 is press-molded into the plate glass 126, both the surfaces of the plate glass 126 may be supported by bringing the press-molding surfaces 152A and 162A always into intimate contact therewith out a gap. However, the guide members 154 and 164 do not exist, and thus, unless the press mold is driven extremely precisely, it is difficult to carry out the press molding with the press-molding surface 152A and the press-molding surface 162A being held precisely in parallel with each other. Therefore, the glass blank is liable to deteriorate in thickness deviation.

Taking into consideration the points described above, the press mold 150 (and the press mold 160) including at least the guide member 154 and the press mold body 152 which are formed as separate members is extremely advantageous in that both the thickness deviation and the flatness of the glass blank may be improved in a balanced manner.

It is preferred to use a metal or an alloy as a material for forming each of the press molds 150 and 160 in view of heat resistance, workability, and durability. In this case, in view of the temperature of molten glass, the heat resistant temperature of the metal or alloy for forming each of the press molds 150 and 160 is preferably 1,000° C. or more, more preferably 1,100° C. or more. Specific examples of the material for forming each of the press molds 150 and 160 preferably include ferrum casting ductile (FCD), alloy tool steel (such as SKD61), high-speed steel (SKH), cemented carbide, Colmonoy, and Stellite. Note that, it may be possible to control the press molding by cooling the press molds 150 and 160 by using a cooling medium such as water or air so that the temperatures of the press molds 150 and 160 do not rise. Further, for the purpose of causing the temperature distribution within the press-molding surfaces 152A and 162A to be uniform, the cooling medium may be used to cool the vicinity of the central portions of the press-molding surfaces 152A and 162A and/or a heating member such as a heater may be placed on outer peripheral sides of the press molds 150 and 160 to heat the outer edge sides of the press-molding surfaces 152A and 162A.

Further, regions (molten glass stretching regions S1 and S2) in contact with at least the plate glass 126 of the press-molding surfaces 152A and 162A of the first press mold 150 and the second press mold 160, respectively, may be surfaces having formed thereon as significant an irregular portion as, for example, a convex portion for forming in the surfaces of the glass blank a V-shaped groove or the like having the depth on the order of ⅓ to ¼ of the thickness thereof, but, usually, it is preferred that the regions be substantially flat surfaces. Note that, the whole of the press-molding surfaces 152A and 162A may be substantially flat surfaces. A reason for this is that, when a large V-shaped groove is formed in the glass blank, a crack defect which is assumed to be due to stress concentration on the V-shaped groove portion is liable to be caused. In addition to this, when a significantly irregular portion is formed in the molten glass stretching regions S1 and S2, heat shrinkage of the plate glass 126 in the diameter direction in the second step is prevented. Therefore, excessive stress is produced in the plate glass 126 in the in-plane direction, which causes the plate glass 126 to be liable to be cracked.

Here, the term “substantially flat surface” not only means a usual flat surface whose curvature is substantially zero, but also means a surface having such a very small curvature that a slightly convex surface or a slightly concave surface is formed. Further, it is naturally allowed for the “substantially flat surface” to have minute irregularities which are formed when usual flattening processing, usual mirror polishing processing, or the like is applied at the time of manufacturing press molds, and it is also acceptable for the “substantially flat surface” to have convex portions and/or concave portions larger than the minute irregularities, if necessary.

Here, it is allowed for the convex portion larger than the minute irregularity to include a substantially point-shaped convex portion and/or a substantially linear-shaped convex portion each having such a height of 20 μm or less that those portions have a slight chance of bringing about the deterioration of flow resistance and promoting the partial cooling of a molten glass gob. Note that, the height is preferably 10 μm or less, more preferably 5 μm or less. Further, when the convex portion larger than the minute irregularity is a trapezoid-shaped convex portion having a minimum width in top surface on the order of several millimeters or more, or a dome-shaped convex portion having nearly the same height and size as the trapezoid-shaped convex portion instead of the substantially point-shaped convex portion and substantially linear-shaped convex portion, the above-mentioned chance of bringing about the deterioration of flow resistance and promoting the partial cooling of a molten glass gob becomes smaller, and hence the convex portion is allowed to have a height of 50 μm or less. Note that, the height is preferably 30 μm or less, more preferably 10 μm or less. Further, from the viewpoint of suppressing the occurrence of a crack due to stress concentration at the intersection part between the bottom surface and a side surface of the trapezoid-shaped convex portion, it is preferred that the side surface of the trapezoid-shaped convex portion be a flat surface having an angle of slope of 0.5° or less with respect to the top surface, or be a curved surface created by modifying the flat surface to a concave surface. Note that, the angle is more preferably 0.1° or less.

Further, it is allowed for the concave portion larger than the minute irregularity to include a substantially point-shaped concave portion and/or a substantially linear-shaped concave portion each having a depth of 20 μm or less, in order that, for example, the deterioration of the flowability of molten glass flowing into the concave portion at the time of press molding is not brought about. Note that, the depth is preferably 10 μm or less, more preferably 5 μm or less. Further, when the concave portion larger than the minute irregularity is an inverted trapezoid-shaped concave portion having a minimum width in top surface on the order of several millimeters or more, or an inverted dome-shaped concave portion having nearly the same height and size as the inverted trapezoid-shaped concave portion instead of the substantially point-shaped concave portion and substantially linear-shaped concave portion, the above-mentioned chance of bringing about the deterioration of the flowability becomes smaller, and hence the concave portion is allowed to have a depth of 50 μm or less. Note that, the depth is preferably 30 μm or less, more preferably 10 μm or less. Further, from the viewpoint of suppressing the occurrence of a crack due to stress concentration at the intersection part between the bottom surface and a side surface of the trapezoid-shaped convex portion, it is preferred that the side surface of the trapezoid-shaped convex portion be a flat surface having an angle of slope of 0.5° or less with respect to the bottom surface, or be a curved surface created by modifying the flat surface to a concave surface. Note that, the angle is more preferably 0.1° or less.

Note that, as illustrated in FIG. 14 to FIG. 19, the specific structure of the press mold 150 (and the press mold 160) is not specifically limited insofar as the press mold 150 includes at least the press mold body 152 and the guide member 154 and the first step and the second step may be carried out. However, it is preferred that the press mold 150 further include, in addition to the press mold body 152 and the guide member 154, a first pushing member and a second pushing member. Here, the first pushing member has at least the function of pushing the press mold body 152 and the guide member 154 at the same time in a direction perpendicular to the press-molding surface 152A and to the side of the press mold 160 which is placed to be opposed to the press-molding surface 152A. The second pushing member has at least the function of, after the guide member 154 and a part of the press mold 160 (guide member 164) which is placed to be opposed to the press-molding surface 152A are brought into contact with each other by the first pushing member, pushing the press mold body 152 in the direction perpendicular to the press-molding surface 152A and to the side of the press mold 160 which is placed to be opposed to the press-molding surface 152A.

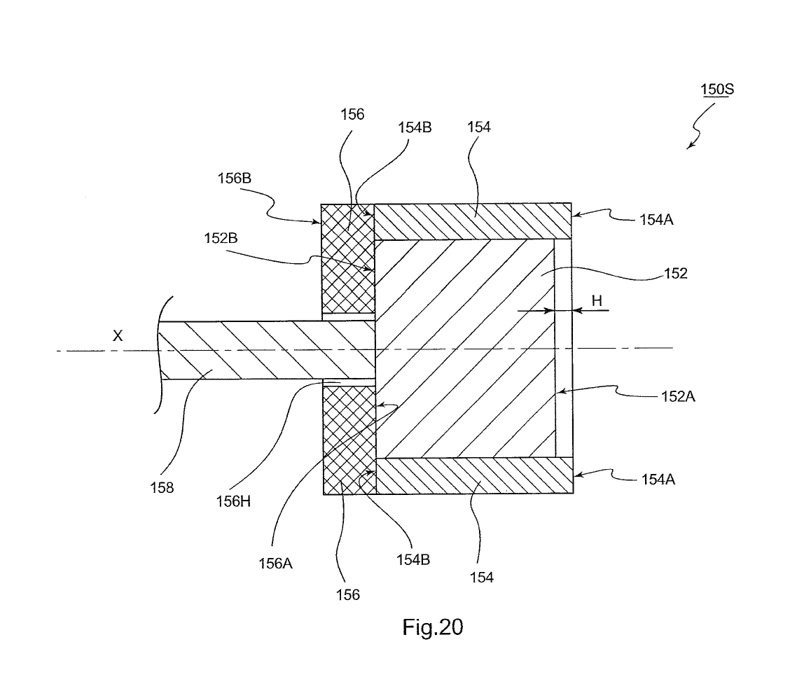

FIG. 20 is a schematic sectional view for illustrating one example of the press mold used in the method of manufacturing a glass blank for a magnetic recording medium glass substrate according to the second embodiment, and more specifically, a view for illustrating one example of the more specific structures of the press molds 150 and 160. In FIG. 20, like reference numerals are used to designate members similar to those illustrated in FIG. 14 to FIG. 19. Further, a press mold 150S illustrated in FIG. 20 is a figure corresponding to the press mold 150, but a similar structure may be adopted in the press mold 160. Here, a principal part of the press mold 150S includes the press mold body 152, the guide member 154, a first pushing member 156, and a second pushing member 158. Central axes of the members are coincident (dot-and-dash line X in the figure), and the central axes are substantially coincident with the horizontal direction.

Here, the press mold body 152 is formed of a circular cylinder having one end surface that forms the circular press-molding surface 152A. Note that, the shape of the press mold body 152 is a circular cylinder in the example illustrated in FIG. 20, but the shape is not specifically limited insofar as the shape is substantially columnar. In the example illustrated in FIG. 20, the press-molding surface 152A is a substantially flat surface.

The guide member 154 is a hollow circular cylinder, which has a length in an axial direction X that is longer than the length in the axial direction X of the press mold body 152 which is a circular cylinder, which houses the press mold body 152 in an inner peripheral side, and which has one end surface (guide surface 154A) that is brought into contact with the guide member of the other press mold (not shown in the figure) when pushed by the first pushing member 156. Here, the difference between the length of the guide member 154 and the length of the press mold body 152 in the axial direction X, in other words, a height difference H between the guide surface 154A and the press-molding surface 152A in the axial direction X, corresponds to a length which is approximately a half of the thickness of the glass blank to be produced. Note that, the shape of the guide member 154 is a hollow circular cylinder, but the shape is not specifically limited insofar as the shape is hollow columnar.

The first pushing member 156 is formed of a disk-like member. Here, one surface (pushing surface 156A) of the disk-like first pushing member 156 is a flat surface which is in contact with the other end surface (pushed surface 152B) of the press mold body 152 and with the other end surface (pushed surface 154B) of the guide member 154. Further, a through hole 156H which passes through the first pushing member 156 in the thickness direction is provided in a part of a region which is opposed to the pushed surface 152B of the press mold body 152. Note that, a surface 156B which is opposite to the pushing surface 156A is connected to a first drive (not shown). Therefore, in the press molding, by the first drive, the press mold body 152 and the guide member 154 may be pushed at the same time via the first pushing member 156 in the axial direction-X illustrated in the figure from the side on which the first pushing member 156 is placed to the side on which the press mold body 152 and the guide member 154 are placed.

Note that, in the example illustrated in FIG. 20, the shape of the first pushing member 156 is a disk, but the shape is not specifically limited insofar as the shape is substantially plate-like. Further, the through hole 156H is provided as a hole having a circular opening along the central axis X of the press mold body 152 and the first pushing member 156, but an arbitrary number of the through holes 156H may be provided at arbitrary positions in the first pushing member 156 insofar as the positions are in a part of the region which is opposed to the pushed surface 152B of the press mold body 152. Further, the shape of the opening of the through hole 156H may be appropriately selected as well. However, it is particularly preferred that the through hole (s) 156H be provided so as to have point symmetry with respect to the central axis X of the press mold body 152.

The second pushing member 158 is formed of a rod-like member which is placed within the through hole 156H and is connected to the pushed surface 152B side of the press mold body 152. Note that, the shape of the second pushing member 158 is a circular cylindrical rod in the example illustrated in FIG. 20, but the shape is not specifically limited insofar as the second pushing member 158 may move the press mold body 152 in the X axis direction. Note that, an end of the second pushing member 158 which is opposite to an end thereof connected to the pushed surface 152B side is connected to a second drive (not shown). Therefore, in the press molding, by the second drive, only the press mold body 152 may be pushed via the second pushing member 158 along the axial direction X from the side on which the second pushing member 158 is placed to the side on which the press mold body 152 is placed.

Note that, in the press molding, in order to facilitate thin and uniform stretch of the molten glass gob 124, it is preferred that the temperature distribution within the press-molding surface 152A be controllable to be uniform. In order to attain this, (1) a heating member for heating the vicinity of an outer edge side of the press-molding surface 152A may be provided, and/or (2) a flow path through which a cooling medium flows may be provided in the press mold body 152 and at least in the vicinity of the central portion on the press-molding surface 152A side.

Here, the heating member may be, for example, a cylindrical heater placed on an outer peripheral side of the guide member 154 or bar-like heaters in parallel with the axial direction X which are placed at regular intervals along a peripheral direction of the guide member 154. Note that, these heaters may be built in the guide member 154, or may be placed so as to be embedded on an outer peripheral surface side of the press mold body 152. Further, as the cooling liquid, a liquid such as water, a gas such as air, a gas in which a liquid is dispersed by being sprayed, or the like may be used.

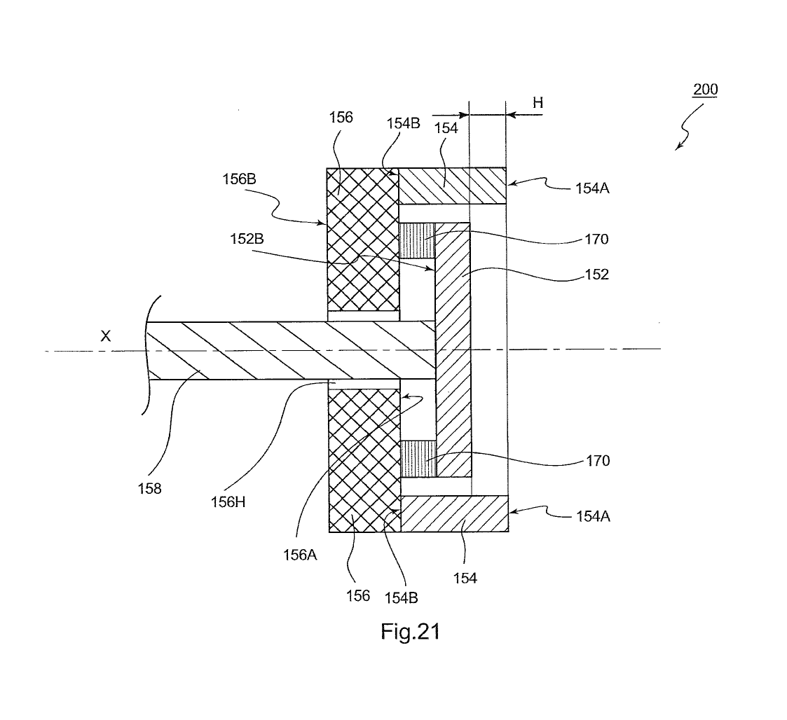

Further, as the press molds 150 and 160, a press mold illustrated in FIG. 21 may be used. FIG. 21 is a schematic sectional view illustrating another example of the press mold used in the method of manufacturing a glass blank for a magnetic recording medium glass substrate according to the second embodiment. Note that, in FIG. 21, like reference numerals are used to designate members having substantially the same or similar functions as those illustrated in FIG. 20.

Here, a principal part of a press mold 200 illustrated in FIG. 21 includes the press mold body 152, the guide member 154, the first pushing member 156, and the second pushing member 158. Central axes of the members (dot-and-dash line X in the figure) are coincident, and the central axes are substantially coincident with the horizontal direction. Note that, the press mold 200 illustrated in FIG. 21 and the press mold 1505 illustrated in FIG. 20 are similar in including the press mold body 152, the guide member 154, the first pushing member 156, and the second pushing member 158, but are greatly different from each other mainly in the following points. That is, compared with the case of the press mold 150S illustrated in FIG. 20, in the press mold 200 illustrated in FIG. 21, (1) the press mold body 152 and the guide member 154 are placed so that an outer peripheral surface of the press mold body 152 and an inner peripheral surface of the guide member 154 are substantially distanced from each other, (2) the press mold body 152 and the first pushing member 156 are placed so that the pushed surface 152B of the press mold body 152 and the pushing surface 156A of the first pushing member 156 are substantially distanced from each other, and (3) a support member 170 is placed between the pushed surface 152B and the pushing surface 156A along the outer peripheral side of the pushed surface 152B.

Here, the press mold body 152 is formed of a circular cylinder having one end surface that forms the circular press-molding surface 152A. Note that, the shape of the press mold body 152 is a disk in the example illustrated in FIG. 20, but the shape is not specifically limited insofar as the shape is substantially disk. In the example illustrated in FIG. 21, the press-molding surface 152A is a substantially flat surface. Further, the support member 170 is placed so as to be fixed to any one of the pushed surface 152B and the pushing surface 156A, and is movable away from the other surface. Note that, as the support member 170, for example, a ring-like member may be used.

In the press mold 200 illustrated in FIG. 21, the first pushing member 156 may push the guide member 154 to the other press mold which is placed to be opposed to the press mold 200. In this case, at the same time, the press mold body 152 is also pushed via the support member 170 to the other press mold which is placed to be opposed to the press mold 200. Further, the second pushing member 158 may push only the press mold body 152 to the other press mold which is placed to be opposed to the press mold 200. Note that, in the example illustrated in FIG. 20, in the press molding, a pressing force is applied to the press mold body 152 (1) in the vicinity of a central portion or (2) in the vicinity of an outer edge portion of the pushed surface 152B. Therefore, it is preferred that conditions of the press such as the thickness, the material, the strength, and the like of the press mold body 152, the strength and the like of the support member 170, or the press pressure are selected so that the press mold body 152 does not warp no matter where among the locations of (1) and (2) the pressing force is applied.

Note that, the example illustrated in FIG. 14 to FIG. 19 is directed to the second pressing process. When the first pressing process is carried out, for example, only one of the pair of press molds needs to employ the press mold 150S illustrated in FIG. 20 or the press mold 200 illustrated in FIG. 21. In this case, as the other press mold, for example, a press mold which is substantially formed of only a press mold body portion such as a simple disk-like member or cylindrical member to be described below (for example, a press mold 310 to be described below illustrated in FIG. 23) may be used. In this case, for example, in the first step, a part of the other press mold (for example, the press-molding surface thereof) and the guide surface 154A are brought into contact with each other, and, in the second step, the press mold body 152 is further pushed to the side of the other press mold under the state in which the part of the other press mold and the guide surface 154A are in contact with each other.

### —Glass Material—

The glass material used in the method of manufacturing a glass blank according to the second embodiment is not specifically limited insofar as the glass material has physical properties suitable for a magnetic recording medium glass substrate, in particular, a high thermal expansion coefficient, further, high stiffness, or heat resistance and the like, and, at the same time, the glass material may be easily press-molded into a plate shape by the horizontal direct press. It is desired that the thermal expansion coefficient be similar to the thermal expansion coefficient of a holder for holding the magnetic recording medium. More specifically, the average linear expansion coefficient at 100 to 300° C. is preferably 70×10⁻⁷/° C. or more, more preferably 75×10⁻⁷/° C. or more, still more preferably 80×10⁻⁷/° C. or more, yet still more preferably 85×10⁻⁷/° C. or more. The upper limit of the average linear expansion coefficient is not specifically limited, but, practically, preferably 120×10⁻⁷/° C. or less. For the purpose of reducing deflection which is caused when the magnetic recording medium rotates at high speed, a glass material having high stiffness is desired. More specifically, the Young's modulus is preferably 70 GPa or more, more preferably 75 GPa or more, still more preferably 80 GPa or more, yet still more preferably 85 GPa or more. The upper limit of the Young's modulus is not specifically limited, but, practically, preferably 120 GPa or less. Further, by using a glass material which is excellent in heat resistance, the substrate may be processed at a high temperature in the process of manufacturing a magnetic recording medium, and hence, the glass transition temperature of the glass material is preferably 600° C. or more, more preferably 610° C. or more, still more preferably 620° C. or more, yet still more preferably 630° C. or more. Note that, the upper limit of the glass transition temperature is not specifically limited, but, from a practical viewpoint of suppressing temperature rise in the press molding and the like, is preferably 780° C. or less. Using a glass material which has a high thermal expansion coefficient, high stiffness, and heat resistance is effective in obtaining a glass substrate suitable for a magnetic recording medium having a high recording density.

As the composition of the glass material, a composition which may easily materialize physical properties suitable for a magnetic recording medium glass substrate may be appropriately selected, and for example, a glass composition of a conventional glass material for the vertical direct press may be appropriately selected, but it is preferred that aluminosilicate glass be selected. Note that, a composition of aluminosilicate glass described below is particularly preferred, because all of heat resistance, high stiffness, and a high thermal expansion coefficient may be easily accomplished in a well-balanced way.

That is, it is preferred that the glass composition of the glass (hereinafter, referred to as “Glass Composition 1”), expressed in mol %, include

### 50 to 75% of SiO₂,

### 0 to 5% of Al₂O₃,

### 0 to 3% of Li₂O,

### 0 to 5% of ZnO,

3 to 15% in total of at least one kind of component selected from Na₂O and K₂O,
14 to 35% in total of at least one kind of component selected from MgO, CaO, SrO, and BaO, and
2 to 9% in total of at least one kind of component selected from ZrO₂, TiO₂, La₂O₃, Y₂O₃, Yb₂O₃, Ta₂O₅, Nb₂O₅, and HfO₂, and
the molar ratio {(MgO+CaO)/(MgO+CaO+SrO+BaO)} be in the range of 0.8 to 1 and the molar ratio {Al₂O₃/(MgO+CaO)} be in the range of 0 to 0.30.

A preferred range of the average linear expansion coefficient of Glass Composition 1 at 100 to 300° C. is 70×10⁻⁷/° C. or more, a preferred range of the glass transition temperature is 630° C. or more, and a preferred range of the Young's modulus is 80 GPa or more. Glass Composition 1 is suitable as a material of a magnetic recording medium glass substrate of an energy-assisted method using a high Ku magnetic material.

Further, as a glass material which has a high thermal expansion coefficient, which is excellent in acid resistance and alkali resistance, which reduces the amount of alkaline elution from a surface of the substrate, and which is suitable for chemical strengthening, one having the following glass composition (hereinafter referred to as “Glass Composition 2”) may be presented.

That is, Glass Composition 2 includes, as a composition expressed in mol %,

70 to 85% in total of SiO₂ and Al₂O₃, provided that the content of SiO₂ is 50% or more and the content of Al₂O₃ is 3% or more,
10% or more in total of Li₂O, Na₂O, and K₂O,
1 to 6% in total of MgO and CaO, provided that the content of CaO is higher than the content of MgO, and
more than 0% and 4% or less in total of ZrO₂, TiO₂, La₂O₃, Y₂O₃, Yb₂O₃, Ta₂O₅, Nb₂O₅, and HfO₂.

### (Method of Manufacturing Magnetic Recording Medium Glass Substrate)

The method of manufacturing a magnetic recording medium glass substrate according to the second embodiment is characterized in that a magnetic recording medium glass substrate is manufactured by at least going through a polishing step of polishing the main surface of a glass blank manufactured by the method of manufacturing a glass blank for a magnetic recording medium glass substrate according to the second embodiment. Hereinafter, specific examples of steps involved in the processing of a glass blank into a magnetic recording medium glass substrate are described in more detail.

First, scribing is performed on a glass blank obtained by carrying out the press molding. The scribing refers to providing cutting lines (line-like flaws) like two concentric circles (inner concentric circle and outer concentric circle) with a scriber made of cemented carbide or formed of diamond particles on a surface of a molded glass blank, in order to process the molded glass blank into a ring shape having a predetermined size. The glass blank having scribed thereon the two concentric circles is partially heated, and the outside portion of the outer concentric circle and the inside portion of the inner concentric circle are removed by virtue of the difference in thermal expansion of glass, thereby yielding a disk-shaped glass having a perfect circle shape.

When scribe processing is carried out, if the roughness of the main surfaces of the glass blank is 1 μm or less, cutting lines can be suitably provided by using a scriber. Note that, in the case where the roughness of the main surfaces of the glass blank exceeds 1 μm, a scriber does not follow the irregularities of the surface and it may become difficult to provide cutting lines uniformly. In this case, after the main surfaces of the glass blank are made smooth, scribing is performed.

Next, the scribed glass undergoes shape processing. The shape processing includes chamfering (chamfering of an outer peripheral end portion and an inner peripheral end portion). In the chamfering, the outer peripheral end portion and inner peripheral end portion of the ring-shaped glass are chamfered with a diamond grinding stone.

Next, the disk-shaped glass undergoes end surface polishing. In the end surface polishing, the inner peripheral side end surface and outer peripheral side end surface of the glass undergo mirror finish by brush polishing. In this case, there is used a slurry including fine particles of cerium oxide or the like as free abrasive grains. The end surface polishing removes contamination caused by attachment of dust or the like and impair such as damage or flaws on or in the end surfaces of the glass. As a result, precipitation of ions of sodium, potassium, and the like causing corrosion can be prevented from occurring.

Next, first polishing is carried out on the main surfaces of the disk-shaped glass. The purpose of the first polishing is to remove flaws and strain remaining in the main surfaces. A machining allowance removed by the first polishing is, for example, several μm to about 10 μm. As a grinding step involving a large amount of a machining allowance is not required to be performed, flaws, strain, and the like, which are caused by the grinding step, are not generated in the glass. Thus, the first polishing step involves a small amount of a machining allowance.

In the first polishing step and the second polishing step described below, a double-side polishing apparatus is used. The double-side polishing apparatus is an apparatus for carrying out polishing with polishing pads by relatively moving a disk-shaped glass and the polishing pads. The double-side polishing apparatus includes a polishing carrier fitting portion having an internal gear and a sun gear which are each rotationally driven at a predetermined rotation rate and also includes an upper surface plate and a lower surface plate which are rotationally driven in opposite directions to each other with the polishing carrier fitting portion being sandwiched by both the plates. On each surface facing a disk-shaped glass of the upper surface plate and lower surface plate, the polishing pads described below are attached. Each polishing carrier fitted so as to be engaged with each of the internal gear and the sun gear performs a planetary gear motion, that is, revolves around the sun gear while spinning.

The each polishing carrier holds a plurality of disk-shaped glasses. The upper surface plate is movable in the vertical direction and presses each polishing pad onto the front and back main surfaces of each disk-shaped glass. Then, while a slurry (polishing liquid) containing polishing abrasive grains (polishing material) is being supplied, the disk-shaped glass and the polishing pad move relatively owning to the planetary gear motion of the polishing carrier and the phenomenon that the upper surface plate and the lower surface plate rotate in opposite directions to each other. As a result, the front and back main surfaces of each disk-shaped glass is polished. Note that, in the first polishing step, a hard resin polisher, for example, is used as the polishing pad and cerium oxide abrasive grains, for example, are used as the polishing material.

Next, the disk-shaped glass after the first polishing is subjected to chemical strengthening. It is possible to use a molten salt of potassium nitrate or the like as a chemical strengthening solution. In the chemical strengthening, the chemical strengthening solution is heated to, for example, 300° C. to 400° C., and a cleaned glass is pre-heated to, for example, 200° C. to 300° C. and then immersed in the chemical strengthening solution for, for example, 3 hours to 4 hours. The immersion is preferably performed under a state in which a plurality of glasses are contained in a holder so as to be held by their end surfaces so that both main surfaces of each of the glasses entirely undergo chemical strengthening.

Each glass is immersed in the chemical strengthening solution, as described above, and as a result, sodium ions in the surface layers of the glass are substituted by potassium ions each having a relatively large ion radius in the chemical strengthening solution, respectively, forming a compressive stress layer with a thickness of about 50 to 200 μm. Thus, the glass is strengthened and is provided with good impact resistance. Note that, the glass having undergone chemical strengthening treatment is cleaned. For example, the glass is cleaned with sulfuric acid and then cleaned with pure water, isopropyl alcohol (IPA), or the like.

Next, the glass which has undergone chemical strengthening and has been cleaned sufficiently is subjected to second polishing. A machining allowance removed by the second polishing is, for example, about 1 μm.

The purpose of the second polishing is to finish the main surfaces like mirror surfaces. In the second polishing step, the disk-shaped glass is polished by using a double-side polishing apparatus as in the first polishing step, but the composition of polishing abrasive grains contained in a polishing liquid (slurry) to be used and the composition of a polishing pad are different from those in the first one. In the second polishing step, there are used polishing abrasive grains each having a smaller diameter and a softer polishing pad compared with those in the first polishing step. For example, in the second polishing step, a soft foamed resin polisher, for example, is used as the polishing pad, and finer cerium oxide abrasive grains than the cerium oxide abrasive grains used in the first polishing step are, for example, used as the polishing material.

The disk-shaped glass polished in the second polishing step is again cleaned. In the cleaning, a neutral detergent, pure water, or IPA is used. The second polishing yields a glass substrate for a magnetic disk having a main surface flatness of 4 μm or less and a main surface roughness of 0.2 nm or less. After that, various layers such as a magnetic layer are formed on the glass substrate for a magnetic disk, and a magnetic disk is produced.

Note that, the chemical strengthening step is carried out between the first polishing step and the second polishing step, and the order of these steps is not limited to this order. As long as the second polishing step is carried out after the first polishing step, the chemical strengthening step can be arbitrarily arranged. For example, the order of the first polishing step, the second polishing step, and the chemical strengthening step (hereinafter, referred to as “Routing 1” may be adopted. Note that, if Routing 1 is adopted, surface irregularities that may be produced by the chemical strengthening step are not removed, and hence more preferred is the routing of the first polishing step, the chemical strengthening step, and the second polishing step.

Note that, in manufacturing a magnetic recording medium glass substrate, the flatness of the glass blank used in the processing and the flatness of the produced magnetic recording medium glass substrate may be caused to be substantially the same. As a flatness required of a magnetic recording medium glass substrate, for example, in recent years, a flatness which is 10 μm or less is required with regard to a 2.5-inch glass substrate. Such flatness may be easily accomplished by a glass blank produced by the method of manufacturing a glass blank according to the second embodiment of the present invention. The “flatness of the glass blank used in the processing and the flatness of the produced magnetic recording medium glass substrate are substantially the same” as used herein means that the flatness of the glass blank is 105% or less with the required flatness of the magnetic recording medium glass substrate being the reference (100%).

Note that, when the flatness of the glass blank used in the processing and the flatness of the produced magnetic recording medium glass substrate are caused to be substantially the same, a step such as a lapping step which is carried out with one of the main purposes thereof being to improve the flatness may be eliminated.

### (Method of Manufacturing Magnetic Recording Medium)

A method of manufacturing a magnetic recording medium according to the second embodiment of the present invention is characterized in that a magnetic recording medium is produced by at least going through a magnetic recording layer-forming step of forming a magnetic recording layer on a magnetic recording medium glass substrate produced by the method of manufacturing a magnetic recording medium glass substrate according to the second embodiment of the present invention.

A magnetic recording medium is also called, for example, a magnetic disk or a hard disk, and is suitable for internal storages (such as fixed disks) for desk top computers, server computers, notebook computers, mobile computers, and the like, internal storages for portable recording and reproducing devices used for recording and reproducing images and/or sounds, recording and reproducing devices for in-car audio systems, and the like.

The magnetic recording medium has, for example, a configuration in which at least an adherent layer, an undercoat layer, a magnetic layer (magnetic recording layer), a protective layer, and a lubricant layer are laminated on the main surface of a substrate sequentially, starting from the layer close the main surface of the magnetic recording medium glass substrate. For example, a magnetic recording medium glass substrate is introduced into a film-forming apparatus in which pressure is reduced, and each layer from the adherent layer to the magnetic layer is sequentially formed on the main surface of the magnetic recording medium glass substrate in an Ar atmosphere by using a DC magnetron sputtering method. There can be used, for example, CrTi as the adherent layer, and, for example, CrRu as the undercoat layer. After the above-mentioned film formation, the protective layer is formed with C₂H₄ gas by using, for example, a CVD method, and then, nitriding treatment including introducing nitrogen into the surface is carried out in the same chamber, thereby being able to form the magnetic recording medium. After that, for example, polyfluoropolyether (PFPE) is applied on the protective layer by a dip coating method, thereby being able to form the lubricant layer.

The size of the magnetic recording medium is not specifically limited. However, the magnetic recording medium glass substrate is formed of a glass material which is excellent in impact resistance, and hence, it is suitable that the size is 2.5 inch or smaller which is conveniently portable and highly likely to be exposed to impact from the outside.

### EXAMPLES

### Examples of First Aspect of the Present Invention

Hereinafter, the first aspect of the present invention is described by way of examples, but the first aspect of the present invention is not limited to only the following examples.

### <<Production of Glass Blank>>

In examples and comparative examples, more than several hundreds of glass blanks (diameter: about 75 mm, thickness: about 0.9 mm) for producing 2.5-inch magnetic recording medium glass substrates were continuously produced.

### Example A1

According to the process illustrated in FIG. 1 to FIG. 9, the molten glass gob forming step, the first pressing step, the second pressing step, and the taking out step were carried out to produce glass blanks. Note that, the viscosity of the molten glass which flows out from the glass outlet 12 was adjusted to be 700 dPa·s, the first press mold 50 and the second press mold 60 were placed so as to be perpendicular to the direction in which the molten glass gob 24 fell, and the falling distance was set to be 150 mm.

Here, main physical property values and the composition of the glass material used in producing the glass blanks were as follows.

Glass transition temperature: 495° C.

Deformation point: 550° C.

Strain point: 490° C.

Composition: composition corresponding to Glass Composition 2

Further, specific conditions for carrying out the first pressing step and the second pressing step and details of the press molds 50 and 60 used in the press molding were as follows.

### —Conditions for Carrying Out First Pressing Step—

The temperature of the press-molding surface 52A immediately before the first pressing step was carried out was set to be 500° C., the temperature of the press-molding surface 62A immediately before the first pressing step was carried out was set to be 500° C., the temperature difference within the press-molding surface 52A immediately before the first pressing step was carried out was set to be 50° C., and the temperature difference within the press-molding surface 62A immediately before the first pressing step was carried out was set to be 50° C. Note that, the press molds 50 and 60 were set to be driven so that the press-molding surface 52A and the press-molding surface 62A were brought into contact with the molten glass gob 24 at the same time. Further, the press-molding time was 0.07 second. Note that, the temperatures of the press-molding surfaces 52A and 62A were monitored by thermocouples placed at a depth of 1 mm from the press-molding surfaces 52A and 62A. Among the thermocouples, one was placed at the center of each of the press-molding surfaces 52A and 62A, and four were placed at positions of 30 mm in radius from the center of each of the press-molding surfaces 52A and 62A so as to form angles of 0°, 90°, 180°, and 270° in a peripheral direction, respectively.

### —Conditions for Carrying out Second Pressing Step—

The duration time of the second pressing step was adjusted and the flatness of the obtained glass blanks was measured. When the duration time of the second pressing step was 2 seconds or more, the flatness of the glass blanks was 4 μm. Therefore, the duration time of the second pressing step was set to be 2 seconds. The temperature of the plate glass 26 when the second pressing step was completed (temperature when taken out) was 495° C. The press pressure during the second pressing step was carried out was set to be always held at 0.5 MPa. Note that, the temperature of the plate glass 26 was a value determined on the assumption that the temperature was a temperature measured by the thermocouple placed at the center of each of the press-molding surfaces 52A and 62A. In this way, the duration time of the second pressing step was controlled with the flatness of the glass blank being a barometer to obtain glass blanks excellent in flatness.

### —Press Mold—

As the press mold 50, one formed of cast iron of the integral type in which the press mold body 52 and the guide member 54 were integrally formed was used. As the press mold 50, one of the integral type which was similar to the press mold 60 was used. Note that, the press-molding surfaces 52A and 62A were completely flat surfaces. Further, each of the press molds 50 and 60 of the integral type which were used was provided with a flow path for passing cooling water therethrough formed in the press mold body 52 or 62 for controlling the temperature of the press-molding surface 52A or 62A and the temperature distribution within the press-molding surface 52A or 62A, and a heater placed on an outer peripheral side of the press mold 50 or 60. Here, the flow rate of the cooling water and the heating conditions of the heater were controlled so that the difference between the temperature of the press-molding surface 52A of the press mold 50 and the temperature of the press-molding surface 62A of the press mold 60 was always held within a range of ±10° C.

### Example A2

Glass blanks were produced in the same manner as in Example A1 except that the duration time of the second pressing step was lengthened and the temperature of the plate glass when taken out was set to be 490° C.

### Example A3

Glass blanks were produced in the same manner as in Example A1 except that, as the press molds 50 and 60, ones of the separate type in which the press mold bodies 52 and 62 and the guide members 54 and 64 were formed as separate members, respectively, were used.

### Example A4

Glass blanks were produced in the same manner as in Example A3 except that the press pressure during the second pressing step was carried out was reduced with time. Note that, the press pressure was controlled so as to be 50% when the temperature of the plate glass 26 reached a temperature which was 25° C. lower than the defromation point, with the press pressure immediately after the start of the second pressing step being the reference (100%).

### Example A5

Glass blanks were produced in the same manner as in Example A3 except that the press pressure during the second pressing step was carried out was reduced with time. Note that, the press pressure was controlled so as to be 50% when the temperature of the plate glass 26 reached a temperature which was 25° C. higher than the defromation point, with the press pressure immediately after the start of the second pressing step being the reference (100%).

### Example A6

Glass blanks were produced in the same manner as in Example A3 except that the press pressure during the second pressing step was carried out was reduced with time. Note that, the press pressure was controlled so as to be 50% when the temperature of the plate glass 26 reached a temperature which was 40° C. higher than the defromation point, with the press pressure immediately after the start of the second pressing step being the reference (100%).

### Example A7

Glass blanks were produced in the same manner as in Example A3 except that the press pressure during the second pressing step was carried out was reduced with time. Note that, the press pressure was controlled so as to be 50% when the temperature of the plate glass 26 reached a temperature which was 40° C. lower than the defromation point, with the press pressure immediately after the start of the second pressing step being the reference (100%).

### Example A8

Glass blanks were produced in the same manner as in Example A3 except that the press pressure during the second pressing step was carried out was reduced with time. Note that, the press pressure was controlled so as to be 50% when the temperature of the plate glass 26 reached the defromation point, with the press pressure immediately after the start of the second pressing step being the reference (100%).

### Comparative Example A1

Glass blanks were produced in the same manner as in Example A1 except that the duration time of the second pressing step was set to be less than 2 seconds and the temperature of the plate glass when taken out was set to be 520° C.

### Comparative Example A2

Glass blanks were produced in the same manner as in Example A1 except that the second pressing step was eliminated.

### Comparative Example A3

Glass blanks were produced by the vertical direct press using a glass material similar to the one used in Example A1. In the production of the glass blanks, there was used a press apparatus including a rotating table along the outer peripheral edge of which twelve lower molds were arranged at regular intervals and which rotated table rotating in one direction while alternatively moving and stopping for each 30° at the time of press. Further, when the numbers, P1 to P12, were given to twelve lower mold stop positions corresponding to the twelve lower molds arranged on the outer peripheral edge of the rotating table along the rotating direction of the rotating table, the following respective members were arranged above the press surface of a lower mold or at a side of a lower mold at each of the following lower mold stop positions.

Lower mold stop position P1: molten glass supply apparatus

Lower mold stop position P2: Upper mold

Lower mold stop position P9: taking out means (vacuum adsorption apparatus)

In the press apparatus, a predetermined amount of molten glass is supplied onto a lower mold at the lower mold stop position P1, the molten glass is press-molded into a thin plate glass with the upper mold and the lower mold at the lower mold stop position P2, and the obtained thin plate glass (glass blank) is taken out at the lower mold stop position P9. Further, a soaking and cooling step is carried out when the lower mold moves to the stop positions P2 to P9, and preheating of the lower mold is carried out by using a heater when the lower mold moves to the stop positions P9 to P12.

The material of the upper mold and the lower mold and the smoothness and the flatness of the press-molding surfaces were similar to those of the press molds 50 and 60 used in Example A1. Note that, the viscosity of the molten glass immediately before being supplied onto the lower mold located at the lower mold stop position P1 was adjusted to be 500 dPa·s.

### —Conditions for Carrying out Pressing Step—

Note that, the details of the conditions for carrying out the pressing step were as follows. The temperature of the press-molding surface of the upper mold immediately before the pressing step was carried out was set to be 380° C., the temperature of the press-molding surface of the lower mold immediately before the pressing step was carried out was set to be 480° C., the temperature difference within the press-molding surface of the upper mold immediately before the pressing step was carried out was set to be 30° C., and the temperature difference within the press-molding surface of the lower mold immediately before the pressing step was carried out was set to be 30° C. Note that, the upper mold was driven downward 2 seconds later after a predetermined amount of the molten glass was supplied onto the lower mold. Further, time from when the upper mold was brought into contact with the molten glass on the lower mold to when the upper mold and the lower mold were moved away from each other (press-molding time) was 0.3 second. When the pressing step was carried out under the conditions described above, the temperature of the plate glass when the pressing step was completed (temperature when taken out) was 500° C. Note that, the temperatures of the press-molding surfaces of the upper mold and the lower mold were monitored by thermocouples placed at a depth of 5 mm from the press-molding surfaces. Among the thermocouples, one was placed at the center of each of the press-molding surfaces, and four were placed at positions of 15 mm in radius from the center of each of the press-molding surfaces so as to form angles of 0°, 90°, 180°, and 270° in a peripheral direction, respectively.

### Comparative Example A4

Glass blanks were produced in the same manner as in Comparative Example A3 except that the press-molding time was extended so that the temperature when taken out was 495° C. Note that, the production speed was considerably slow and there was no practicality, and thus, at the time of having produced several tens of glass blanks, the press was stopped.

### Comparative Example A5

A press apparatus similar to the one used in Comparative Example A3 except that an upper mold for cooling was further placed on the press surface at the lower mold stop position P3 was used as the press apparatus. Note that, the upper mold for cooling has substantially the same structure as that of the upper mold for press molding placed on the press surface at the lower mold stop position P2. Here, the pressing step to be carried out at the lower mold stop position P2 was carried out under conditions similar to those in Comparative Example A3.

Further, during the period in which the lower mold is stopped at the lower mold stop position P3, a state was held in which the whole upper mold for cooling was preheated to about 480° C. and was brought close to the plate glass placed on the lower mold but was not brought into contact therewith.

### (Evaluation)

The glass blanks produced in the examples and the comparative examples were evaluated in terms of flatness, a crack, and productivity. The results are shown in Table 1 and Table 2. Note that, the temperature between the press-molding surfaces during the first pressing step and the second pressing step were carried out in all the examples and Comparative Examples A1 and A2 in which the glass blanks were produced by the horizontal direct press was 550° C. or less at the highest, and the temperature between the press-molding surfaces during the pressing step was carried out in Comparative Examples A3 to A5 in which the glass blanks were produced by the vertical direct press was in a range of 450° C. to 500° C.

TABLE 1

| | | Example A1 | Example A2 | Example A3 | Example A4 | Example A5 |
|---|---|---|---|---|---|---|
| Physical | Deformation point | 550 | 550 | 550 | 550 | 550 |
| property values | [° C.] | | | | | |
| of glass | Strain point [° C.] | 490 | 490 | 490 | 490 | 490 |
| material used | | | | | | |
| Press method | | Horizontal | Horizontal | Horizontal | Horizontal | Horizontal |
| | | direct press | direct press | direct press | direct press | direct press |
| Mold type | | Integral type | Integral type | Separate type | Separate type | Separate type |
| Conditions for | Temperature T1 | 500 | 500 | 500 | 500 | 500 |
| first pressing | of press-molding | | | | | |
| step | surface 52A | | | | | |
| | immediately | | | | | |
| | before first | | | | | |
| | pressing step was | | | | | |
| | carried out [° C.] | | | | | |
| | Temperature T2 | 500 | 500 | 500 | 500 | 500 |
| | of press-molding | | | | | |
| | surface 62A | | | | | |
| | immediately | | | | | |
| | before first | | | | | |
| | pressing step was | | | | | |
| | carried out [° C.] | | | | | |
| | Temperature | 0 | 0 | 0 | 0 | 0 |
| | difference | | | | | |
| | between | | | | | |
| | press-molding | | | | | |
| | surfaces (\|T1 − T2\|) | | | | | |
| | [° C.] | | | | | |
| | Temperature | 50 | 50 | 50 | 50 | 50 |
| | difference within | | | | | |
| | press-molding | | | | | |
| | surface 52A | | | | | |
| | immediately | | | | | |
| | before first | | | | | |
| | pressing step was | | | | | |
| | carried out [° C.] | | | | | |
| | Temperature | 50 | 50 | 50 | 50 | 50 |
| | difference within | | | | | |
| | press-molding | | | | | |
| | surface 62A | | | | | |
| | immediately | | | | | |
| | before first | | | | | |
| | pressing step was | | | | | |
| | carried out [° C.] | | | | | |
| Conditions for | Duration time of | 2 seconds | Longer than | 2 seconds | 2 seconds | 2 seconds |
| second | second pressing | | 2 seconds | | | |
| pressing step | step | | | | | |
| | Temperature of | 495 | 490 | 495 | 495 | 495 |
| | plate glass 26 | | | | | |
| | when second | | | | | |
| | pressing step was | | | | | |
| | completed | | | | | |
| | (temperature | | | | | |
| | when taken out) | | | | | |
| | [° C.] | | | | | |
| | Press pressure | Always | Always | Always | Reduced to | Reduced to |
| | during the second | constant | constant | constant | 50% when | 50% when |
| | pressing step was | | | | temperature of | temperature of |
| | carried out | | | | plate glass 26 | plate glass 26 |
| | | | | | reached | reached |
| | | | | | temperature | temperature |
| | | | | | which was 40° C. | which was 40° C. |
| | | | | | lower than | higher than |
| | | | | | defromation point | defromation point |
| Result of | Flatness [μm] | 4 | 4 | 4 | 4 | 4 |
| evaluation | Crack | B | A | C | A | A |
| | Productivity | B | C | B | B | B |

| | | | | | Comparative | Comparative |
|---|---|---|---|---|---|---|
| | | Example A6 | Example A7 | Example A8 | Example A1 | Example A2 |
| Physical | Deformation point | 550 | 550 | 550 | 550 | 550 |
| property values | [° C.] | | | | | |
| of glass | Strain point [° C.] | 490 | 490 | 490 | 490 | 490 |
| material used | | | | | | |
| Press method | | Horizontal | Horizontal | Horizontal | Horizontal | Horizontal |
| | | direct press | direct press | direct press | direct press | direct press |
| Mold type | | Separate type | Separate type | Separate type | Integral type | Integral type |
| Conditions for | Temperature T1 | 500 | 500 | 500 | 500 | 500 |
| first pressing | of press-molding | | | | | |
| step | surface 52A | | | | | |
| | immediately | | | | | |
| | before first | | | | | |
| | pressing step was | | | | | |
| | carried out [° C.] | | | | | |
| | Temperature T2 | 500 | 500 | 500 | 500 | 500 |
| | of press-molding | | | | | |
| | surface 62A | | | | | |
| | immediately | | | | | |
| | before first | | | | | |
| | pressing step was | | | | | |
| | carried out [° C.] | | | | | |
| | Temperature | 0 | 0 | 0 | 0 | 0 |
| | difference | | | | | |
| | between | | | | | |
| | press-molding | | | | | |
| | surfaces (\|T1 − T2\|) | | | | | |
| | [° C.] | | | | | |
| | Temperature | 50 | 50 | 50 | 50 | 50 |
| | difference within | | | | | |
| | press-molding | | | | | |
| | surface 52A | | | | | |
| | immediately | | | | | |
| | before first | | | | | |
| | pressing step was | | | | | |
| | carried out [° C.] | | | | | |
| | Temperature | 50 | 50 | 50 | 50 | 50 |
| | difference within | | | | | |
| | press-molding | | | | | |
| | surface 62A | | | | | |
| | immediately | | | | | |
| | before first | | | | | |
| | pressing step was | | | | | |
| | carried out [° C.] | | | | | |
| Conditions for | Duration time of | 2 seconds | 2 seconds | 2 seconds | Shorter than | Second |
| second | second pressing | | | | 2 seconds | pressing step |
| pressing step | step | | | | | was not |
| | Temperature of | 495 | 495 | 495 | 520 | carried out |
| | plate glass 26 | | | | | |
| | when second | | | | | |
| | pressing step was | | | | | |
| | completed | | | | | |
| | (temperature | | | | | |
| | when taken out) | | | | | |
| | [° C.] | | | | | |
| | Press pressure | Reduced to | Reduced to | Reduced to | Always | |
| | during the second | 50% when | 50% when | 50% when | constant | |
| | pressing step was | temperature of | temperature of | temperature | | |
| | carried out | plate glass 26 | plate glass 26 | of plate | | |
| | | reached | reached | glass 26 | | |
| | | temperature | temperature | reached | | |
| | | which was 40° C. | which was 40° C. | defromation | | |
| | | higher than | lower than | point | | |
| | | defromation point | defromation point | | | |
| Result of | Flatness [μm] | 4 | 4 | 4 | 11 | 20 |
| evaluation | Crack | B | B | A | B | A |
| | Productivity | B | B | B | B | A |

TABLE 2

| | | Comparative | Comparative | Comparative |
|---|---|---|---|---|
| | | Example A3 | Example A4 | Example A5 |
| Physical | Deformation point | 550 | 550 | 550 |
| property | [° C.] | | | |
| values of | Strain point [° C.] | 490 | 490 | 490 |
| glass | | | | |
| material | | | | |
| used | | | | |
| Press method | | Vertical direct | Vertical direct | Vertical direct |
| | | press | press | press |
| Conditions | Temperature T1 of | 380 | 380 | 380 |
| for pressing | press-molding | | | |
| step | surface of upper | | | |
| | mold immediately | | | |
| | before pressing step | | | |
| | was carried out [° C.] | | | |
| | Temperature T2 of | 480 | 480 | 480 |
| | press-molding | | | |
| | surface of lower mold | | | |
| | immediately before | | | |
| | pressing step was | | | |
| | carried out [° C.] | | | |
| | Temperature | 100 | 100 | 100 |
| | difference between | | | |
| | press-molding | | | |
| | surfaces (\|T1 − T2\|) | | | |
| | [° C.] | | | |
| | Temperature | 30 | 30 | 30 |
| | difference within | | | |
| | press-molding | | | |
| | surface of upper | | | |
| | mold immediately | | | |
| | before pressing step | | | |
| | was carried out [° C.] | | | |
| | Temperature | 30 | 30 | 30 |
| | difference within | | | |
| | press-molding | | | |
| | surface of lower mold | | | |
| | immediately before | | | |
| | pressing step was | | | |
| | carried out [° C.] | | | |
| | Temperature of plate | 500 | 495 | 500 |
| | glass when pressing | | | |
| | step was completed | | | |
| | (temperature when | | | |
| | taken out) [° C.] | | | |
| Presence/absence of upper mold for | | Absence | Absence | Presence |
| cooling used | | | | |
| Results of | Flatness [μm] | 20 | 15 | 15 |
| evaluation | Crack | Not evaluated | | |
| | Productivity | A | D | A |

Note that, the evaluation method for the flatness and the evaluation method and the evaluation criteria for the crack and the productivity shown in Table 1 and Table 2 are as described below.

### —Flatness—

The flatness was measured with a three-dimensional shape measuring apparatus (manufactured by COMS Co., Ltd., high-precision three-dimensional shape measuring system, MAP-3D). The average flatness of ten samples was determined.

### —Crack—

When 1,000 glass blanks were continuously produced, glass blanks with a crack among the obtained glass blanks were counted to determine the rate of occurrence of a crack. Note that, the evaluation criteria of the results of the evaluation shown in Table 1 and Table 2 are as follows.

A: The rate of occurrence of a crack is 0%.
B: The rate of occurrence of a crack is more than 0% and 1% or less.
C: The rate of occurrence of a crack is more than 1% and 2% or less.
D: The rate of occurrence of a crack is 2% or more.

### —Productivity—

The number of glass blanks produced per unit time when 1,000 glass blanks were continuously produced was determined. Note that, the evaluation criteria of the results of the evaluation shown in Table 1 and Table 2 are as follows.

A: The number of glass blanks produced per hour was 3,420 or more.
B: The number of glass blanks produced per hour was 3,240 or more and less than 3,420.
C: The number of glass blanks produced per hour was 3,060 or more and less than 3,240.
D: The number of glass blanks produced per hour was less than 3,060.

### <<Production of Magnetic Recording Medium Glass Substrate and Magnetic Recording Medium>>

### Example B1

The glass blanks produced in Example A1 were annealed to reduce or remove strain. Next, there was applied scribe processing on a portion that was to serve as the outer periphery of a magnetic recording medium glass substrate and a portion that was to serve as the central hole thereof. As a result of the processing, two grooves looking like concentric circles were formed outside and outside. Next, by partially heating the portions on which the scribe processing was applied, a crack were generated along the grooves produced by the scribe processing, by virtue of the difference in thermal expansion of glass, and the outside portion of the outer concentric circle and the inside portion were removed. As a result, a disk-shaped glass having a perfect circle shape was obtained.

Next, shape processing was applied to the disk-shaped glass by using chamfering or the like and its end surfaces were polished. Then, after a first polishing was carried out on the main surfaces of the disk-shaped glass, the glass was immersed in a chemical strengthening solution to perform chemical strengthening. After the chemical strengthening, the glass was sufficiently cleaned and then subjected to a second polishing. After the second polishing step, the disk-shaped glass was cleaned again and a magnetic recording medium glass substrate was produced. The obtained magnetic recording medium glass substrate had an outer diameter of 65 mm, a central hole diameter of 20 mm, a thickness of 0.8 mm, and a main surface roughness of 0.2 nm or less.

Note that, in producing the magnetic recording medium glass substrate, steps such as the lapping step carried out with one of the main purposes thereof being to improve the flatness were eliminated. However, the flatness of the glass blank used in the processing was 4 μm and the flatness of the magnetic recording medium glass substrate produced was 4 μm, and thus, there was almost no difference in flatness between the two. Note that, the flatness of the magnetic recording medium glass substrate was measured in a similar way to the measurement of the flatness of the glass blank.

Next, the magnetic recording medium glass substrate produced was used to form an adherent layer, an undercoat layer, a magnetic layer, a protective layer, and a lubricant layer in the stated order on the main surface of the magnetic recording medium glass substrate, yielding a magnetic recording medium. First, a film-forming apparatus in which vacuuming had been performed was used to form sequentially the adherent layer, the undercoat layer, and the magnetic layer in an Ar atmosphere by using a DC magnetron sputtering method. At that time, the adherent layer was formed by using a CrTi target so that an amorphous CrTi layer having a thickness of 20 nm was formed. Subsequently, a single wafer/stationary opposed film-forming apparatus was used to form a layer having a thickness of 10 nm made of amorphous CrRu as the undercoat layer in an Ar atmosphere by using a DC magnetron sputtering method. Further, the magnetic layer was formed at a film-forming temperature of 400° C. by using an FePt target or a CoPt target so that an amorphous FePt layer or an amorphous CoPt layer each having a thickness of 200 nm was formed. After the film formation up to the magnetic layer finished, the magnetic recording medium was transferred from the film-forming apparatus to a heating furnace and annealed at a temperature of 650 to 700° C.

Next, a protective layer made of hydrogenated carbon was formed by a CVD method using ethylene as a material gas. After that, a lubricant layer made using perfluoropolyether (PFPE) was formed by a dip coating method. The thickness of the lubricant layer was 1 nm. The manufacturing steps described above provided magnetic recording media.

The flatness of the obtained magnetic recording media was 4 μm, which was substantially similar to the flatness of the magnetic recording medium glass substrates used in producing the magnetic recording media. Note that, the flatness of the magnetic recording media was measured in a similar way to the measurement of the flatness of the glass blanks.

### Comparative Example B1

The glass blanks produced in Comparative Example A1 were used to produce magnetic recording medium glass substrates. Note that, the magnetic recording medium glass substrates were produced in the same manner as in Example B1 except that the lapping step was further carried out with the grinding allowance being set to be 50 μm after the end face was polished and before the first polishing was carried out. The obtained magnetic recording medium glass substrates had an outer diameter of 65 mm, a central hole diameter of 20 mm, a thickness of 0.8 mm, and a main surface roughness of 0.2 nm or less. Further, the flatness of the glass blanks used in the processing was 15 μm while the flatness of the produced magnetic recording medium glass substrates was 4 μm. It was confirmed that the flatness was greatly improved.

Next, the obtained magnetic recording medium glass substrates were used to produce magnetic recording medium glass substrates in the same manner as in Example B1. The flatness of the obtained magnetic recording media was 4 μm, which was substantially similar to the flatness of the magnetic recording medium glass substrates used in producing the magnetic recording media.

### Comparative Example B2

Magnetic recording medium glass substrates and magnetic recording media were produced in the same manner as in Comparative Example B1 except that the lapping step was eliminated. The flatnesses of the obtained magnetic recording medium glass substrates and magnetic recording media were substantially the same as the flatness of the glass blanks used in the processing.

### Comparative Example B3

Magnetic recording medium glass substrates and magnetic recording media were produced in the same manner as in Comparative Example B1 except that the glass blanks produced in Comparative Example A5 were used. The obtained magnetic recording medium glass substrates had an outer diameter of 65 mm, a central hole diameter of 20 mm, a thickness of 0.8 mm, and a main surface roughness of 0.2 nm or less. Further, the flatness of the glass blanks used in the processing was 15 μm while the flatness of the produced magnetic recording medium glass substrates was 4 μm. It was confirmed that the flatness was greatly improved.

Next, the obtained magnetic recording medium glass substrates were used to produce magnetic recording medium glass substrates in the same manner as in Comparative Example B1. The flatness of the obtained magnetic recording media was 4 μm, which was substantially similar to the flatness of the magnetic recording medium glass substrates used in producing the magnetic recording media.

### Comparative Example B4

Magnetic recording medium glass substrates and magnetic recording media were produced in the same manner as in Comparative Example B3 except that the lapping step was eliminated. The flatnesses of the obtained magnetic recording medium glass substrates and magnetic recording media were substantially the same as the flatness of the glass blanks used in the processing.

### Examples of Second Aspect of the Present Invention

Hereinafter, a second aspect of the present invention is described by way of examples, but the second aspect of the present invention is not limited to only the following examples.

### <<Production of Glass Blank>>

In examples and comparative examples, more than several hundreds of glass blanks (diameter: about 75 mm, thickness: about 0.9 mm) for producing 2.5-inch magnetic recording medium glass substrates were continuously produced.

### Example A1

According to the process illustrated in FIG. 11 to FIG. 19, the molten glass gob forming step, the press-molding step (first step and second step), and the taking out step were carried out to produce glass blanks. Note that, the viscosity of the molten glass which flows out from the glass outlet 112 was adjusted to be 700 dPa·s, the first press mold 150 and the second press mold 160 were placed so as to be perpendicular to the direction in which the molten glass gob 124 fell, and the falling distance was set to be 150 mm.

Here, main physical property values and the composition of the glass material used in producing the glass blanks were as follows.

Glass transition temperature: 495° C.

Deformation point: 550° C.

Strain point: 490° C.

Composition: composition corresponding to Glass Composition 2

Further, specific conditions for carrying out the first step and the second step and details of the press molds 150 and 160 used in the press molding were as follows.

### —Conditions for Carrying out First Step—

The temperature of the press-molding surface 152A immediately before the first step was carried out was set to be 500° C., the temperature of the press-molding surface 162A immediately before the first step was carried out was set to be 500° C., the temperature difference within the press-molding surface 152A immediately before the first step was carried out was set to be 50° C., and the temperature difference within the press-molding surface 162A immediately before the first step was carried out was set to be 50° C. Note that, the press molds 150 and 160 were set to be driven so that the press-molding surface 152A and the press-molding surface 162A were brought into contact with the molten glass gob 124 at the same time. Further, the press-molding time was 0.07 second. Note that, the temperatures of the press-molding surfaces 152A and 162A were monitored by thermocouples placed at a depth of 30 mm from the press-molding surfaces 152A and 162A, respectively. Among the thermocouples, one was placed at the center of each of the press-molding surfaces 152A and 162A, and four were placed at positions of 1 mm in radius from the center of each of the press-molding surfaces 152A and 162A in diameter directions so as to form angles of 0°, 90°, 180°, and 270° in a peripheral direction, respectively.

### —Conditions for Carrying out Second Step—

The temperature of the plate glass 126 when the second step was completed (temperature when taken out) was set to be 495° C. The press pressures of the press mold bodies 152 and 162 during the second step was carried out were set to be always held at 0.5 MPa. Note that, the temperature of the plate glass 126 was a value determined on the assumption that the temperature was a temperature measured by the thermocouple placed at the center of each of the press-molding surfaces 152A and 162A.

### —Press Mold—

As the press mold 150, one formed of cast iron of the integral type in which the press mold body 152 and the guide member 154 were integrally formed was used. As the press mold 150, one of the integral type which was similar to the press mold 160 was used. Note that, the press-molding surfaces 152A and 162A were completely flat surfaces. Further, each of the press molds 150 and 160 of the integral type which were used was provided with a flow path for pas sing cooling water therethrough formed in the press mold body 152 or 162 for controlling the temperature of the press-molding surface 152A or 162A and the temperature distribution within the press-molding surface 152A or 162A, and a heater placed on an outer peripheral side of the press mold 150 or 160.

### Example A2

Glass blanks were produced in the same manner as in Example A1 except that the temperature of the plate glass when taken out was set to be 490° C.

### Example A3

Glass blanks were produced in the same manner as in Example A1 except that the temperature of the plate glass when taken out was set to be 505° C.

### Example A4

Glass blanks were produced in the same manner as in Example A3 except that the press pressure during the second step was carried out was reduced with time. Note that, the press pressure was controlled so as to be 50% when the temperature of the plate glass 126 reached a temperature which was 25° C. lower than the defromation point, with the press pressure immediately after the start of the second step being the reference (100%).

### Example A5

Glass blanks were produced in the same manner as in Example A3 except that the press pressure during the second step was carried out was reduced with time. Note that, the press pressure was controlled so as to be 50% when the temperature of the plate glass 126 reached a temperature which was 25° C. higher than the defromation point, with the press pressure immediately after the start of the second step being the reference (100%).

### Example A6

Glass blanks were produced in the same manner as in Example A3 except that the press pressure during the second step was carried out was reduced with time. Note that, the press pressure was controlled so as to be 50% when the temperature of the plate glass 126 reached a temperature which was 40° C. lower than the defromation point, with the press pressure immediately after the start of the second step being the reference (100%).

### Example A7

Glass blanks were produced in the same manner as in Example A3 except that the press pressure during the second step was carried out was reduced with time. Note that, the press pressure was controlled so as to be 50% when the temperature of the plate glass 126 reached a temperature which was 40° C. higher than the defromation point, with the press pressure immediately after the start of the second step being the reference (100%).

### Example A8

Glass blanks were produced in the same manner as in Example A3 except that the press pressure during the second step was carried out was reduced with time. Note that, the press pressure was controlled so as to be 50% when the temperature of the plate glass 126 reached the defromation point, with the press pressure immediately after the start of the second step being the reference (100%).

### Comparative Example A1

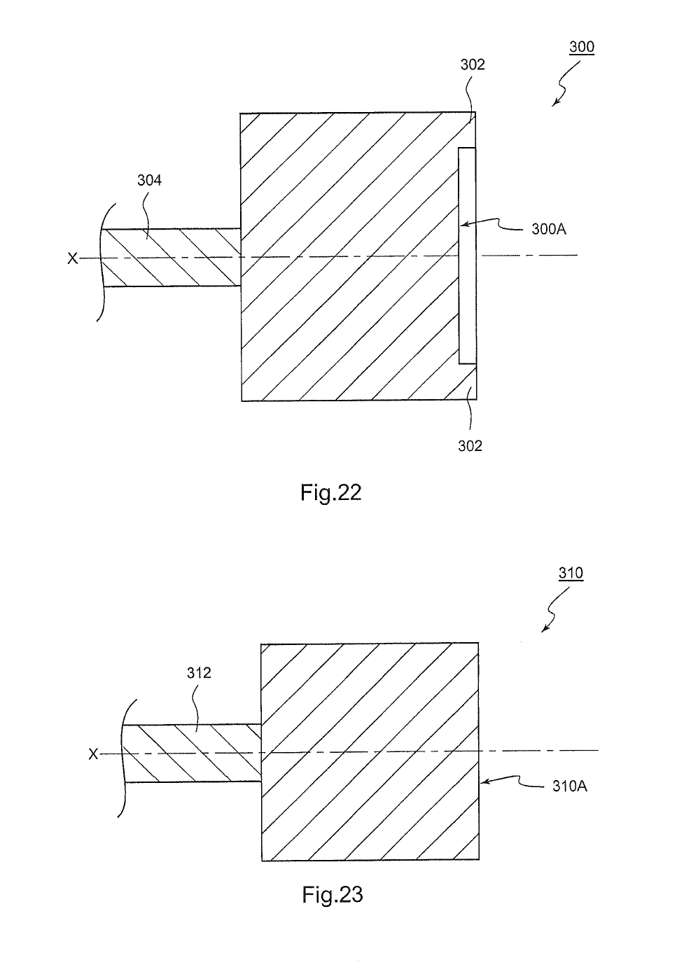

Glass blanks were produced under basically the same conditions as in Example A1 except that a press mold 300 illustrated in FIG. 22 was used as the press mold. However, during the second step was carried out, the press pressure was applied to the whole press mold 300.

Note that, the press mold 300 illustrated in FIG. 22 is formed of cast iron and has a structure in which the press mold body 152 and the guide member 154 forming the press mold 150S illustrated in FIG. 20 are integrated. The press mold 300 is a circular cylinder and one end face thereof is a press-molding surface 300A. Further, a ring-like convex portion 302 having a function similar to that of the guide member 154 is provided along an outer edge portion of the press-molding surface. Further, a rod-like member 304 is attached to a surface which is opposite to the press-molding surface 300A. A drive which is not shown is connected to the other end of the rod-like member 304. Note that, the rod-like member 304 is attached so as to be coaxial with the axial direction X of the press mold 300. Further, the smoothness and the flatness of the press-molding surface 300A of the press mold 300 and the dimensions of the press-molding surface 300A and the convex portion 302 are substantially similar to those of the mold 1505 used in the examples and illustrated in FIG. 20.

### Comparative Example A2

Glass blanks were produced under basically the same conditions as in Example A1 except that a press mold 310 illustrated in FIG. 23 was used as the press mold. However, the first step was completed at a point in time at which the thickness of the plate glass 126 was similar to the thickness of the glass blank to be produced, and after that, the second step was carried out with the press pressure being reduced. Further, during the second step was carried out, the press pressure was applied to the whole press mold 310.

Note that, the press mold 310 illustrated in FIG. 23 is formed of cast iron and has a structure corresponding to that of the press mold body 152 forming the press mold 150S illustrated in FIG. 20 are integrated. The press mold 310 is a circular cylinder and one end face thereof is a press-molding surface 310A. Further, a rod-like member 312 is attached to a surface which is opposite to the press-molding surface 310A. A drive which is not shown is connected to the other end of the rod-like member 312. Note that, the rod-like member 312 is attached so as to be coaxial with the axial direction X of the press mold 310.

### (Evaluation)

The glass blanks produced in the examples and the comparative examples were evaluated in terms of flatness, thickness deviation, and a crack. The results are shown in Table 3. Note that, the temperatures of two press-molding surfaces during the first step and the second step were carried out in the examples and the comparative examples were substantially the same and were 505° C. or less at the highest.

TABLE 3

| | | Example | Example | Example | Example | Example |
|---|---|---|---|---|---|---|
| | | A1 | A2 | A3 | A4 | A5 |
| Physical | Deformation | 550 | 550 | 550 | 550 | 550 |
| property | point [° C.] | | | | | |
| values of | Strain point | 490 | 490 | 490 | 490 | 490 |
| glass | [° C.] | | | | | |
| material | | | | | | |
| used | | | | | | |
| Structure of a pair of | | with | with | with | with | with |
| molds | | guide | guide | guide | guide | guide |
| | | member | member | member | member | member |
| Conditions | Temperature T1 of | 500 | 500 | 500 | 500 | 500 |
| for first | press-molding | | | | | |
| step | surface 52A | | | | | |
| | immediately | | | | | |
| | before first | | | | | |
| | step was | | | | | |
| | carried out | | | | | |
| | [° C.] | | | | | |
| | Temperature T2 of | 500 | 500 | 500 | 500 | 500 |
| | press-molding | | | | | |
| | surface 62A | | | | | |
| | immediately | | | | | |
| | before first | | | | | |
| | step was | | | | | |
| | carried out | | | | | |
| | [° C.] | | | | | |
| | Temperature | 0 | 0 | 0 | 0 | 0 |
| | difference | | | | | |
| | between press- | | | | | |
| | molding surfaces | | | | | |
| | (\|T1 − T2\|) | | | | | |
| | [° C.] | | | | | |
| | Temperature | 50 | 50 | 50 | 50 | 50 |
| | difference | | | | | |
| | within | | | | | |
| | press-molding | | | | | |
| | surface 52A | | | | | |
| | immediately | | | | | |
| | before first | | | | | |
| | step was | | | | | |
| | carried out | | | | | |
| | [° C.] | | | | | |
| | Temperature | 50 | 50 | 50 | 50 | 50 |
| | difference | | | | | |
| | within | | | | | |
| | press-molding | | | | | |
| | surface 62A | | | | | |
| | immediately | | | | | |
| | before first | | | | | |
| | step was | | | | | |
| | carried out | | | | | |
| | [° C.] | | | | | |
| Conditions | Temperature | 495 | 490 | 505 | 505 | 505 |
| for second | of plate | | | | | |
| step | glass 26 | | | | | |
| | when | | | | | |
| | second step | | | | | |
| | was | | | | | |
| | completed | | | | | |
| | (temperature | | | | | |
| | when taken | | | | | |
| | out) [° C.] | | | | | |
| | Press | Always | Always | Always | Reduced to | Reduced to |
| | pressure | constant | constant | constant | 50% when | 50% when |
| | during the | | | | temperature | temperature |
| | second step | | | | of plate | of plate |
| | was carried | | | | glass 26 | glass 26 |
| | out | | | | reached | reached |
| | | | | | temperature | temperature |
| | | | | | which was | which was |
| | | | | | 25° C. lower | 25° C. higher |
| | | | | | than defroma- | than defroma- |
| | | | | | tion point | tion point |
| Results of | Flatness | 4 | 4 | 4 | 4 | 4 |
| evaluation | [μm] | | | | | |
| | Thickness | 10 | 10 | 10 | 10 | 10 |
| | deviation | | | | | |
| | [μm] | | | | | |
| | Crack | C | A | B | A | A |

| | | | | | Compar- | Compar- |
|---|---|---|---|---|---|---|
| | | | | | ative | ative |
| | | Example | Example | Example | Example | Example |
| | | A6 | A7 | A8 | A1 | A2 |
| Physical | Deformation | 550 | 550 | 550 | 550 | 550 |
| property | point [° C.] | | | | | |
| values of | Strain point | 490 | 490 | 490 | 490 | 490 |
| glass | [° C.] | | | | | |
| material | | | | | | |
| used | | | | | | |
| Structure of a pair of | | with | with | with | FIG. 12 | FIG. 13 |
| molds | | guide | guide | guide | (press | (without |
| | | member | member | member | mold | guide |
| | | | | | body | member) |
| | | | | | and | |
| | | | | | guide | |
| | | | | | member | |
| | | | | | were | |
| | | | | | inte- | |
| | | | | | grally | |
| | | | | | formed) | |
| Conditions | Temperature T1 of | 500 | 500 | 500 | 500 | 500 |
| for first | press-molding | | | | | |
| step | surface 52A | | | | | |
| | immediately | | | | | |
| | before first | | | | | |
| | step was | | | | | |
| | carried out | | | | | |
| | [° C.] | | | | | |
| | Temperature T2 of | 500 | 500 | 500 | 500 | 500 |
| | press-molding | | | | | |
| | surface 62A | | | | | |
| | immediately | | | | | |
| | before first | | | | | |
| | step was | | | | | |
| | carried out | | | | | |
| | [° C.] | | | | | |
| | Temperature | 0 | 0 | 0 | 0 | 0 |
| | difference | | | | | |
| | between press- | | | | | |
| | molding surfaces | | | | | |
| | (\|T1 − T2\|) | | | | | |
| | [° C.] | | | | | |
| | Temperature | 50 | 50 | 50 | 50 | 50 |
| | difference | | | | | |
| | within | | | | | |
| | press-molding | | | | | |
| | surface 52A | | | | | |
| | immediately | | | | | |
| | before first | | | | | |
| | step was | | | | | |
| | carried out | | | | | |
| | [° C.] | | | | | |
| | Temperature | 50 | 50 | 50 | 50 | 50 |
| | difference | | | | | |
| | within | | | | | |
| | press-molding | | | | | |
| | surface 62A | | | | | |
| | immediately | | | | | |
| | before first | | | | | |
| | step was | | | | | |
| | carried out | | | | | |
| | [° C.] | | | | | |
| Conditions | Temperature | 505 | 505 | 505 | 495 | 495 |
| for second | of plate | | | | | |
| step | glass 26 | | | | | |
| | when | | | | | |
| | second step | | | | | |
| | was | | | | | |
| | completed | | | | | |
| | (temperature | | | | | |
| | when taken | | | | | |
| | out) [° C.] | | | | | |
| | Press | Reduced to | Reduced to | Reduced | Always | Always |
| | pressure | 50% when | 50% when | to 50% | con- | con- |
| | during the | temperature | temperature | when | stant | stant |
| | second step | of plate | of plate | temper- | | |
| | was carried | glass 26 | glass 26 | ature | | |
| | out | reached | reached | of plate | | |
| | | temperature | temperature | glass 26 | | |
| | | which was | which was | reached | | |
| | | 40° C. lower | 40° C. higher | defroma- | | |
| | | than defroma- | than defroma- | tion | | |
| | | tion point | tion point | point | | |
| Results of | Flatness | 4 | 4 | 4 | 15 | 4 |
| evaluation | [μm] | | | | | |
| | Thickness | 10 | 10 | 10 | 10 | 30 |
| | deviation | | | | | |
| | [μm] | | | | | |
| | Crack | B | B | A | A | B |

Note that, the evaluation method and the evaluation criteria for the flatness, thickness deviation, and a crack shown in Table 3 are as described below.

### —Flatness—

The flatness was measured with a three-dimensional shape measuring apparatus (manufactured by COMS Co., Ltd., high-precision three-dimensional shape measuring system, MAP-3D). The average flatness of ten samples was determined.

### —Thickness Deviation—

With regard to the thickness deviation, the thicknesses of the produced glass blank at the center and at positions of 30 mm in radius from the center so as to form angles of 0°, 90°, 180°, and 270° in a peripheral direction, respectively, were measured with a micrometer, and the standard deviation of the five points was determined. Then, the average value of the standard deviations of ten samples was determined.

### —Crack—

When 1,000 glass blanks were continuously produced, glass blanks with a crack among the obtained glass blanks were counted to determine the rate of occurrence of a crack. Note that, the evaluation criteria of the results of the evaluation shown in Table 3 and Table 2 are as follows.

A: The rate of occurrence of a crack is 0%.
B: The rate of occurrence of a crack is more than 0% and 1% or less.
C: The rate of occurrence of a crack is more than 1% and 2% or less.
D: The rate of occurrence of a crack is 3% or more.

### <<Production of Magnetic Recording Medium Glass Substrate and Magnetic Recording Medium>>

### Example B1

The glass blanks produced in Example A1 were annealed to reduce or remove strain. Next, there was applied scribe processing on a portion that was to serve as the outer periphery of a magnetic recording medium glass substrate and a portion that was to serve as the central hole thereof. As a result of the processing, two grooves looking like concentric circles were formed outside and outside. Next, by partially heating the portions on which the scribe processing was applied, a crack were generated along the grooves produced by the scribe processing, by virtue of the difference in thermal expansion of glass, and the outside portion of the outer concentric circle and the inside portion were removed. As a result, a disk-shaped glass having a perfect circle shape was obtained.

Next, shape processing was applied to the disk-shaped glass by using chamfering or the like and its end surfaces were polished. Then, after a first polishing is carried out on the main surfaces of the disk-shaped glass, the glass is immersed in a chemical strengthening solution to perform chemical strengthening. After the chemical strengthening, the glass was sufficiently cleaned and then subjected to a second polishing. After the second polishing step, the disk-shaped glass was cleaned again and a magnetic recording medium glass substrate was produced. The obtained magnetic recording medium glass substrate had an outer diameter of 65 mm, a central hole diameter of 20 mm, a thickness of 0.8 mm, and a main surface roughness of 0.2 nm or less.

Note that, in producing the magnetic recording medium glass substrates, steps such as the lapping step carried out with one of the main purposes thereof being to improve the flatness were eliminated. However, the flatness of the glass blanks used in the processing was 4 μm and the flatness of the magnetic recording medium glass substrates produced was 4 μm, and thus, there was almost no difference in flatness between the two. Note that, the flatness of the magnetic recording medium glass substrates was measured in a similar way to the measurement of the flatness of the glass blanks.

Next, the produced magnetic recording medium glass substrate was used to form an adherent layer, an undercoat layer, a magnetic layer, a protective layer, and a lubricant layer in the stated order on the main surface of the magnetic recording medium glass substrate, yielding a magnetic recording medium. First, a film-forming apparatus in which vacuuming had been performed was used to form sequentially the adherent layer, the undercoat layer, and the magnetic layer in an Ar atmosphere by using a DC magnetron sputtering method. At that time, the adherent layer was formed by using a CrTi target so that an amorphous CrTi layer having a thickness of 20 nm was formed. Subsequently, a single wafer/stationary opposed film-forming apparatus was used to form a layer having a thickness of 10 nm made of amorphous CrRu as the undercoat layer in an Ar atmosphere by using a DC magnetron sputtering method. Further, the magnetic layer was formed at a film-forming temperature of 400° C. by using an FePt target or a CoPt target so that an amorphous FePt layer or an amorphous CoPt layer each having a thickness of 200 nm was formed. After the film formation up to the magnetic layer finished, the magnetic recording medium was transferred from the film-forming apparatus to a heating furnace and annealed at a temperature of 650 to 700° C.

Next, a protective layer made of hydrogenated carbon was formed by a CVD method using ethylene as a material gas. After that, a lubricant layer made using perfluoropolyether (PFPE) was formed by a dip coating method. The thickness of the lubricant layer was 1 nm. The manufacturing steps described above provided magnetic recording media.

The flatness of the obtained magnetic recording media was 4 μm, which was substantially similar to the flatness of the magnetic recording medium glass substrates used in producing the magnetic recording media. Note that, the flatness of the magnetic recording media was measured in a similar way to the measurement of the flatness of the glass blanks.

### Comparative Example B1

The glass blanks produced in Comparative Example A1 were used to produce magnetic recording medium glass substrates. Note that, the magnetic recording medium glass substrates were produced in the same manner as in Example B1 except that the lapping step was further carried out with the grinding allowance being set to be 50 μm after the end face was polished and before the first polishing was carried out. The obtained magnetic recording medium glass substrates had an outer diameter of 65 mm, a central hole diameter of 20 mm, a thickness of 0.8 mm, and a main surface roughness of 0.2 nm or less. Further, the flatness of the glass blanks used in the processing was 15 μm while the flatness of the produced magnetic recording medium glass substrates was 4 μm. It was confirmed that the flatness was greatly improved.

Next, the obtained magnetic recording medium glass substrates were used to produce magnetic recording medium glass substrates in the same manner as in Example B1. The flatness of the obtained magnetic recording media was 4 μm, which was substantially similar to the flatness of the magnetic recording medium glass substrates used in producing the magnetic recording media.

### Comparative Example B2

Magnetic recording medium glass substrates and magnetic recording media were produced in the same manner as in Comparative Example B1 except that the lapping step was eliminated. The flatnesses of the obtained magnetic recording medium glass substrates and magnetic recording media were substantially the same as the flatness of the glass blanks used in the processing.

1. A method of manufacturing a glass blank for a magnetic recording medium glass substrate, comprising at least:
a first pressing step of pressing a falling molten glass gob with a first press mold and a second press mold placed so as to be opposed to each other in a direction crossing a direction in which the molten glass gob falls to form the falling molten glass gob into a plate shape;
a second pressing step of continuing to press, with the first press mold and the second press mold, plate glass formed between the first press mold and the second press mold; and
a taking out step of, after the second pressing step, moving the first press mold and the second press mold away from each other and taking out the plate glass sandwiched between the first press mold and the second press mold, wherein:
at least during a period in which the first pressing step and the second pressing step are carried out, the temperature of a press-molding surface of the first press mold and the temperature of a press-molding surface of the second press mold are substantially the same;
in the first pressing step, the molten glass gob is pressed after the press-molding surface of the first press mold and the press-molding surface of the second press mold are brought into contact with the molten glass gob substantially at the same time; and
the duration time of the second pressing step is controlled so that the flatness of the glass blank for a magnetic recording medium glass substrate is 10 μm or less.

2. A method of manufacturing a glass blank for a magnetic recording medium glass substrate according to claim 1,
wherein the duration time of the second pressing step is selected so that the temperature of the plate glass when the second pressing step is completed is at least equal to or lower than a temperature which is 10° C. higher than the strain point of a glass material forming the plate glass.

3. A method of manufacturing a glass blank for a magnetic recording medium glass substrate according to claim 1,
further comprising a molten glass gob forming step of causing molten glass to fall from a glass outlet and cutting a forward end portion of a molten glass flow continuously flowing out downward in the vertical direction.

4. A method of manufacturing a glass blank for a magnetic recording medium glass substrate according to claim 3,
wherein the viscosity of the molten glass is in a range of 500 dPa·s to 1,050 dPa·s.

5. A method of manufacturing a glass blank for a magnetic recording medium glass substrate according to claim 1,
wherein the first press mold and the second press mold are placed so as to be opposed to each other in a direction perpendicular to the direction in which the molten glass gob falls.

6. A method of manufacturing a glass blank for a magnetic recording medium glass substrate according to claim 1,
wherein the temperature of the press-molding surfaces of the first press mold and the second press mold immediately before the first pressing step is carried out is equal to or lower than a temperature which is 10° C. higher than the strain point of a glass material forming the molten glass gob.

7. A method of manufacturing a glass blank for a magnetic recording medium glass substrate according to claim 1,
wherein the press pressure in the second pressing step is reduced with time.

8. A method of manufacturing a glass blank for a magnetic recording medium glass substrate according to claim 7,
wherein the press pressure is reduced when the temperature of the plate glass sandwiched between the first press mold and the second press mold is lowered into a range of ±30° C. from the defromation point of a glass material forming the plate glass.

9. A method of manufacturing a glass blank for a magnetic recording medium glass substrate according to claim 1,
wherein, during the second pressing step is carried out, one surface of the plate glass and the press-molding surface of the first press mold are always in intimate contact with each other without a gap and the other surface of the plate glass and the press-molding surface of the second press mold are always in intimate contact with each other without a gap.

10. A method of manufacturing a glass blank for a magnetic recording medium glass substrate according to claim 1,
wherein the duration time of the second pressing step is controlled so that the flatness of the glass blank for a magnetic recording medium glass substrate is 4 μm or less.

11. A method of manufacturing a glass blank for a magnetic recording medium glass substrate according to claim 1,
wherein regions in contact with at least the plate glass of the press-molding surfaces of the first press mold and the second press mold are substantially flat surfaces.

12. A method of manufacturing a magnetic recording medium glass substrate, comprising at least:
manufacturing a glass blank for a magnetic recording medium glass substrate, comprising at least:
a first pressing step of pressing a falling molten glass gob with a first press mold and a second press mold placed so as to be opposed to each other in a direction crossing a direction in which the molten glass gob falls to form the falling molten glass gob into a plate shape;
a second pressing step of continuing to press, with the first press mold and the second press mold, plate glass formed between the first press mold and the second press mold; and
a taking out step of, after the second pressing step, moving the first press mold and the second press mold away from each other and taking out the plate glass sandwiched between the first press mold and the second press mold; and
after that, a polishing step of polishing main surfaces of the glass blank for a magnetic recording medium glass substrate, wherein:
at least during a period in which the first pressing step and the second pressing step are carried out, the temperature of a press-molding surface of the first press mold and the temperature of a press-molding surface of the second press mold are substantially the same;
in the first pressing step, the molten glass gob is pressed after the press-molding surface of the first press mold and the press-molding surface of the second press mold are brought into contact with the molten glass gob substantially at the same time; and
the duration time of the second pressing step is controlled so that the flatness of the glass blank for a magnetic recording medium glass substrate is 10 μm or less.

13. A method of manufacturing a magnetic recording medium glass substrate according to claim 12, wherein
the duration time of the second pressing step is selected so that the temperature of the plate glass when the second pressing step is completed is at least equal to or lower than a temperature which is 10° C. higher than the strain point of a glass material forming the plate glass.

14. A method of manufacturing a magnetic recording medium glass substrate according to claim 12,
wherein the flatness of the glass blank for a magnetic recording medium glass substrate and the flatness of the magnetic recording medium glass substrate are substantially the same.

15. A method of manufacturing a magnetic recording medium, comprising at least:
manufacturing a glass blank for a magnetic recording medium glass substrate, comprising at least:
a first pressing step of pressing a falling molten glass gob with a first press mold and a second press mold placed so as to be opposed to each other in a direction crossing a direction in which the molten glass gob falls to form the falling molten glass gob into a plate shape;
a second pressing step of continuing to press, with the first press mold and the second press mold, plate glass formed between the first press mold and the second press mold; and
a taking out step of, after the second pressing step, moving the first press mold and the second press mold away from each other and taking out the plate glass sandwiched between the first press mold and the second press mold;
after that, manufacturing a magnetic recording medium glass substrate, comprising at least a polishing step of polishing main surfaces of the glass blank for a magnetic recording medium glass substrate; and further,
manufacturing a magnetic recording medium, comprising at least a magnetic recording layer-forming step of forming a magnetic recording layer on the magnetic recording medium glass substrate, wherein:
at least during a period in which the first pressing step and the second pressing step are carried out, the temperature of a press-molding surface of the first press mold and the temperature of a press-molding surface of the second press mold are substantially the same;
in the first pressing step, the molten glass gob is pressed after the press-molding surface of the first press mold and the press-molding surface of the second press mold are brought into contact with the molten glass gob substantially at the same time; and
the duration time of the second pressing step is controlled so that the flatness of the glass blank for a magnetic recording medium glass substrate is 10 μm or less.

16. A method of manufacturing a magnetic recording medium according to claim 15,
wherein the duration time of the second pressing step is selected so that the temperature of the plate glass when the second pressing step is completed is at least equal to or lower than a temperature which is 10° C. higher than the strain point of a glass material forming the plate glass.

17. A method of manufacturing a magnetic recording medium according to claim 15,
wherein the flatness of the glass blank for a magnetic recording medium glass substrate and the flatness of the magnetic recording medium glass substrate are substantially the same.

18. A method of manufacturing a glass blank for a magnetic recording medium glass substrate, comprising at least a press-molding step of press-molding a falling molten glass gob with a first press mold and a second press mold placed so as to be opposed to each other in a direction crossing a direction in which the molten glass gob falls, wherein:
at least the first press mold at least comprises:
a press mold body having a press-molding surface; and
a guide member having at least the function of maintaining a substantially fixed distance between the press-molding surfaces of the first press mold and the second press mold in the press molding, by, when pushed to the side of the second press mold which is placed so as to be opposed to the press-molding surface, being brought into contact with a part of the second press mold which is placed so as to be opposed to the press-molding surface; and
the press-molding step comprises:
a first step of forming the molten glass gob into plate glass by bringing the first press mold and the second press mold closer together until the guide member of the first press mold and the second press mold are in contact with each other; and
a second step of continuing to press, with the press mold body of the first press mold and the second press mold, the plate glass with the guide member of the first press mold and the second press mold being in contact with each other.

19. A method of manufacturing a magnetic recording medium glass substrate, comprising at least:
manufacturing a glass blank for a magnetic recording medium glass substrate, comprising at least a press-molding step of press-molding a falling molten glass gob with a first press mold and a second press mold placed so as to be opposed to each other in a direction crossing a direction in which the molten glass gob falls; and
after that, a polishing step of polishing main surfaces of the glass blank for a magnetic recording medium glass substrate, wherein:
at least the first press mold at least comprises:
a press mold body having a press-molding surface; and
a guide member having at least the function of maintaining a substantially fixed distance between the press-molding surfaces of the first press mold and the second press mold in the press molding, by, when pushed to the side of the second press mold which is placed so as to be opposed to the press-molding surface, being brought into contact with a part of the second press mold which is placed so as to be opposed to the press-molding surface; and
the press-molding step comprises:
a first step of forming the molten glass gob into plate glass by bringing the first press mold and the second press mold closer together until the guide member of the first press mold and the second press mold are in contact with each other; and
a second step of continuing to press, with the press mold body of the first press mold and the second press mold, the plate glass with the guide member of the first press mold and the second press mold being in contact with each other.

20. A method of manufacturing a magnetic recording medium, comprising at least:
manufacturing a glass blank for a magnetic recording medium glass substrate, comprising at least a press-molding step of press-molding a falling molten glass gob with a first press mold and a second press mold placed so as to be opposed to each other in a direction crossing a direction in which the molten glass gob falls;
after that, manufacturing a magnetic recording medium glass substrate, comprising at least a polishing step of polishing main surfaces of the glass blank for a magnetic recording medium glass substrate; and further,
manufacturing a magnetic recording medium, comprising at least a magnetic recording layer-forming step of forming a magnetic recording layer on the magnetic recording medium glass substrate, wherein:
at least the first press mold at least comprises:
a press mold body having a press-molding surface; and
a guide member having at least the function of maintaining a substantially fixed distance between the press-molding surfaces of the first press mold and the second press mold in the press molding, by, when pushed to the side of the second press mold which is placed so as to be opposed to the press-molding surface, being brought into contact with a part of the second press mold which is placed so as to be opposed to the press-molding surface; and
the press-molding step comprises:
a first step of forming the molten glass gob into plate glass by bringing the first press mold and the second press mold closer together until the guide member of the first press mold and the second press mold are in contact with each other; and
a second step of continuing to press, with the press mold body of the first press mold and the second press mold, plate glass with the guide member of the first press mold and the second press mold being in contact with each other.
